(19) United States
(12) Patent Application Publication
(10) Pub. No.: US 2020/0261855 A1
(43) Pub. Date: Aug. 20, 2020

(54) ASYMMETRIC COMPOSITE MEMBRANES AND USES THEREOF

(71) Applicant: The Regents of the University of California, Oakland, CA (US)

(72) Inventors: Brian T. McVerry, Laguna Hills, CA (US); Richard B. Kaner, Los Angeles, CA (US); Chain Lee, Monterey Park, CA (US); Mackenzie Anderson, Los Angeles, CA (US)

(21) Appl. No.: 16/762,435

(22) PCT Filed: Nov. 9, 2018
(86) PCT No.: PCT/US2018/059967

§ 371 Date: May 7, 2020

Related U.S. Application Data
(60) Provisional application No. 62/583,751, filed on Nov. 9, 2017.

(51) Int. Cl. B01D 67/00; C08J 5/18; C08J 7/04; B01D 61/02; B01D 65/08; B01D 69/02; B01D 69/10; B01D 69/12; B01D 71/64; B01D 71/28; C02F 1/44; B01D 53/22

(52) U.S. Cl. CPC B01D 67/0018; C02F 2103/08; C08J 7/0427; B01D 61/025; B01D 61/027; B01D 65/08; B01D 69/02; B01D 69/10; B01D 69/12; B01D 71/64; B01D 71/28; C02F 1/441; B01D 53/228; C02F 1/442; C08J 2463/00; C08J 2481/06; C08J 2379/08; C08J 2379/02; C08J 2377/06; B01D 2325/022; C08J 5/18

(57) ABSTRACT

Disclosed herein are asymmetric thin-film composite membranes and methods of making and using the same. Also included herein are asymmetric thin-film composite membranes for preventing and/or reducing microfouling or macrofouling. Additionally included herein are asymmetric thin-film composite membranes for preventing and/or reducing biofilm.

### RELATED APPLICATIONS

This application claims the benefit of U.S. Provisional Patent Application No. 62/583,751, filed on Nov. 9, 2017. The contents of this application are hereby incorporated by reference in their entirety.

### BACKGROUND

With rapid population growth and increased agricultural demand to support it, worldwide freshwater availability is declining at alarming rates. It is estimated that 1.2 billion people do not have access to safe drinking water, with millions dying annually from diseases transmitted from contaminated water. In some instances, developed countries such as the United States are undergoing unprecedented droughts and will be considered “water-stressed” before the end of the century.

Polymeric thin-film membranes have emerged as leading technology for water purification due to their transport properties, large surface area/low footprint, and low cost of fabrication. Despite their high performance, current polymeric thin-film composite membranes have several limitations. Placing a thin active layer (˜150 nm) on top of a porous support membrane (typically made from polysulfone) is achieved using interfacial polymerization, however, this method is limited to the use of highly reactive precursors based on the polymerization of acyl chlorides with polyamines or polyols. Moreover, the rapid reaction rate of interfacial polymerization forms a rough active layer that leads to membrane fouling. Because the active layer is formed on the already made support membrane, the properties of the support membrane must be considered to form the active layers. For example, solution casting thin films onto the support membrane often causes issues with dissolution of the support polymer or leads to poor lamination of the two layers. Many polymers known for their chlorine tolerance or pH stability, must be thermally cured at higher temperatures than the support membrane can withstand, limiting current curing temperatures to mild conditions.

Thus, there exists a need for new types of polymer membranes as well as methods of their preparation.

### SUMMARY

Described herein are asymmetric thin-film composite membranes. In one aspect, the present disclosure relates to an asymmetric thin-film composite membrane comprising an active layer and a microporous support layer, wherein
the active layer comprises at least one polymer or at least one active agent, and the active layer has a thickness from about 10 nm to about 1,000 nm;
the microporous support layer comprises an epoxy resin; and
the active layer and the microporous support layer are covalently bonded to each other.

In certain embodiments, the active layer comprises at least one polyaniline, at least one polyimide, at least one polybenzimidazolone, at least one polystyrene, at least one polyamide, at least one polybenzimidazole, at least one polybenzoxazole, or a combination thereof.

Also described herein are methods of making and using the aforementioned membranes.

### BRIEF DESCRIPTION OF THE FIGURES

The accompanying figures, which are incorporated in and constitute a part of this specification, illustrate several aspects and together with the description serve to explain and not to limit the scope of current disclosure.

FIG. 1 illustrates representative flow diagram of the fabrication steps to create thin-film lift off (T-FLO) asymmetric thin-film membranes.

FIG. 2 illustrates representative covalent interactions between an epoxy support layer of the asymmetric thin-film membrane and an active layer of the asymmetric thin-film membrane upon curing.

FIG. 3 left illustrates representative curing optimization of the microporous epoxy support to create a more dense structure; right illustrates representative smaller pores and thicker pore walls prevent compaction (scanning electron microscope (SEM)). Using higher concentration of PEG400 as a porogen creates membranes with enhanced density that appears more transparent when wet.

FIG. 4 illustrates representative SEM cross-sectional images displaying membrane morphology and active layer thickness.

FIG. 5 illustrates representative permeability and rejection data for polyimide-amine T-FLO membranes according to some embodiments.

FIG. 6 illustrates representative U-shaped osmosis cell to investigate transport properties of new active layer polymers.

FIG. 7 illustrates representative diagram of high pressure six-cell reverse osmosis apparatus.

FIG. 8 illustrates representative diagram of the gas separation apparatus.

FIG. 9A shows that “sticky” foulants such as alginate and bovine serum albumin require polymer surfaces with higher γ-values to generate repulsive forces.

FIG. 9B demonstrates that modified surfaces with greater γ-values than commercial membranes reduce the attractive forces at the foulant/membrane interface, ultimately reducing fouling.

FIG. 10 depicts a commercial Dow SWLE membrane that was compared directly against a T-FLO membrane with a polybenzimidazole/polystyrene sulfonate (PBI/PSSA) polymer active layer. Each sample's rejection of sodium chloride was tested, then sample were exposed to a basic solution (pH=11) and a solution containing chlorine bleach. When exposed to the chlorine bleach (sodium hypochlorite) for 20 minutes, the commercial RO membrane quickly lost its high rejection. The T-FLO membrane maintained its high rejection of NaCl under the same treatment conditions.

FIG. 11 depicts a solution of ethanol-containing methylene blue as a solute that was pressurized through a polybenzimidazole T-FLO membrane. The membrane rejected ˜90% of the dyed solute in a single pass and steady permeability could be reached up to 300 psi.

FIG. 12A depicts the pressure difference between the inlet and the permeate side with no support and membranes described in example 17.

FIG. 12B depicts the pressure difference between the inlet and the permeate side with the support described in Example 17.

FIG. 13 depicts the comparison of the CO₂ permeance of the membranes with and without the epoxy layer. The pure CO₂ and N₂ permeance variation and ideal selectivity (CO₂/N₂) were measured at 7 psi (0.048 MPa) feed pressure. The CO₂ permeability of PANi film membrane (without epoxy layer) is slightly higher than the PANi support membrane produced. However, the difference in CO₂ and N₂ permeance was not significant, which indicated that CO₂ and N₂ permeance were not affected by epoxy layer. This can be explained by the fact that the produced epoxy layer had a larger pore size, which could not reduce the penetration of the gases. When the pore size of support decreases enough to affect gas transport in the membrane, it follows both surface diffusion and molecular sieving mechanisms. No effect of the epoxy support layer on the CO₂/N₂ selectivity was observed in this study.

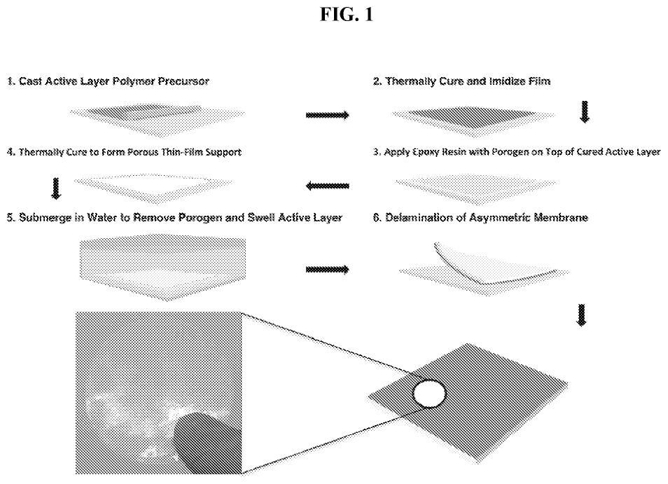

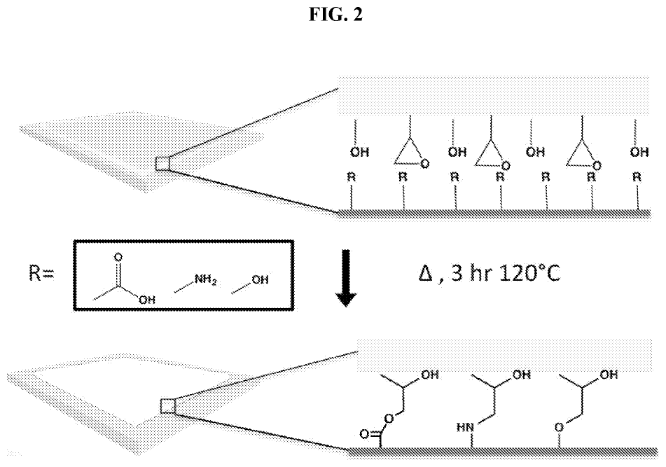

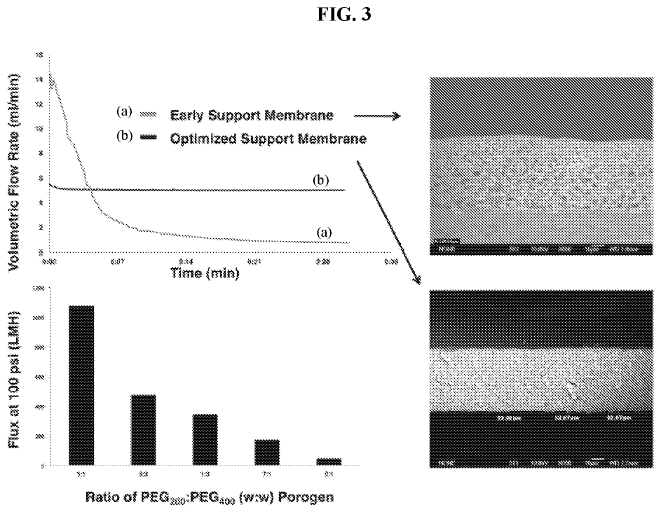

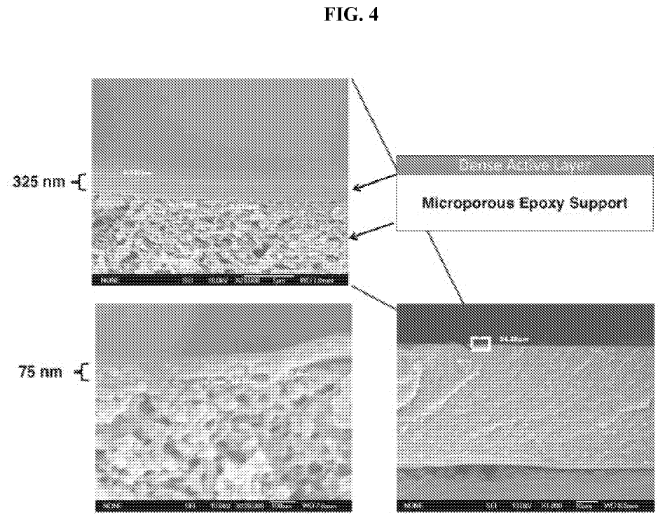

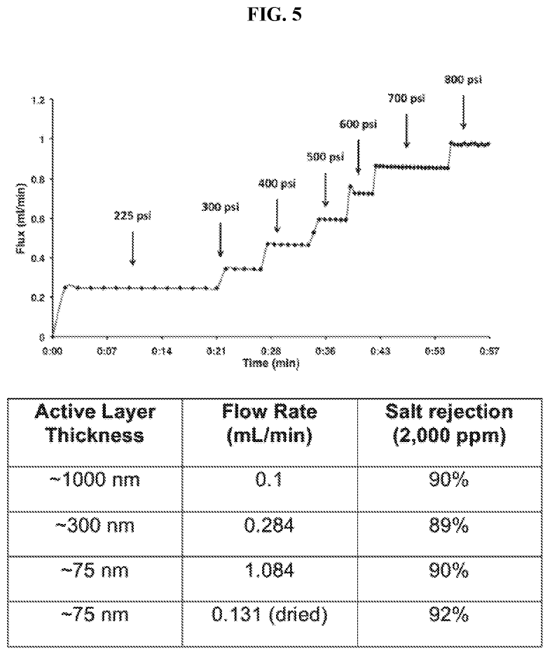

### DETAILED DESCRIPTION

With rapid population growth and increased agricultural demand to support it, worldwide freshwater availability is declining at alarming rates. It is estimated that 1.2 billion people do not have access to safe drinking water, with millions dying annually from diseases transmitted from contaminated water. Developed countries such as the United States are undergoing unprecedented droughts and in some cases, will be considered “water-stressed” before the end of the century. Diminishing groundwater resources are being contaminated with increasing amounts of heavy metals, micropollutants, and reproductive toxins. Chemicals added to disinfect water supplies negatively impact the environment and often undergo side reactions that generate high levels of carcinogens in drinking water.

The oceans, which hold about 97% of the world's water, represent an almost infinite source of water if energy-efficient, low-cost technologies can be developed to produce freshwater directly from seawater. In some instances, thin-film polymeric membranes provide a method to continuously remove salt from seawater through reverse osmosis (RO). As saline water is pressurized across a semi-permeable polymer film, water and salt ions diffuse through the polymer membrane at different rates. The greater the permeation rate of water compared to the permeation rate of the salt ions, the greater the selectivity or apparent rejection of salt. In some cases, membranes with high salt selectivity are utilized to perform single-pass RO to convert seawater to freshwater at lower energy costs.

In the case of polymer films, permeants dissolved into the polymer matrix and diffused through the membrane are driven by concentration and pressure gradients. This phenomenon holds true in membranes for pervaporation, dialysis, reverse osmosis, and gas separation. For desalination, suitable polymers have high permeation rates for water and low permeation rates for salts. The polymer films are screened as dense films to determine the diffusivity of water (Dw) and diffusivity of salt (Ds) through the membranes. Polymers with a high Dw/Ds ratio are suitable for high selectivity; however, there is a trade-off. Polymers with high selectivity that swell in water often possess very low permeability, and on the other hand, many hydrophilic polymers have high permeability but low selectivity. The earliest candidates are cellulose-based polymers with varying degrees of acetylation. By tuning the degree of acetylation, the amount of polymer swelling in a salt solution could be controlled, and in turn, the Dw/Ds of the material can be controlled as well.

Although the relationship of Dw to Ds is dependent on the chemical structure of the polymeric material, the permeation rate of the polymer film is also dependent on the film thickness. Theoretically, a thin polymer film will have greater permeability than a thick film of identical material, while maintaining the same salt rejection. Therefore, several new methods are developed to reduce the thickness of RO membranes. The first commercially viable RO membrane is produced by casting an asymmetric cellulose acetate (CA) thin-film membrane by phase inversion to form a thin, dense active layer supported by a microporous underlayer that is able withstand the high pressure of RO. The active layer, estimated to be 200 nm thick, afforded the highest permeability of any RO membrane at the time.

Despite its early success, CA membranes suffer from biodegradation, compaction, and poor pH stability, necessitating continued research into more robust materials for RO. Several classes of polymers are used as suitable RO permeators, especially amide-linked polymers. Cadotte et al. developed a new fabrication technique, leveraging the ability of polyamides to be interfacially polymerized, to form a polyamide (PA) active layer of about 150 nm on a porous polysulfone support. The new thin-film composite membranes exhibited greater transport properties and chemical and thermal stability compared to CA membranes.

Like CA membranes, current PA membranes have several drawbacks for desalination. Although they have good resistance to biological attack, PA active layers are susceptible to fouling by microorganisms, inorganic scaling, and colloids in the feed solution. The rapid kinetics of the interfacial polymerization causes the membrane surfaces to be rough, which leads to accelerated fouling rates, as biological agents can readily attach themselves to rough surfaces. Additionally, the polyamide bond might be cleaved by common oxidants; thus, common cleaning agents such as hypochlorite cannot come in contact with the membrane. Furthermore, studying the PA active layer is cumbersome. When the active layer is strongly bound to the support, it is very difficult to isolate and investigate the intrinsic properties of the thin-film polymer.

Biofouling or biological fouling is the accumulation of microorganisms, plants, algae, or animals on a wet surface. In some instances, biofouling is further subdivided into microfouling or macrofouling. Microfouling comprises the attachment of microorganisms (e.g., bacteria or fungi) and/or the formation of biofilm. Macrofouling is the attachment and accumulation of macroorganisms.

Biofilm is the formation of surface-associated microorganisms encased within an extracellular polymeric substance (ESP). The ESP can comprise polysaccharides, proteins, DNA, and/or lipids. The formation and development of the biofilm can occurs with a deposit of a first conditioning film which composes of organic materials such as protein, polysaccharide, and proteoglycan to increase the stickiness of the surface for a microorganism to adhere to. The biofilm then develops as microorganisms (e.g., bacteria) adhere to the surface. Colonization further leads to secretion of EPS and biofilm matures with secondary adhesion of microorganisms (e.g., bacteria).

In some instances, microorganisms (e.g., bacteria) growing within a biofilm is more resistant to antibiotics and disinfectants than planktonic cells (or free-flowing microorganisms) and the resistance increases with the age of the biofilm. Further, a bacterial biofilm, for example, also exhibits increased physical resistance towards desiccation, extreme temperatures and/or light.

Conventional methods of killing a microorganism (e.g., bacteria) such as antibiotics and chemical disinfection are sometimes ineffective with biofilm-associated microorganisms (e.g., bacteria). For example, sometimes a large quantity of antimicrobials is required to remove biofilm-causing microorganisms (e.g., bacteria) and the quantity can be environmentally undesirable and/or impractical. Standard chemical disinfectants and antibiotics can also fail to penetrate biofilms fully or fail to be fully cytocidal for species and metabolic states existing within the films. Furthermore, typical biocides kill the bacteria by damaging the cell wall structure, which in turn can results in the release of more toxic endotoxins.

Also described herein are asymmetric thin-film composite membranes, biofouling resistant asymmetric thin-film composite membranes, processes of making an asymmetric thin-film composite membrane, methods of purifying solutions using an asymmetric thin-film composite membrane, and methods of separating gas mixtures using an asymmetric thin-film composite membrane.

In one aspect, the present disclosure relates to an asymmetric thin-film composite membrane comprising an active layer and a microporous support layer, wherein
the active layer comprises at least one polymer or at least one active agent, and the active layer has a thickness from about 10 nm to about 1,000 nm;
the microporous support layer comprises an epoxy resin; and the active layer and the microporous support layer are covalently bonded to each other.

In certain embodiments, the active layer comprises at least one polyaniline, at least one polyimide, at least one polybenzimidazolone, at least one polystyrene, at least one polyamide, at least one polybenzimidazole, at least one polybenzoxazole, or a combination thereof.

In one aspect, described herein is an asymmetric thin-film composite membrane comprising:

(a) an active layer; and
(b) a microporous support layer,
wherein said active layer has thickness from about 10 nm to about 1000 nm, and wherein said active layer and said microporous support layer are bonded to each other covalently.

In some embodiments, the active layer comprises at least one polyaniline. In some embodiments, the active layer comprises at least one polyimide e.g., wherein the polyimide is aromatic. In some embodiments, the active layer comprises at least one polybenzimidazolone. In some embodiments, the active layer comprises at least one polyamide, e.g., wherein the polyamide is aromatic. In some embodiments, the active layer comprises at least one polybenzimidazole. In some embodiments, the active layer comprises at least one polybenzoxazole. In some embodiments, the active layer comprises one or more materials selected from zeolites, metal-organic frameworks, nanoporous carbides, TiO₂ nanoparticles, and carbon nanotubes.

In some embodiments, the microporous support layer comprises at least one polymer-based epoxy resin, and/or a hardener.

In some embodiments, the asymmetric thin-film composite membrane disclosed herein is resistant to fouling. For example, the asymmetric thin-film composite membrane disclosed herein may prevent and/or reduce biofouling, such as microfouling (e.g., by a bacterium or a fungus) and/or macrofouling (e.g., biofilm and bacterial adhesion). In some embodiments, microfouling is formed by a gram-positive bacterium, such as a bacterium from the genus Actinomyces, Arthrobacter, Bacillus, Clostridium, Corynebacterium, Enterococcus, Lactococcus, Listeria, Micrococcus, Mycobacterium, Staphylococcus, or Streptococcus. In some embodiments, the gram-positive bacterium comprises Actinomyces spp., Arthrobacter spp., Bacillus licheniformis, Clostridium difficile, Clostridium spp., Corynebacterium spp., Enterococcus faecalis, Lactococcus spp., Listeria monocytogenes, Micrococcus spp., Mycobacterium spp., Staphylococcus aureus, Staphylococcus epidermidis, Streptococcus pneumoniae, or Streptococcus pyogenes. In some embodiments, microfouling is formed by a gram-negative bacterium, such as a bacterium from the genus Alteromonas, Aeromonas, Desulfovibrio, Escherichia, Fusobacterium, Geobacter, Haemophilus, Klebsiella, Legionella, Porphyromonas, Proteus, Pseudomonas, Serratia, Shigella, Salmonella, or Vibrio. Representative species of such gram-negative bacteria include Alteromonas spp., Aeromonas spp., Desulfovibrio spp., Escherichia coli, Fusobacterium nucleatum, Geobacter spp., Haemophilus spp., Klebsiella spp., Legionella pneumophila, Porphyromonas spp., Pseudomonas aeruginosa, Proteus vulgaris, Proteus mirabilis, Proteus penneri, Serratia spp., Shigella dysenteriae, Shigella flexneri, Shigella boydii, Shigella sonnei, Salmonella bongori, Salmonella enterica, or Vibrio cholerae. In some embodiments, the bacterium is a marine bacterium, e.g., Pseudoalteromonas spp. or Shewanella spp. In some embodiments, microfouling is formed by a fungus, e.g., Candida albicans, Candida glabrata, Candida rugose, Candida parapsilosis, Candida tropicalis, Candida dubliniensis, or Hormoconis resinae. In some embodiments, macrofouling comprises growth of a calcareous fouling organism (barnacle, bryozoan, mollusk, polychaete, tube worm, or zebra mussel) or non-calcareous fouling organism (e.g., seaweed, hydroids, or algae). In some embodiments, a surface coated with an asymmetric thin-film composite membrane reduces the formation of biofouling by about 10%, 20%, 30%, 40%, 50%, 60%, 70%, 80%, 90%, 95%, 99%, or more relative to a surface not coated with the asymmetric thin-film composite membrane. In some embodiments, a surface coated with an asymmetric thin-film composite membrane reduces the formation of biofouling by about 10%, 20%, 30%, 40%, 50%, 60%, 70%, 80%, 90%, 95%, 99%, or more relative to a surface coated with a commercial RO membrane.

In another aspect, described herein is a process of making an asymmetric thin-film composite membrane comprising:
providing a substrate having a top surface and a bottom surface;
applying an active layer to the top surface of the substrate;
exposing the active layer to a heat source;
applying epoxy resin microporous support layer on top of the thermally exposed active layer;
exposing the microporous support layer to a heat source to form an asymmetric thin-film composite membrane; wherein said active layer and said microporous support layer are bonding to each other covalently;
exposing the asymmetric thin-film composite membrane to water; and
optionally separating the membrane from the substrate.

In some embodiments, the substrate is inorganic substrate, e.g., glass or metal. In some embodiments, the substrate is a non-woven fiber material.

In some embodiments, the active layer comprises at least one polyaniline. In some embodiments, the active layer comprises at least one polyimide, e.g., wherein the polyimide is aromatic. In some embodiments, the active layer comprises at least one polybenzimidazolone. In some embodiments, the active layer comprises at least one polyamide, e.g., wherein the polyamide is aromatic. In some embodiments, the active layer comprises at least one polybenzimidazole. In some embodiments, the active layer comprises at least one polybenzoxazole. In some embodiments, the active layer comprises one or more materials selected from zeolites, metal-organic frameworks, nanoporous carbides, TiO₂ nanoparticles, and carbon nanotubes.

In some embodiments, the microporous support layer comprises at least one polymer-based epoxy resin. In some such embodiments, the said microporous support layer additionally comprises a hardener, and/or one or more porogens.

In yet another aspect, described herein is a method of purifying a solution, the method comprising:
(a) providing an asymmetric thin-film membrane comprising an active layer and a microporous support layer,
wherein said active layer has thickness from about 10 nm to about 1000 nm, and
wherein said active layer and said microporous support layer are bonded to each other covalently;
(b) contacting an active layer face of the membrane with a first solution of a first volume having a first contaminant concentration at a first pressure; and
(c) contacting a microporous support layer face of the membrane with a second solution of a second volume optionally having a second contaminant concentration at a second pressure;
wherein the first solution is in fluid communication with the second solution through the membrane,
wherein the first contaminant concentration is higher than the second contaminant concentration, thereby creating an osmotic pressure across the membrane, and
wherein the first pressure is sufficiently higher than the second pressure to overcome the osmotic pressure to increase the second volume and decrease the first volume, and wherein the first contaminant remains on the active layer face, thereby generating a purified solution.

In yet another aspect, described herein is a method of separating a contaminant from a gas, the method comprising:
(a) providing an asymmetric thin-film membrane comprising an active layer and a microporous support layer,
wherein said active layer has thickness from about 10 nm to about 1000 nm, and wherein said active layer and said microporous support layer are bonded to each other covalently;
(b) contacting an active layer face of the membrane with a first gas mixture of a first volume having a first contaminant concentration at a first pressure; and
(c) contacting a microporous support layer face of the membrane with a second gas mixture of a second volume optionally having a second contaminant concentration at a second pressure;
wherein the first gas mixture is in communication with the second gas mixture through the membrane,
wherein the first contaminant concentration is higher than the second contaminant concentration, thereby creating an osmotic pressure across the membrane, and wherein the first pressure is sufficiently higher than the second pressure to increase
the second volume and decrease the first volume, and wherein the first contaminant remains on the active layer face, thereby generating a purified gas.

In some embodiments, provided herein are asymmetric thin-film composite membranes. In some embodiments, the asymmetric thin-film composite membranes are used in desalination of water. In some embodiments, the asymmetric thin-film composite membranes comprise anti-fouling properties and are used to prevent and/or to reduce the development of biofouling. In some embodiments, the asymmetric thin-film composite membranes prevent and/or reduce the attachment of microorganisms, plants, algae, or animals to a surface. In some embodiments, the asymmetric thin-film composite membranes are used in wastewater treatment. In some embodiments, the asymmetric thin-film composite membranes are used in ultrafiltration. In some embodiments, the asymmetric thin-film composite membranes are used in kidney dialysis. In some embodiments, the asymmetric thin-film composite membranes are used in nanofiltration. In some embodiments, the asymmetric thin-film composite membranes are used in gas separation.

In certain embodiments, also provided herein are surfaces coated with one or more asymmetric thin-film composite membranes disclosed herein. In some instances, provided herein are materials coated with one or more asymmetric thin-film composite membranes disclosed herein.

In additional embodiments, disclosed herein are the components to be used to prepare the asymmetric thin-film composite membranes of the disclosure as well as the asymmetric thin-film composite membrane themselves to be used within the methods disclosed herein.

### Asymmetric Thin-Film Composite Membranes

In one aspect, described herein is an asymmetric thin-film composite membrane comprising an active layer and a microporous support layer, wherein
the active layer comprises at least one polymer or at least one active agent, wherein the active layer has a thickness from about 10 nm to about 1,000 nm;
the microporous support layer comprises an epoxy resin; and
the active layer and the microporous support layer are covalently bonded to each other.

In another aspect, described herein is an asymmetric thin-film composite membrane comprising:
an active layer; and
a microporous support layer,
wherein said active layer has thickness from about 10 nm to about 1000 nm, and
wherein said active layer and said microporous support layer are bonded to each other covalently.

### Active Layers

In some embodiments, the active layer of the asymmetric thin-film composite membrane comprises at least one polyaniline.

In some embodiments, the polyaniline is emeraldine base. In some such embodiments, the emeraldine base has the structure:

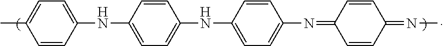

In some embodiments, the active layer of the asymmetric thin-film composite membrane comprises at least one polyimide. In some embodiments, the polyimide is aromatic such as a polyimide having a structure:

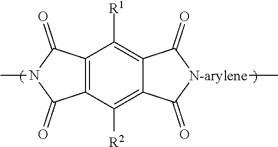

wherein,
R¹ is H, D, halogen, —CN, —OR³, —SR³, —S(═O)R³, —S(═O)₂R³, —C(═O)R³, —C(═O)OR³, —N(R³)₂ substituted or unsubstituted C₁-C₆alkyl, substituted or unsubstituted C₁-C₆fluoroalkyl, substituted or unsubstituted C₁-C₆heteroalkyl, substituted or unsubstituted C₃-C₆cycloalkyl, substituted or unsubstituted aryl, substituted or unsubstituted benzyl, or substituted or unsubstituted monocyclic heteroaryl;
R² is H, D, halogen, —CN, —OR³, —SR³, —S(═O)R³, —S(═O)₂R³, —C(═O)R³, —C(═O)OR³, —N(R³)₂ substituted or unsubstituted C₁-C₆alkyl, substituted or unsubstituted C₁-C₆fluoroalkyl, substituted or unsubstituted C₁-C₆heteroalkyl, substituted or unsubstituted C₃-C₆cycloalkyl, substituted or unsubstituted aryl, substituted or unsubstituted benzyl, or substituted or unsubstituted monocyclic heteroaryl; and
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle.

In some embodiments, the arylene group of aromatic polyimide is:

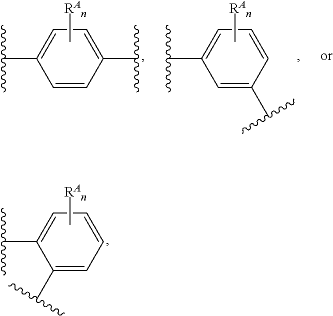

wherein each R^{A} is independently selected from H, D, halogen, —CN, —NO₂, —OR³, —SR³, —S(═O)R³, —S(═O)₂R³, —S(═O)₂N(R³)₂, —NR³S(═O)₂R³, —C(═O)R³, —OC(═O)R³, —C(═O)OR³, —OC(═O)OR³, —C(═O)N(R³)₂, and —N(R³)₂;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
n is 0, 1, 2, 3, or 4.

In some embodiments, the arylene group of aromatic polyimide is:

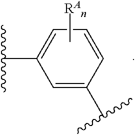

In some embodiments, the aromatic polyimide has the structure of:

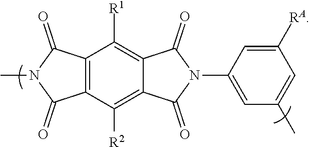

In some embodiments, R¹ is H. In some embodiments, R² is H. In some embodiments, R^{A} is H, —C(═O)OH, —C(═O)OCH₃, or —C(═O)NH₂. In some embodiments, R^{A} is H. In some embodiments, R^{A} is —C(═O)OH. In some embodiments, R^{A} is —C(═O)OCH₃. In some embodiments, R^{A} is —C(═O)NH₂.

In some embodiments, the active layer of the asymmetric thin-film composite membrane comprises at least one polybenzimidazolone, such as a polybenzimidazolone having a structure:

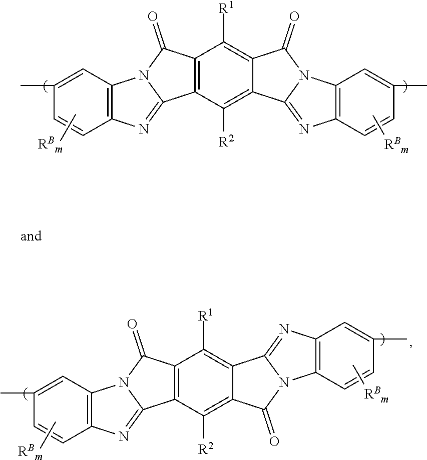

wherein each R^{B} is independently selected from H, D, halogen, —CN, —NO₂, —OR³, —SR³, —S(═O)R³, —S(═O)₂R³, —S(═O)₂N(R³)₂, —NR³S(═O)₂R³, —C(═O)R³, —OC(═O)R³, —C(═O)OR³, —OC(═O)OR³, and —N(R³)₂;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
m is 0, 1, 2, or 3.

In some embodiments, the active layer of the asymmetric thin-film composite membrane comprises at least one polyamide. In some embodiments, the polyamide has the structure of:

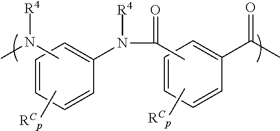

each R⁴ is independently H, D, —S(═O)R³, —S(═O)₂R³, —S(═O)₂N(R³)₂, —C(═O)R³, —C(═O)OR³, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl; or
two R^{C} are taken together to form a cross link;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

In some embodiments, the polyamide has the structure of:

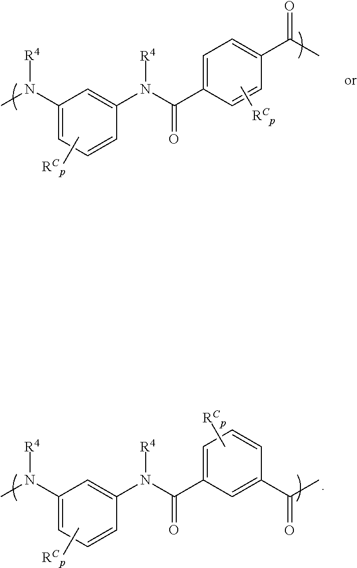

In some embodiments, the active layer of the asymmetric thin-film composite membrane comprises at least one polybenzimidazole, such as a polybenzimidazole having a structure:

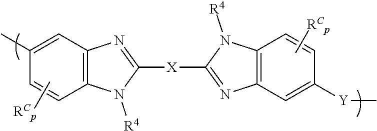

wherein,
X is absent, substituted or unsubstituted C₁-C₆alkylene, or substituted or unsubstituted arylene;
Y is absent, substituted or unsubstituted C₁-C₄alkylene, or substituted or unsubstituted arylene;
each R⁴ is independently H, D, —S(═O)R³, —S(═O)₂R³, —S(═O)₂N(R³)₂, —C(═O)R³, —C(═O)OR³, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

In some embodiments, the active layer of the asymmetric thin-film composite membrane comprises at least one polybenzoxazole, such as a polybenzoxazole having a structure:

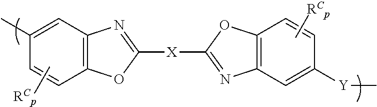

wherein,
X is absent, substituted or unsubstituted C₁-C₈alkylene, or substituted or unsubstituted arylene;
Y is absent, substituted or unsubstituted C₁-C₄alkylene, or substituted or unsubstituted arylene;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

In some embodiments, the active layer of the asymmetric thin-film composite membrane comprises at least one polystyrene, such as a polystyrene having a structure:

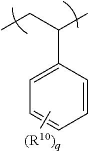

wherein
each R¹⁰ is independently alkyl, hydroxyl, nitro, halo, amino, alkoxy, or sulfonyl; and
q is 1, 2, 3, 4, or 5.

In some embodiments, R¹⁰ is sulfonyl and q is 1.

In some embodiments, the polystyrene has the structure:

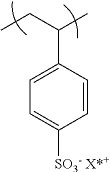

wherein X* is a positive counter ion (e.g., sodium, lithium, potassium, calcium).

In some embodiments, the active layer of the asymmetric thin-film composite membrane comprises polybenzimidazole/polystyrene sulfonate (PBI/PSSA) polymer.

In some embodiments, the active layer of the asymmetric thin-film composite membrane comprises one or more materials selected from the group consisting of zeolites, metal-organic frameworks, nanoporous carbides, TiO₂ nanoparticles, and carbon nanotubes.

In some embodiments, the active layer of the asymmetric thin-film composite membrane comprises zeolites. In some embodiments, the active layer of the asymmetric thin-film composite membrane comprises metal-organic frameworks. In some embodiments, the active layer of the asymmetric thin-film composite membrane comprises nanoporous carbides. In some embodiments, the active layer of the asymmetric thin-film composite membrane comprises TiO₂ nanoparticles. In some embodiments, the active layer of the asymmetric thin-film composite membrane comprises carbon nanotubes.

In some embodiments, the active layer of the asymmetric thin-film composite membrane has a thickness of about 1 nm to about 1,000 nm. In some embodiments, the active layer of the asymmetric thin-film composite membrane has a thickness of at least about 1 nm.

In some embodiments, the active layer of the asymmetric thin-film composite membrane has a thickness of at most about 1,000 nm. In some embodiments, the active layer of the asymmetric thin-film composite membrane has a thickness of at least about 1 nm, about 10 nm, about 20 nm, about 30 nm, about 40 nm, about 50 nm, about 75 nm, about 100 nm, about 150 nm, about 200 nm, about 250 nm, about 300 nm, about 350 nm, about 400 nm, about 450 nm, about 500 nm, about 600 nm, about 750 nm, or about 1,000 nm. In some embodiments, the active layer of the asymmetric thin-film composite membrane has a thickness of no more than about 1 nm, about 10 nm, about 20 nm, about 30 nm, about 40 nm, about 50 nm, about 75 nm, about 100 nm, about 150 nm, about 200 nm, about 250 nm, about 300 nm, about 350 nm, about 400 nm, about 450 nm, about 500 nm, about 600 nm, about 750 nm, or about 1,000 nm. In some embodiments, the active layer of the asymmetric thin-film composite membrane has a thickness of about 1 nm to about 10 nm, about 1 nm to about 50 nm, about 1 nm to about 75 nm, about 1 nm to about 100 nm, about 1 nm to about 150 nm, about 1 nm to about 200 nm, about 1 nm to about 250 nm, about 1 nm to about 500 nm, about 1 nm to about 750 nm, about 1 nm to about 1,000 nm, about 10 nm to about 50 nm, about 10 nm to about 75 nm, about 10 nm to about 100 nm, about 10 nm to about 150 nm, about 10 nm to about 200 nm, about 10 nm to about 250 nm, about 10 nm to about 500 nm, about 10 nm to about 750 nm, about 10 nm to about 1,000 nm, about 50 nm to about 75 nm, about 50 nm to about 100 nm, about 50 nm to about 150 nm, about 50 nm to about 200 nm, about 50 nm to about 250 nm, about 50 nm to about 500 nm, about 50 nm to about 750 nm, about 50 nm to about 1,000 nm, about 75 nm to about 100 nm, about 75 nm to about 150 nm, about 75 nm to about 200 nm, about 75 nm to about 250 nm, about 75 nm to about 500 nm, about 75 nm to about 750 nm, about 75 nm to about 1,000 nm, about 100 nm to about 150 nm, about 100 nm to about 200 nm, about 100 nm to about 250 nm, about 100 nm to about 500 nm, about 100 nm to about 750 nm, about 100 nm to about 1,000 nm, about 150 nm to about 200 nm, about 150 nm to about 250 nm, about 150 nm to about 500 nm, about 150 nm to about 750 nm, about 150 nm to about 1,000 nm, about 200 nm to about 250 nm, about 200 nm to about 500 nm, about 200 nm to about 750 nm, about 200 nm to about 1,000 nm, about 250 nm to about 500 nm, about 250 nm to about 750 nm, about 250 nm to about 1,000 nm, about 500 nm to about 750 nm, about 500 nm to about 1,000 nm, or about 750 nm to about 1,000 nm.

In some embodiments, the active layer of the asymmetric thin-film composite membrane has a thickness of about 1 nm, about 2 nm, about 5 nm, about 10 nm, about 15 nm, about 20 nm, about 25 nm, about 30 nm, about 35 nm, about 40 nm, about 45 nm, about 50 nm, about 55 nm, about 60 nm, about 65 nm, about 70 nm, about 75 nm, about 80 nm, about 85 nm, about 90 nm, about 95 nm, about 100 nm, about 110 nm, about 120 nm, about 130 nm, about 140 nm, about 150 nm, about 160 nm, about 170 nm, about 180 nm, about 190 nm, about 200 nm, about 210 nm, about 220 nm, about 230 nm, about 240 nm, about 250 nm, about 260 nm, about 270 nm, about 280 nm, about 290 nm, about 300 nm, about 310 nm, about 320 nm, about 330 nm, about 340 nm, about 350 nm, about 360 nm, about 370 nm, about 380 nm, about 390 nm, about 400 nm, about 410 nm, about 420 nm, about 430 nm, about 440 nm, about 450 nm, about 460 nm, about 470 nm, about 480 nm, about 490 nm, about 500 nm, about 510 nm, about 520 nm, about 530 nm, about 540 nm, about 550 nm, about 560 nm, about 570 nm, about 580 nm, about 590 nm, about 600 nm, about 610 nm, about 620 nm, about 630 nm, about 640 nm, about 650 nm, about 660 nm, about 670 nm, about 680 nm, about 690 nm, about 700 nm, about 710 nm, about 720 nm, about 730 nm, about 740 nm, about 750 nm, about 760 nm, about 770 nm, about 780 nm, about 790 nm, about 800 nm, about 810 nm, about 820 nm, about 830 nm, about 840 nm, about 850 nm, about 860 nm, about 870 nm, about 880 nm, about 890 nm, about 900 nm, about 910 nm, about 920 nm, about 930 nm, about 940 nm, about 950 nm, about 960 nm, about 970 nm, about 980 nm, about 990 nm, or about 1000 nm.

### Microporous Support Layers

In some embodiments, the microporous support layer of the asymmetric thin-film composite membrane comprises at least one polymer-based epoxy resin.

Epoxy resins are characterized by the three-membered ether group commonly referred to as an epoxy group. In some embodiments, epoxy resins are linear chain molecules comprising the coreaction product of polynuclear dihydroxy phenols or bisphenols with halohydrins to produce epoxy resins containing one or more epoxy groups per molecule. In some embodiments, bisphenols are bisphenol-A, bisphenol-F, bisphenol-S, and 4,4′dihydroxy bisphenol. Halohydrins include epichlorohydrin, dichlorohydrin, and 1,2-dichloro-3-hydroxypropane. In some embodiments, epoxy resins comprise the coreaction product of excess molar equivalents of epichlorohydrin and bisphenol-A to produce predominantly an epoxy group terminated linear molecular chain of repeating units of diglycidyl ether of bisphenol-A containing between 2 and 30 repeating copolymerized units of diglycidyl ether of bisphenol-A. In practice, an excess molar equivalent of epichlorohydrin is reacted with bisphenol-A to produce epoxy resins where up to two moles of epichlorohydrin coreact with one mole of bisphenol-A, although less than complete reaction can produce difunctional epoxy resin along with monoepoxide chains terminated at the other end with a bisphenol-A unit. In some embodiments, linear epoxy resins are polyglycidyl ethers of bisphenol-A having terminating 1,2-epoxide groups and an epoxy equivalent weight between about 175 and 4,000, and a number average molecular weight from about 400 to 40,000 as measured by gel permeation chromatography (GPC).

In some embodiments, the epoxy groups are terminal epoxy groups. In some embodiments, the epoxy groups are internal epoxy groups. The epoxides are of two general types: polyglycidyl compounds or products derived from epoxidation of dienes or polyenes. Polyglycidyl compounds contain a plurality of 1,2-epoxide groups derived from the reaction of a polyfunctional active hydrogen containing compound with an excess of an epihalohydrin under basic conditions. When the active hydrogen compound is a polyhydric alcohol or phenol, the resulting epoxide composition contains glycidyl ether groups.

In some embodiments, trifunctional epoxy resins comprising branched chain epoxy resins are used, wherein the branched chains as well as the backbone chain are each terminated with a terminal epoxide group to provide functionality that is greater than two epoxide. Trifunctional epoxy resins can be produced by coreacting epichlorohydrin with polynuclear polyhydroxy phenols, trifunctional phenols, or aliphatic trifunctional alcohols.

In some embodiments, the polymer-based epoxy resin is diglycidyl ether-based epoxy resin. In some embodiments, the polymer-based epoxy resin is DER 333, DER 661, EPON 828, EPON 836, EPON 1001, EPON 1007F, Epikote 826, Epikote 828, ERL-4201, ERL-4221, GT-7013, GT-7014, GT-7074, GT-259, or any combination thereof. In some embodiments, the polymer-based epoxy resin is DER 333. In some embodiments, the polymer-based epoxy resin is DER 661. In some embodiments, the polymer-based epoxy resin is EPON 828. In some embodiments, the polymer-based epoxy resin is EPON 836. In some embodiments, the polymer-based epoxy resin is EPON 1001. In some embodiments, the polymer-based epoxy resin is EPON 1007F. In some embodiments, the polymer-based epoxy resin is Epikote 826. In some embodiments, the polymer-based epoxy resin is Epikote 828. In some embodiments, the polymer-based epoxy resin is ERL-4201. In some embodiments, the polymer-based epoxy resin is ERL-4221. In some embodiments, the polymer-based epoxy resin is GT-7013. In some embodiments, the polymer-based epoxy resin is GT-7014. In some embodiments, the polymer-based epoxy resin is GT-7074. In some embodiments, the polymer-based epoxy resin is GT-259.

In some embodiments, the epoxy resin is tetraglycidyl-4,4′-(4-aminophenyl)-p-diisopropylbenzene (EPON HPT 1071). In some embodiments, the epoxy resin is tetraglycidyl-4,4′-(3,5-dimethyl-4-aminophenyl)-p-diisopropylbenzene (EPON HPT 1072). In some embodiments, the epoxy resin is tetraglycidyl 4,4′-diamino diphenyl methane (MY-720). As the resin is prepared by reacting epichlorohydrin with methylene dianiline, it is frequently identified as tetraglycidylated methylene dianiline (TGMDA).

In some embodiments, the epoxy resin is polyglycidyl ethers of 4,4′-dihydroxyphenyl methane, 4,4′-dihydroxyphenyl sulfone, 4,4′-dihydroxydiphenyl sulfide, phenolphthalein, resorcinol, or tris(4-hydroxyphenyl)methane and the like. In some embodiments, the epoxy resin is EPON 1031 (a tetraglycidyl derivative of 1,1,2,2-tetrakis(hydroxyphenyl) ethane). In some embodiments, the epoxy resin is Apogen 101 (a methylolated bisphenol A resin). In some embodiments, the epoxy resin is halogenated polyglycidyl compound such as D.E.R. 542 (a brominated bisphenol A epoxy resin). Other suitable epoxy resins include polyepoxides prepared from polyols such as pentaerythritol, glycerol, butanediol, or trimethylolpropane and an epihalohydrin.

Other polyfunctional active hydrogen compounds besides phenols and alcohols are used to prepare the polyglycidyl adducts. They include amines, aminoalcohols, and polycarboxylic acids.

Suitable polyglycidyl adducts derived from aminoalcohols include O,N,N-triglycidyl-4-aminophenol available as Araldite 0500 or Araldite 0510 and O,N,N-triglycidyl-3-aminophenol (available as Glyamine 115).

In some embodiments, the glycidyl esters of carboxylic acids are used. Such glycidyl esters include, for example, diglycidyl phthalate, diglycidyl terephthalate, diglycidyl isophthalate, and diglycidyl adipate. In some embodiments, the resin is polyepoxide such as triglycidyl cyanurates and isocyanurates, N,N-diglycidyl oxamides, N,N′-diglycidyl derivates of hydantoins such as “XB 2793” diglycidyl esters of cycloaliphatic dicarboxylic acids, and polyglycidyl thioethers of polythiols.

Other epoxy-containing materials are copolymers of acrylic acid esters of glycidol such as glycidyl acrylate and glycidyl methacrylate with one or more copolymerizable vinyl compounds. Examples of such copolymers are 1:1 styrene-glycidyl methacrylate, 1:1 methyl methacrylate-glycidyl acrylate and 62.5:24:13.5 methyl methacrylate:ethyl acrylate:glycidyl methacrylate.

In some embodiments, the microporous support layer of the asymmetric thin-film composite membrane comprises at least one hardener.

The epoxy resins might be cured in a conventional manner. Suitable hardeners for the epoxy resins include sulfanilamide, dicyandiamide, aromatic amines such as diamino diphenyl sulfone ((4-H₂NC₆H₄)₂SO₂, DDS), bis(4-aminophenyl) methane, the bis(aminophenyl)diethers including 2,2-bis [4-[4-aminiophenoxy) phenyl]-1,3-trifluoropropane, bis[4-(4-aminophenoxy) phenyl]sulfone, and bisphenol A ether diamine (4-(4-H₂NC₆H₄—O)C₆H₄)₂C(CH₃)₂, BPADA); m-phenylenediamine, p-phenylenediamine, 1,6-diaminonaphthalene, 4,4′-diaminodiphenyl ether, 3-methyl-4-aminobenzamide, alpha, alpha′-bis(4-aminophenyl)-metadiisopropylbenzene, alpha, alpha′-bis(4-aminophenyl)-para-diisopropylbenzene, 1,3-bis(4-aminophenyl)benzene, and 1,3-bis(3-aminophenoxy) benzene, and polycarboxylic acid anhydrides such as hexahydrophthalic acid dianhydride, methylbicyclo[2,2,1]-hept-5-ene-2,3-dicarboxylic acid anhydride, pyromellitic acid dianhydride, bis-2,2-(4-phthalicanhydrido)hexafluoropropane, and benzophenone tetracarboxylic acid dianhydride. In some embodiments, the hardener is DDS or BPADA.

In some embodiments, the hardener is being selected from the aromatic polyamines, aliphatic polyamines and their adducts, carboxylic acid anhydrides, polyamides and catalytic curing agents, as for example tertiary amines, imidazoles, BF₃ monoethylamine, and dicyandiamide. In some embodiments, the hardener is aliphatic polyamine. In some embodiments, the hardener is polyamide. In some embodiments, the hardener is amidoamine. In some embodiments, the hardener is cycloaliphatic amine. In some embodiments, the hardener is aromatic amine. In some embodiments, the hardener is diamine hardener.

In some embodiments, the amount of hardener employed to cure the epoxy resins approximates the quantities employed with the presently used commercial resins such as MY-720, EPON HPT 1071, EPON HPT 1072, and EPON 828. In some embodiments, the amount of hardener is from about 0.05 to about 2 weight equivalents per one weight equivalents of the epoxy resin. In some embodiments, the amount of hardener is from about 0.1 to about 1.5 weight equivalents. In some embodiments, about 0.5 to about 1 weight equivalents.

In some embodiments, the amount of hardener is about 0.05 weight equivalents, about 0.1 weight equivalents, about 0.15 weight equivalents, about 0.2 weight equivalents, about 0.25 weight equivalents, about 0.3 weight equivalents, about 0.35 weight equivalents, about 0.4 weight equivalents, about 0.45 weight equivalents, about 0.5 weight equivalents, about 0.55 weight equivalents, about 0.6 weight equivalents, about 0.65 weight equivalents, about 0.7 weight equivalents, about 0.75 weight equivalents, about 0.8 weight equivalents, about 0.85 weight equivalents, about 0.9 weight equivalents, about 0.95 weight equivalents, about 1 weight equivalent, about 1.05 weight equivalents, about 1.1 weight equivalents, about 1.15 weight equivalents, about 1.2 weight equivalents, about 1.25 weight equivalents, about 1.3 weight equivalents, about 1.35 weight equivalents, about 1.4 weight equivalents, about 1.45 weight equivalents, or about 1.5 weight equivalents. In some embodiments, the amount of hardener is at least about 0.05 weight equivalents, about 0.1 weight equivalents, about 0.15 weight equivalents, about 0.2 weight equivalents, about 0.25 weight equivalents, about 0.3 weight equivalents, about 0.35 weight equivalents, about 0.4 weight equivalents, about 0.45 weight equivalents, about 0.5 weight equivalents, about 0.55 weight equivalents, about 0.6 weight equivalents, about 0.65 weight equivalents, about 0.7 weight equivalents, about 0.75 weight equivalents, about 0.8 weight equivalents, about 0.85 weight equivalents, about 0.9 weight equivalents, about 0.95 weight equivalents, about 1 weight equivalent, about 1.05 weight equivalents, about 1.1 weight equivalents, about 1.15 weight equivalents, about 1.2 weight equivalents, about 1.25 weight equivalents, about 1.3 weight equivalents, about 1.35 weight equivalents, about 1.4 weight equivalents, about 1.45 weight equivalents, or about 1.5 weight equivalents. In some embodiments, the amount of hardener is no more than about 0.05 weight equivalents, about 0.1 weight equivalents, about 0.15 weight equivalents, about 0.2 weight equivalents, about 0.25 weight equivalents, about 0.3 weight equivalents, about 0.35 weight equivalents, about 0.4 weight equivalents, about 0.45 weight equivalents, about 0.5 weight equivalents, about 0.55 weight equivalents, about 0.6 weight equivalents, about 0.65 weight equivalents, about 0.7 weight equivalents, about 0.75 weight equivalents, about 0.8 weight equivalents, about 0.85 weight equivalents, about 0.9 weight equivalents, about 0.95 weight equivalents, about 1 weight equivalent, about 1.05 weight equivalents, about 1.1 weight equivalents, about 1.15 weight equivalents, about 1.2 weight equivalents, about 1.25 weight equivalents, about 1.3 weight equivalents, about 1.35 weight equivalents, about 1.4 weight equivalents, about 1.45 weight equivalents, or about 1.5 weight equivalents.

Depending upon the nature of the hardener, curing of the microporous support layer of the asymmetric thin-film composite membrane is performed at room temperature or at elevated temperatures. Curing provides a crosslinked polymer network which is infusible and intractable. In some embodiments, the curing is performed at about room temperature to about 300° C. In some embodiments, the curing is performed at about 50° C. to about 250° C. In some embodiments, the curing is performed at about 100° C. to about 200° C. In some embodiments, the curing is performed at about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., or about 250° C. In some embodiments, the curing is performed at a temperature of at least about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., or about 250° C. In some embodiments, the curing is performed at a temperature of no more than about 50° C., about 60° C., about 70° C., about 80° C., about 90° C., about 100° C., about 110° C., about 120° C., about 130° C., about 140° C., about 150° C., about 160° C., about 170° C., about 180° C., about 190° C., about 200° C., about 210° C., about 220° C., about 230° C., about 240° C., or about 250° C.

In some embodiments, the epoxy resin comprises a porogen. Examples of porogens include, but not limited to, ethylene glycol and ethylene glycol based materials such as diethylene glycol, triethylene glycol, and higher homologs. The higher homologs of ethylene glycol are often referred to as polyethylene glycol (i.e., PEG) or polyethylene oxide (i.e., PEO). In some embodiments, the porogen is selected from the group consisting of propylene glycol and propylene glycol based materials such as dipropylene glycol, tripropylene glycol, and higher homologs. The higher homologs of propylene glycol are often referred to as polypropylene glycol (i.e., PPG) or polypropylene oxide (i.e., PPO). In some embodiments, the porogen is random or block copolymers of polyethylene oxide and polypropylene oxide.

Some porogens are polyalkylene oxides having a molecular weight of at least 200 g/mole, at least 400 g/mole, at least 800 g/mole, at least 1,000 g/mole, at least 2,000 g/mole, 4,000 g/mole, at least 8,000 g/mole, or at least 10,000 g/mole. In some embodiments, the polyalkylene oxide porogens have an average molecular weight up to 20,000 g/mole, up to 16,000 g/mole, up to 12,000 g/mole, up to 10,000 g/mole, up to 8,000 g/mole, up to 6,000 g/mole up to 4,000 g/mole, up to 2,000 g/mole, up to 1,000 g/mole, up to 500 g/mole, or up to 200 g/mole. In some embodiments, the polyalkylene oxide porogen typically has an average molecular weight in the range of 200 to 20,000 g/mole, in the range of 200 to 16,000 g/mole, in the range of 200 to 8,000 g/mole, in the range of 200 to 4,000 g/mole, in the range of 200 to 2,000 g/mole, in the range of 200 to 1,000 g/mole, in the range of 200 to 800 g/mole, in the range of 200 to 600 g/mole, or in the range of 200 to 400 g/mole.

In some embodiments, a mixture of porogens is used. In some embodiments, the porogen is a mixture of a first porogen being alkylene glycol and a second porogen that is a polyalkylene oxide. In some embodiments, the porogen is a mixture of ethylene glycol with a polyethylene glycol with hydroxy end groups.

In some embodiments, the porogen comprises a hydrophilic polymer, hydrophobic polymer, or a mixture thereof. In some embodiments, the hydrophilic polymer comprises poly(ethylene glycol) (PEG), poly(ethyleneimine), polyaniline, or a mixture thereof. In some embodiments, the polyaniline is a doped polyaniline, de-doped polyaniline, or a partially re-doped poly-aniline. In some embodiments, the polyaniline is doped using one or more minerals and/or organic acid.

In some embodiments, the porogen comprises a mixture of PEG200 and PEG400. In some embodiments, the porogen comprises a mixture of PEG200 and PEG800. In some embodiments, the porogen comprises a mixture of PEG400 and PEG800.

In some embodiments, a ratio of PEG200 to PEG400 is from about 1:10 to about 10:1. In some embodiments, the ratio of PEG200 to PEG400 is about 1 to about 10. In some embodiments, the ratio of PEG200 to PEG400 is about 1 to about 9. In some embodiments, the ratio of PEG200 to PEG400 is about 1 to about 8. In some embodiments, the ratio of PEG200 to PEG400 is about 1 to about 7. In some embodiments, the ratio of PEG200 to PEG400 is about 1 to about 6. In some embodiments, the ratio of PEG200 to PEG400 is about 1 to about 5. In some embodiments, the ratio of PEG200 to PEG400 is about 1 to about 4. In some embodiments, the ratio of PEG200 to PEG400 is about 1 to about 3. In some embodiments, the ratio of PEG200 to PEG400 is about 1 to about 2. In some embodiments, the ratio of PEG200 to PEG400 is about 1 to about 1. In some embodiments, the ratio of PEG200 to PEG400 is about 2 to about 1. In some embodiments, the ratio of PEG200 to PEG400 is about 3 to about 1. In some embodiments, the ratio of PEG200 to PEG400 is about 4 to about 1. In some embodiments, the ratio of PEG200 to PEG400 is about 5 to about 1. In some embodiments, the ratio of PEG200 to PEG400 is about 6 to about 1. In some embodiments, the ratio of PEG200 to PEG400 is about 7 to about 1. In some embodiments, the ratio of PEG200 to PEG400 is about 8 to about 1. In some embodiments, the ratio of PEG200 to PEG400 is about 9 to about 1. In some embodiments, the ratio of PEG200 to PEG400 is about 10 to about 1. In some embodiments, the ratio of PEG200 to PEG400 is at least about 1:10, about 1:9, about 1:8, about 1:7, about 1:6, about 1:5, about 1:4, about 1:3, about 1:2, about 1:2, about 2:1, about 3:1, about 4:1, about 5:1, about 6:1, about 7:1, about 8:1, about 9:1, or about 10:1. In some embodiments, the ratio of PEG200 to PEG400 is no more than about 1:10, about 1:9, about 1:8, about 1:7, about 1:6, about 1:5, about 1:4, about 1:3, about 1:2, about 1:2, about 2:1, about 3:1, about 4:1, about 5:1, about 6:1, about 7:1, about 8:1, about 9:1, or about 10:1.

In some embodiments, the amount of porogen is from about 0.1 to about 10 weight equivalents per one weight equivalent of the epoxy resin. In some embodiments, the amount of porogen is from about 0.2 to about 5 weight equivalents. In some embodiments, about 0.5 to about 4 weight equivalent.

In some embodiments, the amount of porogen is about 0.1 weight equivalents, about 0.2 weight equivalents, about 0.3 weight equivalents, about 0.4 weight equivalents, about 0.5 weight equivalents, about 0.6 weight equivalents, about 0.7 weight equivalents, about 0.8 weight equivalents, about 0.9 weight equivalents, about 1 weight equivalent, about 1.1 weight equivalents, about 1.2 weight equivalents, about 1.3 weight equivalents, about 1.4 weight equivalents, about 1.5 weight equivalents, about 1.6 weight equivalents, about 1.7 weight equivalents, about 1.8 weight equivalents, about 1.9 weight equivalents, about 2 weight equivalents, about 2.1 weight equivalents, about 2.2 weight equivalents, about 2.3 weight equivalents, about 2.4 weight equivalents, about 2.5 weight equivalents, about 2.6 weight equivalents, about 2.7 weight equivalents, about 2.8 weight equivalents, about 2.9 weight equivalents, about 3 weight equivalents, about 3.1 weight equivalents, about 3.2 weight equivalents, about 3.3 weight equivalents, about 3.4 weight equivalents, about 3.5 weight equivalents, about 3.6 weight equivalents, about 3.7 weight equivalents, about 3.8 weight equivalents, about 3.9 weight equivalents, about 4 weight equivalents, about 4.1 weight equivalents, about 4.2 weight equivalents, about 4.3 weight equivalents, about 4.4 weight equivalents, about 4.5 weight equivalents, about 4.6 weight equivalents, about 4.7 weight equivalents, about 4.8 weight equivalents, about 4.9 weight equivalents, about 5 weight equivalents, about 5.1 weight equivalents, about 5.2 weight equivalents, about 5.3 weight equivalents, about 5.4 weight equivalents, about 5.5 weight equivalents, about 5.6 weight equivalents, about 5.7 weight equivalents, about 5.8 weight equivalents, about 5.9 weight equivalents, about 6 weight equivalents, about 6.1 weight equivalents, about 6.2 weight equivalents, about 6.3 weight equivalents, about 6.4 weight equivalents, about 6.5 weight equivalents, about 6.6 weight equivalents, about 6.7 weight equivalents, about 6.8 weight equivalents, about 6.9 weight equivalents, about 7 weight equivalents, about 7.1 weight equivalents, about 7.2 weight equivalents, about 7.3 weight equivalents, about 7.4 weight equivalents, about 7.5 weight equivalents, about 7.6 weight equivalents, about 7.7 weight equivalents, about 7.8 weight equivalents, about 7.9 weight equivalents, about 8 weight equivalents, about 8.1 weight equivalents, about 8.2 weight equivalents, about 8.3 weight equivalents, about 8.4 weight equivalents, about 8.5 weight equivalents, about 8.6 weight equivalents, about 8.7 weight equivalents, about 8.8 weight equivalents, about 8.9 weight equivalents, about 9 weight equivalents, about 9.1 weight equivalents, about 9.2 weight equivalents, about 9.3 weight equivalents, about 9.4 weight equivalents, about 9.5 weight equivalents, about 9.6 weight equivalents, about 9.7 weight equivalents, about 9.8 weight equivalents, about 9.9 weight equivalents, or about 10 weight equivalents of the epoxy resin.

In some embodiments, the epoxy resin additionally comprises an accelerator to increase the rate of cure. In some embodiments, the accelerator is selected from Lewis acid/amine complexes such as BF₃/monoethylamine, BF₃/piperidine, BF₃/methylimidazole; amines, such as imidiazole and its derivatives such as 4-ethyl-2-methylimidazole, 1-methylimidazole, 2-methylimidazole; N,N-dimethylbenzylamine; acid salts of tertiary amines, such as the p-toluenesulfonic acid/imidazole complex, salts of tri-fluoromethane sulfonic acid, such as FC-520 (obtained from 3M Company), organophosphonium halides, dicyandiamide, 1,1-dimethyl-3-phenyl urea (Fikure (62U from Fike Chemical Co.) and chlorinated derivatives of 1,1-dimethyl-3-phenyl urea (monuron and diuron from du Pont).

In some embodiments, the amount of cure accelerator is from about 0.01 wt. % to about 20 wt. % of the epoxy resin system (i.e., epoxy plus hardener plus porogen). In some embodiments, the amount of cure accelerator is about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, or about 20 wt. % of the epoxy resin system (i.e., epoxy plus hardener plus porogen). In some embodiments, the amount of cure accelerator is at least about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, or about 20 wt. % of the epoxy resin system. In some embodiments, the amount of cure accelerator is no more than about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, or about 20 wt. % of the epoxy resin system.

In some embodiments, two or more epoxy resins are mixed prior to curing of the microporous support layer of the asymmetric thin-film composite membrane. In some embodiments, one epoxy resin is present in an amount from about 5 wt. % to about 95 wt. %. In some embodiments, one epoxy resin is present in an amount from about 10 wt. % to about 90 wt. %. In some embodiments, one epoxy resin is present in an amount from about 20 wt. % to about 80 wt. %. In some embodiments, one epoxy resin is present in an amount from about 30 wt. % to about 70 wt. %. In some embodiments, one epoxy resin is present in an amount from about 40 wt. % to about 60 wt. %. In some embodiments, one epoxy resin is present in an amount of about 50 wt. %. In some embodiments, one epoxy resin is present in an amount of at least about 5 wt. %, about 10 wt. %, about 20 wt. %, about 30 wt. %, about 40 wt. %, about 50 wt. %, about 60 wt. %, about 70 wt. %, about 80 wt. %, about 90 wt. %, or about 95 wt. %. In some embodiments, one epoxy resin is present in an amount of no more than about 5 wt. %, about 10 wt. %, about 20 wt. %, about 30 wt. %, about 40 wt. %, about 50 wt. %, about 60 wt. %, about 70 wt. %, about 80 wt. %, about 90 wt. %, or about 95 wt. %.

In some embodiments, the microporous support layer of the asymmetric thin-film composite membrane has a thickness of about 1 μm to about 2,000 μm. In some embodiments, the microporous support layer of the asymmetric thin-film composite membrane has a thickness of at least about 1 μm. In some embodiments, the microporous support layer of the asymmetric thin-film composite membrane has a thickness of at most about 2,000 μm. In some embodiments, the microporous support layer of the asymmetric thin-film composite membrane has a thickness of about 1 μm to about 10 μm, about 1 μm to about 50 μm, about 1 μm to about 100 μm, about 1 μm to about 200 μm, about 1 μm to about 500 μm, about 1 μm to about 750 μm, about 1 μm to about 1,000 μm, about 1 μm to about 1,500 μm, about 1 μm to about 2,000 μm, about 10 μm to about 50 μm, about 10 μm to about 100 μm, about 10 μm to about 200 μm, about 10 μm to about 500 μm, about 10 μm to about 750 μm, about 10 μm to about 1,000 μm, about 10 μm to about 1,500 μm, about 10 μm to about 2,000 μm, about 50 μm to about 100 μm, about 50 μm to about 200 μm, about 50 m to about 500 μm, about 50 μm to about 750 μm, about 50 μm to about 1,000 μm, about 50 m to about 1,500 μm, about 50 μm to about 2,000 μm, about 100 μm to about 200 μm, about 100 μm to about 500 μm, about 100 μm to about 750 μm, about 100 μm to about 1,000 μm, about 100 μm to about 1,500 μm, about 100 μm to about 2,000 μm, about 200 μm to about 500 μm, about 200 μm to about 750 μm, about 200 μm to about 1,000 μm, about 200 m to about 1,500 μm, about 200 μm to about 2,000 μm, about 500 μm to about 750 μm, about 500 μm to about 1,000 μm, about 500 μm to about 1,500 μm, about 500 μm to about 2,000 μm, about 750 μm to about 1,000 μm, about 750 μm to about 1,500 μm, about 750 m to about 2,000 μm, about 1,000 μm to about 1,500 μm, about 1,000 μm to about 2,000 μm, or about 1,500 μm to about 2,000 μm.

In some embodiments, the microporous support layer of the asymmetric thin-film composite membrane has a thickness of at least about 1 μm, about 2 μm, about 5 μm, about 10 μm, about 15 μm, about 20 μm, about 25 μm, about 30 μm, about 35 μm, about 40 μm, about 45 μm, about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, about 500 μm, about 600 μm, about 700 μm, about 800 μm, about 900 μm, about 1000 μm, about 1200 μm, about 1400 μm, about 1500 μm, about 1600 μm, about 1700 μm, about 1800 μm, about 1900 μm, or about 2000 μm. In some embodiments, the microporous support layer of the asymmetric thin-film composite membrane has a thickness of no more than about 1 μm, about 2 μm, about 5 μm, about 10 μm, about 15 μm, about 20 μm, about 25 μm, about 30 μm, about 35 μm, about 40 μm, about 45 μm, about 50 μm, about 60 μm, about 70 μm, about 80 μm, about 90 μm, about 100 μm, about 150 μm, about 200 μm, about 250 μm, about 300 μm, about 350 μm, about 400 μm, about 450 μm, about 500 μm, about 600 μm, about 700 μm, about 800 μm, about 900 μm, about 1000 μm, about 1200 μm, about 1400 μm, about 1500 μm, about 1600 μm, about 1700 μm, about 1800 μm, about 1900 μm, or about 2000 μm.

In some embodiments, the microporous support layer of the asymmetric thin-film composite membrane has a thickness of about 1 μm, about 2 μm, about 5 μm, about 10 μm, about 15 μm, about 20 μm, about 25 μm, about 30 μm, about 35 μm, about 40 μm, about 45 μm, about 50 μm, about 55 μm, about 60 μm, about 65 μm, about 70 μm, about 75 μm, about 80 μm, about 85 μm, about 90 μm, about 95 μm, about 100 μm, about 110 μm, about 120 μm, about 130 μm, about 140 μm, about 150 μm, about 160 μm, about 170 μm, about 180 μm, about 190 μm, about 200 μm, about 210 μm, about 220 μm, about 230 μm, about 240 μm, about 250 μm, about 260 μm, about 270 μm, about 280 μm, about 290 μm, about 300 μm, about 310 μm, about 320 μm, about 330 μm, about 340 μm, about 350 μm, about 360 μm, about 370 μm, about 380 μm, about 390 μm, about 400 μm, about 410 μm, about 420 μm, about 430 μm, about 440 μm, about 450 μm, about 460 μm, about 470 μm, about 480 μm, about 490 μm, about 500 μm, about 510 μm, about 520 μm, about 530 μm, about 540 μm, about 550 μm, about 560 μm, about 570 μm, about 580 μm, about 590 μm, about 600 μm, about 610 μm, about 620 μm, about 630 μm, about 640 μm, about 650 μm, about 660 μm, about 670 μm, about 680 μm, about 690 μm, about 700 μm, about 710 μm, about 720 μm, about 730 μm, about 740 μm, about 750 μm, about 760 μm, about 770 μm, about 780 μm, about 790 μm, about 800 μm, about 810 μm, about 820 μm, about 830 μm, about 840 μm, about 850 μm, about 860 μm, about 870 μm, about 880 μm, about 890 μm, about 900 μm, about 910 μm, about 920 μm, about 930 μm, about 940 μm, about 950 μm, about 960 μm, about 970 μm, about 980 μm, about 990 μm, about 1000 μm, about 1020 μm, about 1040 μm, about 1060 μm, about 1080 μm, about 1100 μm, about 1120 μm, about 1140 μm, about 1160 μm, about 1180 μm, about 1200 μm, about 1220 μm, about 1240 μm, about 1260 μm, about 1280 μm, about 1300 μm, about 1320 μm, about 1340 μm, about 1360 μm, about 1380 μm, about 1400 μm, about 1420 μm, about 1440 μm, about 1460 μm, about 1480 μm, about 1500 μm, about 1520 μm, about 1540 μm, about 1560 μm, about 1580 μm, about 1600 μm, about 1620 μm, about 1640 μm, about 1660 μm, about 1680 μm, about 1700 μm, about 1720 μm, about 1740 μm, about 1760 μm, about 1780 μm, about 1800 μm, about 1820 μm, about 1840 μm, about 1860 μm, about 1880 μm, about 1900 μm, about 1920 μm, about 1940 μm, about 1960 μm, about 1980 μm, or about 2000 μm.

In some embodiments, the active layer of the asymmetric thin-film composite membrane and the microporous support layer of the asymmetric thin-film composite membrane are bonded to each other via C—O covalent bonds. In some embodiments, the active layer of the asymmetric thin-film composite membrane and the microporous support layer of the asymmetric thin-film composite membrane are bonded to each other via C—N covalent bonds. In some embodiments, the active layer of the asymmetric thin-film composite membrane and the microporous support layer of the asymmetric thin-film composite membrane are bonded to each other via C—O or C—N covalent bonds. In some embodiments, the active layer of the asymmetric thin-film composite membrane and the microporous support layer of the asymmetric thin-film composite membrane are bonded to each other via C—O and C—N covalent bonds.

In some embodiments, the asymmetric thin-film composite membrane disclosed herein is a reverse osmosis membrane.

In some embodiments, the asymmetric thin-film composite membrane disclosed herein is stable when contacted by a chemical, an organic solvent, or a combination thereof.

In some embodiments, the chemical is an oxidant or an acid. In some embodiments, the oxidant is sodium hypochlorite.

### Polymeric Thin-Film Membranes

In some embodiments, an asymmetric thin-film composite membrane disclosed herein is coated onto a polymeric thin-film membrane. In some instances, a polymeric thin-film membrane can then be adhered to a surface, the polymeric thin film can be bonded to a surface, and/or the polymeric thin-film can be laminated to a surface of a material.

In some embodiments, a polymeric thin-film comprises a polymer matrix, e.g., a three-dimensional polymer network, substantially permeable to water and substantially impermeable to impurities. For example, the polymer network can be a cross-linked polymer formed from reaction of at least one polyfunctional monomer with a difunctional or polyfunctional monomer.

The polymeric thin-film can be a three-dimensional polymer network such as an aliphatic or aromatic polyamide, aromatic polyhydrazide, poly-bensimidazolone, polyepiaminelamide, polyepiamine/urea, poly-ethyleneimine/urea, sulfonated polyfurane, polybenzimidazole, polypiperazine isophtalamide, a polyether, a polyether-urea, a polyester, or a polyimide or a copolymer thereof or a mixture thereof. Preferably, the polymeric thin film can be formed by an interfacial polymerization reaction or can be cross-linked subsequent to polymerization.

The polymeric thin-film can be an aromatic or non-aromatic polyamide such as residues of a phthaloyl (i.e., isophthaloyl or terephthaloyl) halide, a trimesyl halide, or a mixture thereof. In another example, the polyamide can be residues of diaminobenzene, triaminobenzene, polyetherimine, piperazine or poly-piperazine or residues of a trimesoyl halide and residues of a diaminobenzene. The film can also be residues of trimesoyl chloride and m-phenylenediamine. Further, the film can be the reaction product of trimesoyl chloride and m-phenylenediamine.

### Properties of Asymmetric Thin-Film Composite Membranes

In some embodiments, asymmetric thin-film composite membranes disclosed herein have various properties that provide the superior function of the membranes, including excellent flux, improved hydrophilicity, improved resistance to fouling, tunable surface charge properties, improved salt rejection, higher thermal stability, higher chemical stability, higher solvent stability, or a combination thereof. It is also understood that the membranes have other properties.

In some embodiments, an asymmetric thin-film composite membrane has a contact angle of less than about 70°. In some embodiments, an asymmetric thin-film composite membrane has a contact angle of less than about 65°. In some embodiments, an asymmetric thin-film composite membrane has a contact angle of less than about 60°. In some embodiments, an asymmetric thin-film composite membrane has a contact angle of less than about 55°. In some embodiments, an asymmetric thin-film composite membrane has a contact angle of less than about 50°. In some embodiments, an asymmetric thin-film composite membrane has a contact angle of less than about 45°. In some embodiments, an asymmetric thin-film composite membrane has a contact angle of less than about 40°. Such membrane will have a high resistance of fouling.

In some embodiments, an asymmetric thin-film composite membrane disclosed herein exhibits a salt rejection of at least about 60%. In some embodiments, an asymmetric thin-film composite membrane disclosed herein exhibits a salt rejection of at least about 70%. In some embodiments, an asymmetric thin-film composite membrane disclosed herein exhibits a salt rejection of at least about 80%. In some embodiments, an asymmetric thin-film composite membrane disclosed herein exhibits a salt rejection of at least about 90%. In some embodiments, an asymmetric thin-film composite membrane disclosed herein exhibits a salt rejection of at least about 91%. In some embodiments, an asymmetric thin-film composite membrane disclosed herein exhibits a salt rejection of at least about 92%. In some embodiments, an asymmetric thin-film composite membrane disclosed herein exhibits a salt rejection of at least about 93%. In some embodiments, an asymmetric thin-film composite membrane disclosed herein exhibits a salt rejection of at least about 94%. In some embodiments, an asymmetric thin-film composite membrane disclosed herein exhibits a salt rejection of at least about 95%. In some embodiments, an asymmetric thin-film composite membrane disclosed herein exhibits a salt rejection of at least about 96%. In some embodiments, an asymmetric thin-film composite membrane disclosed herein exhibits a salt rejection of at least about 97%. In some embodiments, an asymmetric thin-film composite membrane disclosed herein exhibits a salt rejection of at least about 98%. In some embodiments, an asymmetric thin-film composite membrane disclosed herein exhibits a salt rejection of at least about 99%.

In some embodiments, an asymmetric thin-film composite membrane disclosed herein exhibits a salt rejection of at least about 90% for at least about 1 hour. In some embodiments, an asymmetric thin-film composite membrane disclosed herein exhibits a salt rejection of at least about 90% for at least about 2 hours. In some embodiments, an asymmetric thin-film composite membrane disclosed herein exhibits a salt rejection of at least about 90% for at least about 3 hours. In some embodiments, an asymmetric thin-film composite membrane disclosed herein exhibits a salt rejection of at least about 90% for at least about 4 hours. In some embodiments, an asymmetric thin-film composite membrane disclosed herein exhibits a salt rejection of at least about 90% for at least about 8 hours. In some embodiments, an asymmetric thin-film composite membrane disclosed herein exhibits a salt rejection of at least about 90% for at least about 12 hours. In some embodiments, an asymmetric thin-film composite membrane disclosed herein exhibits a salt rejection of at least about 90% for at least about 24 hours. In some embodiments, an asymmetric thin-film composite membrane disclosed herein exhibits a salt rejection of at least about 92% for at least about 1 hour. In some embodiments, an asymmetric thin-film composite membrane disclosed herein exhibits a salt rejection of at least about 92% for at least about 2 hours. In some embodiments, an asymmetric thin-film composite membrane disclosed herein exhibits a salt rejection of at least about 92% for at least about 3 hours. In some embodiments, an asymmetric thin-film composite membrane disclosed herein exhibits a salt rejection of at least about 92% for at least about 4 hours. In some embodiments, an asymmetric thin-film composite membrane disclosed herein exhibits a salt rejection of at least about 92% for at least about 8 hours. In some embodiments, an asymmetric thin-film composite membrane disclosed herein exhibits a salt rejection of at least about 92% for at least about 12 hours. In some embodiments, an asymmetric thin-film composite membrane disclosed herein exhibits a salt rejection of at least about 92% for at least about 24 hours. In some embodiments, an asymmetric thin-film composite membrane disclosed herein exhibits a salt rejection of at least about 94% for at least about 1 hour. In some embodiments, an asymmetric thin-film composite membrane disclosed herein exhibits a salt rejection of at least about 94% for at least about 2 hours. In some embodiments, an asymmetric thin-film composite membrane disclosed herein exhibits a salt rejection of at least about 94% for at least about 3 hours. In some embodiments, an asymmetric thin-film composite membrane disclosed herein exhibits a salt rejection of at least about 94% for at least about 4 hours. In some embodiments, an asymmetric thin-film composite membrane disclosed herein exhibits a salt rejection of at least about 94% for at least about 8 hours. In some embodiments, an asymmetric thin-film composite membrane disclosed herein exhibits a salt rejection of at least about 94% for at least about 12 hours. In some embodiments, an asymmetric thin-film composite membrane disclosed herein exhibits a salt rejection of at least about 94% for at least about 24 hours. In some embodiments, an asymmetric thin-film composite membrane disclosed herein exhibits a salt rejection of at least about 96% for at least about 1 hour. In some embodiments, an asymmetric thin-film composite membrane disclosed herein exhibits a salt rejection of at least about 96% for at least about 2 hours. In some embodiments, an asymmetric thin-film composite membrane disclosed herein exhibits a salt rejection of at least about 96% for at least about 3 hours. In some embodiments, an asymmetric thin-film composite membrane disclosed herein exhibits a salt rejection of at least about 96% for at least about 4 hours. In some embodiments, an asymmetric thin-film composite membrane disclosed herein exhibits a salt rejection of at least about 96% for at least about 8 hours. In some embodiments, an asymmetric thin-film composite membrane disclosed herein exhibits a salt rejection of at least about 96% for at least about 12 hours. In some embodiments, an asymmetric thin-film composite membrane disclosed herein exhibits a salt rejection of at least about 96% for at least about 24 hours. In some embodiments, an asymmetric thin-film composite membrane disclosed herein exhibits a salt rejection of at least about 98% for at least about 1 hour. In some embodiments, an asymmetric thin-film composite membrane disclosed herein exhibits a salt rejection of at least about 98% for at least about 2 hours. In some embodiments, an asymmetric thin-film composite membrane disclosed herein exhibits a salt rejection of at least about 98% for at least about 3 hours. In some embodiments, an asymmetric thin-film composite membrane disclosed herein exhibits a salt rejection of at least about 98% for at least about 4 hours. In some embodiments, an asymmetric thin-film composite membrane disclosed herein exhibits a salt rejection of at least about 98% for at least about 8 hours. In some embodiments, an asymmetric thin-film composite membrane disclosed herein exhibits a salt rejection of at least about 98% for at least about 12 hours. In some embodiments, an asymmetric thin-film composite membrane disclosed herein exhibits a salt rejection of at least about 98% for at least about 24 hours. In some embodiments, an asymmetric thin-film composite membrane disclosed herein exhibits a salt rejection of at least about 99% for at least about 1 hour. In some embodiments, an asymmetric thin-film composite membrane disclosed herein exhibits a salt rejection of at least about 99% for at least about 2 hours. In some embodiments, an asymmetric thin-film composite membrane disclosed herein exhibits a salt rejection of at least about 99% for at least about 3 hours. In some embodiments, an asymmetric thin-film composite membrane disclosed herein exhibits a salt rejection of at least about 99% for at least about 4 hours. In some embodiments, an asymmetric thin-film composite membrane disclosed herein exhibits a salt rejection of at least about 99% for at least about 8 hours. In some embodiments, an asymmetric thin-film composite membrane disclosed herein exhibits a salt rejection of at least about 99% for at least about 12 hours. In some embodiments, an asymmetric thin-film composite membrane disclosed herein exhibits a salt rejection of at least about 99% for at least about 24 hours. In some embodiments, an asymmetric thin-film composite membrane disclosed herein exhibits a salt rejection of at least about 60%, at least about 70%, at least about 80%, at least about 90%, at least about 91%, at least about 92%, at least about 93%, at least about 94%, at least about 95%, at least about 96%, at least about 97%, at least about 98%, or at least about 99% for at least about 1 hour, at least about 2 hours, at least about 4 hours, at least about 6 hours, at least about 8 hours, at least about 10 hours, at least about 12 hours, at least about 14 hours, at least about 16 hours, at least about 18 hours, at least about 20 hours, at least about 22 hours, or at least about 24 hours. In a further aspect, an asymmetric thin-film composite membrane disclosed herein exhibits an improvement in at least one property selected from resistance to fouling, hydrophilicity, surface charge, salt rejection, and roughness. In some embodiments, an asymmetric thin-film composite membrane disclosed herein demonstrates an improvement in at least one property selected from resistance to fouling, salt rejection, and hydrophilicity. In some embodiments, an asymmetric thin-film composite membrane disclosed herein demonstrates an improvement in resistance to fouling. In some embodiments, an asymmetric thin-film composite membrane disclosed herein demonstrates an improvement in hydrophilicity. In some embodiments, an asymmetric thin-film composite membrane disclosed herein demonstrates an improvement in surface charge. In some embodiments, an asymmetric thin-film composite membrane disclosed herein demonstrates an improvement in roughness. In some embodiments, an asymmetric thin-film composite membrane disclosed herein demonstrates reduced surface roughness. In some embodiments, an asymmetric thin-film composite membrane disclosed herein demonstrates an improvement in salt rejection.

In some embodiments, an asymmetric thin-film composite membrane disclosed herein prevents and/or reduces biofouling. In some instances, biofouling comprises microfouling or macrofouling. Microfouling comprises formation of microorganism adhesion (e.g., bacteria adhesion) and/or biofilm. Biofilm is a group of microorganism which adheres to a surface. In some instances, the adhered microorganisms are further embedded in a self-produced matrix of extracellular polymeric substance, which comprises a polymeric conglomeration of extracellular DNA, protein, and polysaccharides. Macrofouling comprises attachment of larger organism. In some instances an asymmetric thin-film composite membrane disclosed herein prevents and/or reduces microfouling. In some instances, an asymmetric thin-film composite membrane disclosed herein prevents and/or reduces bacterial adhesion. In some instances, an asymmetric thin-film composite membrane disclosed herein prevents and/or reduces biofilm. In other instances, an asymmetric thin-film composite membrane disclosed herein prevents and/or reduces macrofouling.

In some instances, microfouling is formed by bacteria or fungi. In some instances, microfouling is formed by bacteria. In some instances, a bacterium is a gram-positive bacterium or a gram-negative bacterium. In some cases, a bacterium is a marine bacterium.

In some cases, microfouling is formed by a gram-positive bacterium. Exemplary gram-positive bacteria include, but are not limited to, bacteria from the genus Actinomyces, Arthrobacter, Bacillus, Clostridium, Corynebacterium, Enterococcus, Lactococcus, Listeria, Micrococcus, Mycobacterium, Staphylococcus, or Streptococcus. In some instances, a gram-positive bacterium comprises Actinomyces spp., Arthrobacter spp., Bacillus licheniformis, Clostridium difficile, Clostridium spp., Corynebacterium spp., Enterococcus faecalis, Lactococcus spp., Listeria monocytogenes, Micrococcus spp., Mycobacterium spp., Staphylococcus aureus, Staphylococcus epidermidis, Streptococcus pneumoniae, or Streptococcus pyogenes.

In some instances, microfouling is formed by a gram-positive bacterium from the genus Actinomyces, Arthrobacter, Bacillus, Clostridium, Corynebacterium, Enterococcus, Lactococcus, Listeria, Micrococcus, Mycobacterium, Staphylococcus, or Streptococcus. In some instances, microfouling is formed by a gram-positive bacterium: Actinomyces spp., Arthrobacter spp., Bacillus licheniformis, Clostridium difficile, Clostridium spp., Corynebacterium spp., Enterococcus faecalis, Lactococcus spp., Listeria monocytogenes, Micrococcus spp., Mycobacterium spp., Staphylococcus aureus, Staphylococcus epidermidis, Streptococcus pneumoniae, or Streptococcus pyogenes.

In some instances, an asymmetric thin-film composite membrane disclosed herein is resistant to fouling. In some instances, an asymmetric thin-film composite membrane disclosed herein prevents and/or reduces microfouling on one or more of its surfaces. In some cases, an asymmetric thin-film composite membrane disclosed herein prevents and/or reduces microfouling formed by a gram-positive bacterium from the genus Actinomyces, Arthrobacter, Bacillus, Clostridium, Corynebacterium, Enterococcus, Lactococcus, Listeria, Micrococcus, Mycobacterium, Staphylococcus, or Streptococcus. In some cases, an asymmetric thin-film composite membrane disclosed herein prevents and/or reduces microfouling formed by a gram-positive bacterium: Actinomyces spp., Arthrobacter spp., Bacillus licheniformis, Clostridium difficile, Clostridium spp., Corynebacterium spp., Enterococcus faecalis, Lactococcus spp., Listeria monocytogenes, Micrococcus spp., Mycobacterium spp., Staphylococcus aureus, Staphylococcus epidermidis, Streptococcus pneumoniae, or Streptococcus pyogenes.

In some cases, microfouling comprises bacteria adhesion. In some instances, an asymmetric thin-film composite membrane disclosed herein prevents and/or reduces bacteria adhesion. In some cases, an asymmetric thin-film composite membrane disclosed herein prevents and/or reduces bacteria adhesion formed by a gram-positive bacterium from the genus Actinomyces, Arthrobacter, Bacillus, Clostridium, Corynebacterium, Enterococcus, Lactococcus, Listeria, Micrococcus, Mycobacterium, Staphylococcus, or Streptococcus. In some cases, an asymmetric thin-film composite membrane disclosed herein coated onto a material prevents and/or reduces bacteria adhesion formed by a gram-positive bacterium: Actinomyces spp., Arthrobacter spp., Bacillus licheniformis, Clostridium difficile, Clostridium spp., Corynebacterium spp., Enterococcus faecalis, Lactococcus spp., Listeria monocytogenes, Micrococcus spp., Mycobacterium spp., Staphylococcus aureus, Staphylococcus epidermidis, Streptococcus pneumoniae, or Streptococcus pyogenes.

In some cases, microfouling comprises biofilm. In some instances, an asymmetric thin-film composite membrane disclosed herein coated onto a material prevents and/or reduces biofilm. In some cases, an asymmetric thin-film composite membrane disclosed herein coated onto a material prevents and/or reduces biofilm formed by a gram-positive bacterium from the genus Actinomyces, Arthrobacter, Bacillus, Clostridium, Corynebacterium, Enterococcus, Lactococcus, Listeria, Micrococcus, Mycobacterium, Staphylococcus, or Streptococcus. In some cases, an asymmetric thin-film composite membrane disclosed herein coated onto a material prevents and/or reduces biofilm formed by a gram-positive bacterium: Actinomyces spp., Arthrobacter spp., Bacillus licheniformis, Clostridium difficile, Clostridium spp., Corynebacterium spp., Enterococcus faecalis, Lactococcus spp., Listeria monocytogenes, Micrococcus spp., Mycobacterium spp., Staphylococcus aureus, Staphylococcus epidermidis, Streptococcus pneumoniae, or Streptococcus pyogenes.

In some cases, microfouling is formed by a gram-negative bacterium. Exemplary gram-negative bacteria include, but are not limited to, bacteria from the genus Alteromonas, Aeromonas, Desulfovibrio, Escherichia, Fusobacterium, Geobacter, Haemophilus, Klebsiella, Legionella, Porphyromonas, Proteus, Pseudomonas, Serratia, Shigella, Salmonella, or Vibrio. In some instances, a gram-negative bacterium comprises Alteromonas spp., Aeromonas spp., Desulfovibrio spp., Escherichia coli, Fusobacterium nucleatum, Geobacter spp., Haemophilus spp., Klebsiella spp., Legionella pneumophila, Porphyromonas spp., Pseudomonas aeruginosa, Proteus vulgaris, Proteus mirabilis, Proteus penneri, Serratia spp., Shigella dysenteriae, Shigella flexneri, Shigella boydii, Shigella sonnei, Salmonella bongori, Salmonella enterica, or Vibrio cholerae.

In some instances, microfouling is formed by a gram-negative bacterium from the genus Alteromonas, Aeromonas, Desulfovibrio, Escherichia, Fusobacterium, Geobacter, Haemophilus, Klebsiella, Legionella, Porphyromonas, Proteus, Pseudomonas, Serratia, Shigella, Salmonella, or Vibrio. In some instances, microfouling is formed by a gram-negative bacterium: Alteromonas spp., Aeromonas spp., Desulfovibrio spp., Escherichia coli, Fusobacterium nucleatum, Geobacter spp., Haemophilus spp., Klebsiella spp., Legionella pneumophila, Porphyromonas spp., Pseudomonas aeruginosa, Proteus vulgaris, Proteus mirabilis, Proteus penneri, Serratia spp., Shigella dysenteriae, Shigella flexneri, Shigella boydii, Shigella sonnei, Salmonella bongori, Salmonella enterica, or Vibrio cholerae.

In some embodiments, an asymmetric thin-film composite membrane disclosed herein prevents and/or reduces microfouling formed by a gram-negative bacterium from the genus Alteromonas, Aeromonas, Desulfovibrio, Escherichia, Fusobacterium, Geobacter, Haemophilus, Klebsiella, Legionella, Porphyromonas, Proteus, Pseudomonas, Serratia, Shigella, Salmonella, or Vibrio. In some instances, an asymmetric thin-film composite membrane disclosed herein prevents and/or reduces microfouling formed by a gram-negative bacterium: Alteromonas spp., Aeromonas spp., Desulfovibrio spp., Escherichia coli, Fusobacterium nucleatum, Geobacter spp., Haemophilus spp., Klebsiella spp., Legionella pneumophila, Porphyromonas spp., Pseudomonas aeruginosa, Proteus vulgaris, Proteus mirabilis, Proteus penneri, Serratia spp., Shigella dysenteriae, Shigella flexneri, Shigella boydii, Shigella sonnei, Salmonella bongori, Salmonella enterica, or Vibrio cholerae.

In some embodiments, microfouling comprises bacteria adhesion. In some embodiments, an asymmetric thin-film composite membrane disclosed herein prevents and/or reduces bacteria adhesion formed by a gram-negative bacterium from the genus Alteromonas, Aeromonas, Desulfovibrio, Escherichia, Fusobacterium, Geobacter, Haemophilus, Klebsiella, Legionella, Porphyromonas, Proteus, Pseudomonas, Serratia, Shigella, Salmonella, or Vibrio. In some instances, an asymmetric thin-film composite membrane disclosed herein prevents and/or reduces bacteria adhesion formed by a gram-negative bacterium: Alteromonas spp., Aeromonas spp., Desulfovibrio spp., Escherichia coli, Fusobacterium nucleatum, Geobacter spp., Haemophilus spp., Klebsiella spp., Legionella pneumophila, Porphyromonas spp., Pseudomonas aeruginosa, Proteus vulgaris, Proteus mirabilis, Proteus penneri, Serratia spp., Shigella dysenteriae, Shigella flexneri, Shigella boydii, Shigella sonnei, Salmonella bongori, Salmonella enterica, or Vibrio cholerae.

In some instances, microfouling comprises biofilm. In some embodiments, an asymmetric thin-film composite membrane disclosed herein prevents and/or reduces biofilm formed by a gram-negative bacterium from the genus Alteromonas, Aeromonas, Desulfovibrio, Escherichia, Fusobacterium, Geobacter, Haemophilus, Klebsiella, Legionella, Porphyromonas, Proteus, Pseudomonas, Serratia, Shigella, Salmonella, or Vibrio. In some instances, an asymmetric thin-film composite membrane disclosed herein prevents and/or reduces biofilm formed by a gram-negative bacterium: Alteromonas spp., Aeromonas spp., Desulfovibrio spp., Escherichia coli, Fusobacterium nucleatum, Geobacter spp., Haemophilus spp., Klebsiella spp., Legionella pneumophila, Porphyromonas spp., Pseudomonas aeruginosa, Proteus vulgaris, Proteus mirabilis, Proteus penneri, Serratia spp., Shigella dysenteriae, Shigella flexneri, Shigella boydii, Shigella sonnei, Salmonella bongori, Salmonella enterica, or Vibrio cholerae.

In some cases, microfouling is formed by a marine bacterium. In some instances, a marine bacterium comprises Pseudoalteromonas spp. or Shewanella spp. In some cases, microfouling is formed by Pseudoalteromonas spp. or Shewanella spp.

In some embodiments, an asymmetric thin-film composite membrane disclosed herein prevents and/or reduces microfouling formed by a marine bacterium. In some cases, an asymmetric thin-film composite membrane disclosed herein prevents and/or reduces microfouling formed by Pseudoalteromonas spp. or Shewanella spp.

In some instances, microfouling comprises bacteria adhesion. In some embodiments, an asymmetric thin-film composite membrane disclosed herein prevents and/or reduces bacteria adhesion formed by a marine bacterium. In some cases, an asymmetric thin-film composite membrane disclosed herein prevents and/or reduces bacteria adhesion formed by Pseudoalteromonas spp. or Shewanella spp.

In some instances, microfouling comprises biofilm. In some embodiments, an asymmetric thin-film composite membrane disclosed herein prevents and/or reduces biofilm formed by a marine bacterium. In some cases, an asymmetric thin-film composite membrane disclosed herein prevents and/or reduces biofilm formed by Pseudoalteromonas spp. or Shewanella spp.

In some embodiments, microfouling is formed by a fungus. Exemplary fungus includes, but is not limited to, Candida albicans, Candida glabrata, Candida rugose, Candida parapsilosis, Candida tropicalis, Candida dubliniensis, or Hormoconis resinae. In some cases, microfouling is formed by Candida albicans, Candida glabrata, Candida rugose, Candida parapsilosis, Candida tropicalis, Candida dubliniensis, or Hormoconis resinae.

In some embodiments, an asymmetric thin-film composite membrane disclosed herein prevents and/or reduces microfouling formed by a fungus. In some cases, an asymmetric thin-film composite membrane disclosed herein prevents and/or reduces microfouling formed by Candida albicans, Candida glabrata, Candida rugose, Candida parapsilosis, Candida tropicalis, Candida dubliniensis, or Hormoconis resinae.

In some instances, microfouling comprises bacteria adhesion. In some embodiments, an asymmetric thin-film composite membrane disclosed herein prevents and/or reduces bacteria adhesion formed by a fungus. In some cases, an asymmetric thin-film composite membrane disclosed herein prevents and/or reduces bacteria adhesion formed by Candida albicans, Candida glabrata, Candida rugose, Candida parapsilosis, Candida tropicalis, Candida dubliniensis, or Hormoconis resinae.

In some instances, microfouling comprises biofilm. In some embodiments, an asymmetric thin-film composite membrane disclosed herein prevents and/or reduces biofilm formed by a fungus. In some cases, an asymmetric thin-film composite membrane disclosed herein prevents and/or reduces biofilm formed by Candida albicans, Candida glabrata, Candida rugose, Candida parapsilosis, Candida tropicalis, Candida dubliniensis, or Hormoconis resinae.

In some embodiments, macrofouling comprises calcareous fouling organism or non-calcareous fouling organism. A calcareous fouling organism is an organism with a hard body. In some cases, calcareous fouling organisms comprise barnacle, bryozoan, mollusk, polychaete, tube worm, or zebra mussel. A non-calcareous fouling organism comprises a soft body. Non-calcareous fouling organism comprises seaweed, hydroids, or algae.

In some instances, macrofouling is formed by a calcareous fouling organism. In some cases, macrofouling is formed by barnacle, bryozoan, mollusk, polychaete, tube worm, or zebra mussel.

In some embodiments, an asymmetric thin-film composite membrane disclosed herein prevents and/or reduces macrofouling formed by a calcareous fouling organism. In some instances, an asymmetric thin-film composite membrane disclosed herein prevents and/or reduces macrofouling formed by barnacle, bryozoan, mollusk, polychaete, tube worm, or zebra mussel.

In some cases, macrofouling is formed by a non-calcareous fouling organism. In some cases, macrofouling is formed by seaweed, hydroids, or algae.

In some embodiments, an asymmetric thin-film composite membrane disclosed herein prevents and/or reduces macrofouling formed by a non-calcareous fouling organism. In some instances, an asymmetric thin-film composite membrane disclosed herein prevents and/or reduces macrofouling formed by seaweed, hydroids, or algae.

In some embodiments, an asymmetric thin-film composite membrane disclosed herein reduces the formation of biofouling on its surface. In some cases, the formation of biofouling is reduced by about 10%, 20%, 30%, 40%, 50%, 60%, 70%, 80%, 90%, 95%, 99%, or more relative to a commercial RO membrane. In some instances, the formation of biofouling is reduced by about 10%, or more relative to a commercial RO membrane. In some instances, the formation of biofouling is reduced by about 20%, or more relative to a commercial RO membrane. In some instances, the formation of biofouling is reduced by about 30%, or more relative to a commercial RO membrane. In some instances, the formation of biofouling is reduced by about 40%, or more relative to a commercial RO membrane. In some instances, the formation of biofouling is reduced by about 50%, or more relative to a commercial RO membrane. In some instances, the formation of biofouling is reduced by about 60%, or more relative to a commercial RO membrane. In some instances, the formation of biofouling is reduced by about 70%, or more relative to a commercial RO membrane. In some instances, the formation of biofouling is reduced by about 80%, or more relative to a commercial RO membrane. In some instances, the formation of biofouling is reduced by about 90%, or more relative to a commercial RO membrane. In some instances, the formation of biofouling is reduced by about 95%, or more relative to a commercial RO membrane. In some instances, the formation of biofouling is reduced by about 99%, or more relative to a commercial RO membrane.

In some embodiments, an asymmetric thin-film composite membrane disclosed herein is further coated with an additional agent. In some instances, the additional agent is an antimicrobial agent. Exemplary antimicrobial agent comprises quaternary ammonium salts or tertiary amines. In some instances, the additional agent is a chemical disinfectant. Exemplary chemical disinfectant comprises sodium hypochlorite, sodium hydroxide, and benzalkonium chloride.

### Methods of Use

In one aspect, described herein is a method comprising passing a liquid composition through a membrane disclosed herein, wherein the liquid composition comprises a solute and a solvent; and the membrane is substantially impermeable to the solute.

In some embodiments, the liquid composition is salt water. In other embodiments, the liquid composition is brackish water. In yet other embodiments, the liquid composition is an organic solvent.

In some embodiments, the solute is a dye, a small molecule, a polymer, or an oligomer. In other embodiments, the solute is a pathogen or a toxin.

In some embodiments, the liquid composition is passed through the membrane continuously.

In some embodiments, the liquid composition comprises at least one fouling agent, such as a gram negative bacterium, a gram positive bacterium, or a marine bacterium.

In some embodiments, the bacterium is selected from Actinomyces, Arthrobacter, Bacillus, Clostridium, Corynebacterium, Enterococcus, Lactococcus, Listeria, Micrococcus, Mycobacterium, Staphylococcus, Streptococcus, Actinomyces spp., Arthrobacter spp., Bacillus licheniformis, Clostridium difficile, Clostridium spp., Corynebacterium spp., Enterococcus faecalis, Lactococcus spp., Listeria monocytogenes, Micrococcus spp., Mycobacterium spp., Staphylococcus aureus, Staphylococcus epidermidis, Streptococcus pneumoniae, Streptococcus pyogenes, Alteromonas, Aeromonas, Desulfovibrio, Escherichia, Fusobacterium, Geobacter, Haemophilus, Klebsiella, Legionella, Porphyromonas, Proteus, Pseudomonas, Serratia, Shigella, Salmonella, Vibrio, Alteromonas spp., Aeromonas spp., Desulfovibrio spp., Escherichia coli, Fusobacterium nucleatum, Geobacter spp., Haemophilus spp., Klebsiella spp., Legionella pneumophila, Porphyromonas spp., Pseudomonas aeruginosa, Proteus vulgaris, Proteus mirabilis, Proteus penneri, Serratia spp., Shigella dysenteriae, Shigella flexneri, Shigella boydii, Shigella sonnei, Salmonella bongori, Salmonella enterica, Vibrio Cholerae, Pseudoalteromonas spp. and Shewanella spp.

In some embodiments, the fouling agent is a fungus selected from Candida albicans, Candida glabrata, Candida rugose, Candida parapsilosis, Candida tropicalis, Candida dubliniensis, and Hormoconis resinae.

In some embodiments, the organism is a calcareous organism or non-calcareous organism. In some embodiments, the calcareous organism is a barnacle, bryozoan, mollusk, polychaete, tube worm, or zebra mussel. In some embodiments, the non-calcareous organism is seaweed, hydroids, or algae.

In some embodiments, the liquid composition further comprises chlorine. In some such embodiments, the membrane is not degraded by the chlorine.

In some embodiments, the membrane exhibits a salt rejection of at least about 90% for at least about 4 hours. In some embodiments, the membrane exhibits a salt rejection of at least about 94% for at least about 4 hours. In some embodiments, the membrane exhibits a salt rejection of at least about 96% for at least about 4 hours. In some embodiments, the membrane exhibits a salt rejection of at least about 98% for at least about 4 hours. In some embodiments, the membrane exhibits a salt rejection of at least about 99% for at least about 4 hours.

In another aspect described herein, is a method of passing a gas composition through a membrane disclosed herein, wherein the gas composition comprises at least two gasses; and the membrane is substantially impermeable to at least one of the gasses.

In some embodiments, at least one gas is, and optionally two or more or even all of the gasses in the composition are, selected from nitrogen, carbon dioxide, oxygen, methane, carbon monoxide, chlorine, fluorine, nitrogen dioxide, hydrogen, helium, hydrogen sulfide, hydrogen cyanide, formaldehyde, phosgene, phosphine, and bromine.

In another aspect, described herein is a method of purifying a solution, the method comprising:
(a) providing an asymmetric thin-film membrane comprising an active layer and a microporous support layer, wherein said active layer has thickness from about 10 nm to about 1000 nm, and wherein said active layer and said microporous support layer are bonded to each other covalently;
(b) contacting an active layer face of the membrane with a first solution of a first volume having a first contaminant concentration at a first pressure; and
(c) contacting a microporous support layer face of the membrane with a second solution of a second volume optionally having a second contaminant concentration at a second pressure;
wherein the first solution is in fluid communication with the second solution through the membrane,
wherein the first contaminant concentration is higher than the second contaminant concentration, thereby creating an osmotic pressure across the membrane, and
wherein the first pressure is sufficiently higher than the second pressure to overcome the osmotic pressure to increase the second volume and decrease the first volume, and wherein the first contaminant remains on the active layer face, thereby generating a purified solution.

In some embodiments of a method of purifying a solution, the asymmetric membrane is produced by a process, comprising:
(a) providing a substrate having a top surface and a bottom surface;
(b) applying an active layer to the top surface of the substrate;
(c) exposing the active layer to a heat source;
(d) applying epoxy resin microporous support layer on top of the thermally exposed active layer;
(e) exposing the microporous support layer to a heat source to form an asymmetric thin-film composite membrane; wherein said active layer and said microporous support layer are bonding to each other covalently;
(f) exposing the asymmetric thin-film composite membrane to water; and
(g) optionally separating the membrane from the substrate.

In some embodiments, the asymmetric thin-film composite membranes disclosed herein are used to purify a solution from a contaminant. In some embodiments, the solution is seawater. In some embodiments, the contaminant is salt.

In some embodiments, the asymmetric thin-film composite membrane disclosed herein is used to continuously purify a solution from a contaminant.

In some embodiments, a volumetric flow rate is from at least about 1 ml/min to at least about 50 ml/min. In some embodiments, the volumetric flow rate is at least about 2 ml/min. In some embodiments, the volumetric flow rate is at least about 3 ml/min. In some embodiments, the volumetric flow rate is at least about 4 ml/min. In some embodiments, the volumetric flow rate is at least about 5 ml/min. In some embodiments, the volumetric flow rate is at least about 6 ml/min. In some embodiments, the volumetric flow rate is at least about 7 ml/min. In some embodiments, the volumetric flow rate is at least about 8 ml/min. In some embodiments, the volumetric flow rate is at least about 9 ml/min. In some embodiments, the volumetric flow rate is at least about 10 ml/min. In some embodiments, the volumetric flow rate is at least about 12 ml/min. In some embodiments, the volumetric flow rate is at least about 14 ml/min. In some embodiments, the volumetric flow rate is at least about 16 ml/min. In some embodiments, the volumetric flow rate is at least about 18 ml/min. In some embodiments, the volumetric flow rate is at least about 20 ml/min. In some embodiments, the volumetric flow rate is at least about 22 ml/min. In some embodiments, the volumetric flow rate is at least about 24 ml/min. In some embodiments, the volumetric flow rate is at least about 26 ml/min. In some embodiments, the volumetric flow rate is at least about 28 ml/min. In some embodiments, the volumetric flow rate is at least about 30 ml/min. In some embodiments, the volumetric flow rate is at least about 32 ml/min. In some embodiments, the volumetric flow rate is at least about 34 ml/min. In some embodiments, the volumetric flow rate is at least about 36 ml/min. In some embodiments, the volumetric flow rate is at least about 38 ml/min. In some embodiments, the volumetric flow rate is at least about 40 ml/min. In some embodiments, the volumetric flow rate is at least about 42 ml/min. In some embodiments, the volumetric flow rate is at least about 44 ml/min. In some embodiments, the volumetric flow rate is at least about 46 ml/min. In some embodiments, the volumetric flow rate is at least about 48 ml/min. In some embodiments, the volumetric flow rate is at least about 50 ml/min.

In yet another aspect, described herein is a method of separating a contaminant from a gas, the method comprising:
(a) providing an asymmetric thin-film membrane comprising an active layer and a microporous support layer,
wherein said active layer has thickness from about 10 nm to about 1000 nm, and wherein said active layer and said microporous support layer are bonded to each other covalently;
(b) contacting an active layer face of the membrane with a first gas mixture of a first volume having a first contaminant concentration at a first pressure; and
(c) contacting a microporous support layer face of the membrane with a second gas mixture of a second volume optionally having a second contaminant concentration at a second pressure;
wherein the first gas mixture is in communication with the second gas mixture through the membrane,
wherein the first contaminant concentration is higher than the second contaminant concentration, thereby creating an osmotic pressure across the membrane, and
wherein the first pressure is sufficiently higher than the second pressure to increase the second volume and decrease the first volume, and wherein the first contaminant remains on the active layer face, thereby generating a purified gas.

In some embodiments of a method of separating a contaminant from a gas, the asymmetric membrane is produced by a process, comprising:
(a) providing a substrate having a top surface and a bottom surface;
(b) applying an active layer to the top surface of the substrate;
(c) exposing the active layer to a heat source;
(d) applying epoxy resin microporous support layer on top of the thermally exposed active layer;
(e) exposing the microporous support layer to a heat source to form an asymmetric thin-film composite membrane; wherein said active layer and said microporous support layer are bonded to each other covalently;
(f) exposing the asymmetric thin-film composite membrane to water; and
(g) optionally separating the membrane from the substrate.

In some embodiments, the first gas mixture comprises two or more gases selected from the group consisting of CO₂, CH₄, H₂, He, Ar, N₂, and O₂. In some embodiments, the first gas mixture comprises CO₂ and CH₄.

In some embodiments, the asymmetric thin-film composite membrane continuously separates gases from a mixture.

### Methods of Preparation

In one aspect, the present disclosure provides a method of preparing a membrane disclosed herein comprising the steps of:
obtaining a substrate having a top face and a bottom face;
applying an active layer to the top face of the substrate;
exposing the active layer to a first heat source;
applying an epoxy resin to the active layer; and
exposing the epoxy resin to a second heat source, thereby forming an form an asymmetric thin-film composite membrane.

In some embodiments, the method further comprises exposing the asymmetric thin-film composite membrane to water, e.g., for about 6 hours, about 8 hours, about 12 hours, about 18 hours, or about 24 hours.

In some embodiments, the method further comprises separating the membrane from the substrate having a top face and a bottom face, wherein the top face is affixed to the membrane. In some such embodiments, the top face of the substrate has a smooth surface. In other embodiments, the top face of the substrate has a rough surface. In some embodiments, the substrate comprises a non-woven fiber. In some embodiments, the substrate comprises glass or metal (e.g., stainless steel). In some embodiments, the substrate comprises carbon, polyester, polyaramid, polyetherimide, or a combination thereof. In some embodiments, the fiber is a non-woven polyester fabric.

In some embodiments, the first heat source has a temperature of at least about 100° C., at least about 120° C., at least about 200° C., or at least about 300° C. In some embodiments, the active layer is exposed to the heat source from about 1 to about 18 hours.

In some embodiments, the second heat source has a temperature of at least about 100° C., at least about 120° C., at least about 150° C. In some embodiments, the microporous layer is exposed to the heat source for about 1 to about 6 hours. In some embodiments, the microporous layer is exposed to the heat source for about 3 hours.

In some embodiments, the epoxy resin further comprises one or more porogens, e.g., a hydrophilic polymer, a hydrophobic polymer, or a mixture thereof. In some embodiments, the hydrophilic polymer comprises at least one moiety selected from poly(ethylene glycol) (PEG), poly(ethyleneimine), polyaniline, or a mixture thereof. In certain preferred embodiments, the porogen comprises a mixture of PEG200 and PEG400, e.g., at a ratio of PEG200 to PEG400 from about 1 to about 1.

In some embodiments, a casting blade set to a desired blade height is used to apply the active layer to the top surface of the substrate.

In a further aspect, described herein is a process of making an asymmetric thin-film composite membrane comprising:
(a) providing a substrate having a top surface and a bottom surface;
(b) applying an active layer to the top surface of the substrate;
(c) exposing the active layer to a heat source;
(d) applying epoxy resin microporous support layer on top of the thermally exposed active layer;
(e) exposing the microporous support layer to a heat source to form an asymmetric thin-film composite membrane; wherein said active layer and said microporous support layer are bonding to each other covalently;
(f) exposing the asymmetric thin-film composite membrane to water; and
(g) optionally separating the membrane from the substrate.

In some embodiments, the asymmetric thin-film composite membrane disclosed herein is a reverse osmosis membrane.

In some embodiments, the substrate has a smooth top surface. In some embodiments, the substrate is inorganic substrate. In some embodiments, the substrate is organic substrate.

In some embodiments, the inorganic substrate is glass or metal. In some embodiments, the substrate is a non-woven fiber material. In some embodiments, the non-woven fiber material is produced from glass, carbon, polyester, polyaramid, polyetherimide, or a combination thereof. In some embodiments, the substrate is a non-woven polyester fabric.

In some embodiments, the active layer comprises at least one polyaniline.

In some embodiments, the polyaniline is emeraldine base. In some such embodiments, the emeraldine base has the structure:

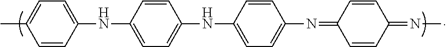

In some embodiments, the active layer comprises at least one polyimide. In some embodiments, the polyimide is aromatic. In some embodiments, the aromatic polyimide has the structure of:

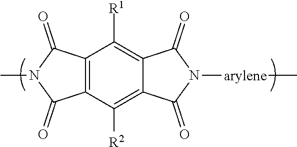

wherein,
R¹ is H, D, halogen, —CN, —OR³, —SR³, —S(═O)R³, —S(═O)₂R³, —C(═O)R³, —C(═O)OR³, —N(R³)₂ substituted or unsubstituted C₁-C₆alkyl, substituted or unsubstituted C₁-C₆fluoroalkyl, substituted or unsubstituted C₁-C₆heteroalkyl, substituted or unsubstituted C₃-C₆cycloalkyl, substituted or unsubstituted aryl, substituted or unsubstituted benzyl, or substituted or unsubstituted monocyclic heteroaryl;
R² is H, D, halogen, —CN, —OR³, —SR³, —S(═O)R³, —S(═O)₂R³, —C(═O)R³, —C(═O)OR³, —N(R³)₂ substituted or unsubstituted C₁-C₆alkyl, substituted or unsubstituted C₁-C₆fluoroalkyl, substituted or unsubstituted C₁-C₆heteroalkyl, substituted or unsubstituted C₃-C₆cycloalkyl, substituted or unsubstituted aryl, substituted or unsubstituted benzyl, or substituted or unsubstituted monocyclic heteroaryl; and
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle.

In some embodiments, the arylene group of aromatic polyimide is:

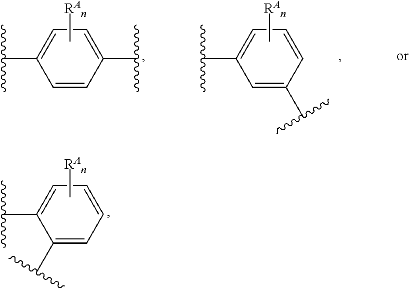

wherein each R^{A} is independently selected from H, D, halogen, —CN, —NO₂, —OR³, —SR³, —S(═O)R³, —S(═O)₂R³, —S(═O)₂N(R³)₂, —NR³S(═O)₂R³, —C(═O)R³, —OC(═O)R³, —C(═O)OR³, —OC(═O)OR³, —C(═O)N(R³)₂, and —N(R³)₂;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
n is 0, 1, 2, 3, or 4.

In some embodiments, the arylene group of aromatic polyimide is:

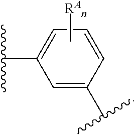

In some embodiments, the aromatic polyimide has the structure of:

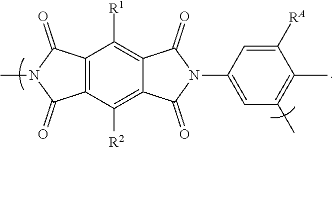

In some embodiments, R¹ is H. In some embodiments, R² is H. In some embodiments, R^{A} is H, —C(═O)OH, —C(═O)OCH₃, or —C(═O)NH₂. In some embodiments, R^{A} is H. In some embodiments, R^{A} is —C(═O)OH. In some embodiments, R^{A} is —C(═O)OCH₃. In some embodiments, R^{A} is —C(═O)NH₂.

In some embodiments, the active layer comprises at least one polybenzimidazolone.

In some embodiments, the polybenzimidazolone has one or more structures selected from:

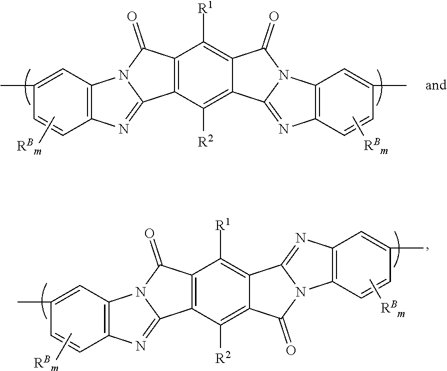

wherein each R^{B} is independently selected from H, D, halogen, —CN, —NO₂, —OR³, —SR³, —S(═O)R³, —S(═O)₂R³, —S(═O)₂N(R³)₂, —NR³S(═O)₂R³, —C(═O)R³, —OC(═O)R³, —C(═O)OR³, —OC(═O)OR³, and —N(R³)₂;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
m is 0, 1, 2, or 3.

In some embodiments, the active layer comprises at least one polyamide. In some embodiments, the polyamide has the structure of:

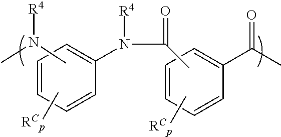

each R⁴ is independently H, D, —S(═O)R³, —S(═O)₂R³, —S(═O)₂N(R³)₂, —C(═O)R³, —C(═O)OR³, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl; or
two R^{C} are taken together to form a cross link;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

In some embodiments, the polyamide has the structure of:

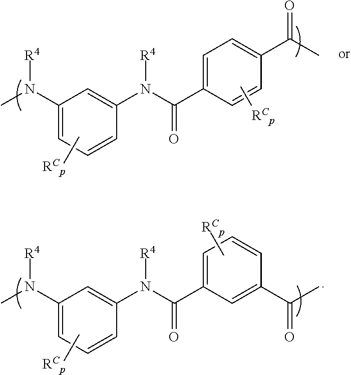

In some embodiments, the active layer comprises at least one polybenzimidazole. In some embodiments, the polybenzimidazole has the structure of:

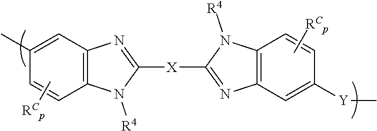

wherein,
X is absent, substituted or unsubstituted C₁-C₆alkylene, or substituted or unsubstituted arylene;
Y is absent, substituted or unsubstituted C₁-C₄alkylene, or substituted or unsubstituted arylene;
each R⁴ is independently H, D, —S(═O)R³, —S(═O)₂R³, —S(═O)₂N(R³)₂, —C(═O)R³, —C(═O)OR³, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

In some embodiments, the active layer comprises at least one polybenzoxazole. In some embodiments, the polybenzoxazole has the structure of:

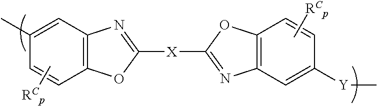

wherein,
X is absent, substituted or unsubstituted C₁-C₈alkylene, or substituted or unsubstituted arylene;
Y is absent, substituted or unsubstituted C₁-C₄alkylene, or substituted or unsubstituted arylene;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

In some embodiments, the active layer comprises one or more materials selected from the group consisting of zeolites, metal-organic frameworks, nanoporous carbides, TiO₂ nanoparticles, and carbon nanotubes.

In some embodiments, the active layer is exposed to a heat source. In some embodiments, the heat source comprises a stream of hot air, an oven, or an IR lamp. In some embodiments, the heat source has a temperature of at least about 50° C. to at least about 350° C. In some embodiments, the heat source has a temperature of at least about 50° C., at least about 60° C., at least about 70° C., at least about 80° C., at least about 90° C., at least about 100° C., at least about 110° C., at least about 120° C., at least about 130° C., at least about 140° C., at least about 150° C., at least about 160° C., at least about 170° C., at least about 180° C., at least about 190° C., at least about 200° C., at least about 210° C., at least about 220° C., at least about 230° C., at least about 240° C., at least about 250° C., at least about 260° C., at least about 270° C., at least about 280° C., at least about 290° C., at least about 300° C., at least about 310° C., at least about 320° C., at least about 330° C., at least about 340° C., or at least about 350° C.

In some embodiments, the active layer is exposed to a heat source from about 1 to about 36 hours. In some embodiments, the active layer is exposed to a heat source from about 1 to about 18 hours. In some embodiments, the active layer is exposed to the heat source for about 1 hour, about 1.5 hours, about 2 hours, about 2.5 hours, about 3 hours, about 3.5 hours, about 4 hours, about 4.5 hours, about 5 hours, about 5.5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 24 hours, about 27 hours, about 30 hours, about 33 hours, or about 36 hours. In some embodiments, the active layer is exposed to a heat source from about 1 hour, about 1.5 hours, about 2 hours, about 2.5 hours, about 3 hours, about 3.5 hours, about 4 hours, about 4.5 hours, about 5 hours, about 5.5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 24 hours, about 27 hours, about 33 hours, or about 33 hours to about 1.5 hours, about 2 hours, about 2.5 hours, about 3 hours, about 3.5 hours, about 4 hours, about 4.5 hours, about 5 hours, about 5.5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, about 24 hours, about 27 hours, about 30 hours, about 33 hours, or about 36 hours.

In some embodiments, the microporous support layer of the asymmetric thin-film composite membrane comprises at least one polymer-based epoxy resin.

In some embodiments, the polymer-based epoxy resin is diglycidyl ether-based epoxy resin. In some embodiments, the polymer-based epoxy resin is DER 333, DER 661, EPON 828, EPON 836, EPON 1001, EPON 1007F, Epikote 826, Epikote 828, ERL-4201, ERL-4221, GT-7013, GT-7014, GT-7074, GT-259, or any combination thereof. In some embodiments, the polymer-based epoxy resin is DER 333. In some embodiments, the polymer-based epoxy resin is DER 661. In some embodiments, the polymer-based epoxy resin is EPON 828. In some embodiments, the polymer-based epoxy resin is EPON 836. In some embodiments, the polymer-based epoxy resin is EPON 1001. In some embodiments, the polymer-based epoxy resin is EPON 1007F. In some embodiments, the polymer-based epoxy resin is Epikote 826. In some embodiments, the polymer-based epoxy resin is Epikote 828. In some embodiments, the polymer-based epoxy resin is ERL-4201. In some embodiments, the polymer-based epoxy resin is ERL-4221. In some embodiments, the polymer-based epoxy resin is GT-7013. In some embodiments, the polymer-based epoxy resin is GT-7014. In some embodiments, the polymer-based epoxy resin is GT-7074. In some embodiments, the polymer-based epoxy resin is GT-259.

In some embodiments, the epoxy resin is tetraglycidyl-4,4′-(4-aminophenyl)-p-diisopropylbenzene (EPON HPT 1071). In some embodiments, the epoxy resin is tetraglycidyl-4,4′-(3,5-dimethyl-4-aminophenyl)-p-diisopropylbenzene (EPON HPT 1072). In some embodiments, the epoxy resin is tetraglycidyl 4,4′-diamino diphenyl methane (MY-720). As the resin is prepared by reacting epichlorohydrin with methylene dianiline, it is frequently identified as tetraglycidylated methylene dianiline (TGMDA).

In some embodiments, the epoxy resin is polyglycidyl ethers of 4,4′-dihydroxyphenyl methane, 4,4′-dihydroxyphenyl sulfone, 4,4′-dihydroxydiphenyl sulfide, phenolphthalein, resorcinol, or tris(4-hydroxyphenyl)methane and the like. In some embodiments, the epoxy resin is EPON 1031 (a tetraglycidyl derivative of 1,1,2,2-tetrakis(hydroxyphenyl) ethane). In some embodiments, the epoxy resin is Apogen 101 (a methylolated bisphenol A resin). In some embodiments, the epoxy resin is halogenated polyglycidyl compound such as D.E.R. 542 (a brominated bisphenol A epoxy resin). Other suitable epoxy resins include polyepoxides prepared from polyols such as pentaerythritol, glycerol, butanediol, or trimethylolpropane and an epihalohydrin.

Other polyfunctional active hydrogen compounds besides phenols and alcohols are used to prepare the polyglycidyl adducts. They include amines, aminoalcohols, and polycarboxylic acids.

Suitable polyglycidyl adducts derived from aminoalcohols include O,N,N-triglycidyl-4-aminophenol available as Araldite 0500 or Araldite 0510 and O,N,N-triglycidyl-3-aminophenol (available as Glyamine 115).

In some embodiments, the glycidyl esters of carboxylic acids are used. Such glycidyl esters include, for example, diglycidyl phthalate, diglycidyl terephthalate, diglycidyl isophthalate, and diglycidyl adipate. In some embodiments, the resin is polyepoxide such as triglycidyl cyanurates and isocyanurates, N,N-diglycidyl oxamides, N,N′-diglycidyl derivates of hydantoins such as “XB 2793” diglycidyl esters of cycloaliphatic dicarboxylic acids, and polyglycidyl thioethers of polythiols.

Other epoxy-containing materials are copolymers of acrylic acid esters of glycidol such as glycidyl acrylate and glycidyl methacrylate with one or more copolymerizable vinyl compounds. Examples of such copolymers are 1:1 styrene-glycidyl methacrylate, 1:1 methyl methacrylate-glycidyl acrylate and 62.5:24:13.5 methyl methacrylate:ethyl acrylate:glycidyl methacrylate.

In some embodiments, the microporous support layer of the asymmetric thin-film composite membrane comprises at least one hardener.

The epoxy resins might be cured in a conventional manner. Suitable hardeners for the epoxy resins include sulfanilamide, dicyandiamide, aromatic amines such as diamino diphenyl sulfone ((4-H₂NC₆H₄)₂SO₂, DDS), bis(4-aminophenyl) methane, the bis(aminophenyl)diethers including 2,2-bis [4-[4-aminiophenoxy) phenyl]-1,3-trifluoropropane, bis[4-(4-aminophenoxy) phenyl]sulfone, and bisphenol A ether diamine (4-(4-H₂NC₆H₄—O)C₆H₄)₂C(CH₃)₂, BPADA); m-phenylenediamine, p-phenylenediamine, 1,6-diaminonaphthalene, 4,4′-diaminodiphenyl ether, 3-methyl-4-aminobenzamide, alpha, alpha′-bis(4-aminophenyl)-metadiisopropylbenzene, alpha, alpha′-bis(4-aminophenyl)-para-diisopropylbenzene, 1,3-bis(4-aminophenyl)benzene, and 1,3-bis(3-aminophenoxy) benzene, and polycarboxylic acid anhydrides such as hexahydrophthalic acid dianhydride, methylbicyclo[2,2,1]-hept-5-ene-2,3-dicarboxylic acid anhydride, pyromellitic acid dianhydride, bis-2,2-(4-phthalicanhydrido)hexafluoropropane, and benzophenone tetracarboxylic acid dianhydride. In some embodiments, the hardener is DDS or BPADA.

In some embodiments, the hardener is being selected from the aromatic polyamines, aliphatic polyamines and their adducts, carboxylic acid anhydrides, polyamides and catalytic curing agents, as for example tertiary amines, imidazoles, BF₃ monoethylamine, and dicyandiamide. In some embodiments, the hardener is aliphatic polyamine. In some embodiments, the hardener is polyamide. In some embodiments, the hardener is amidoamine.

In some embodiments, the hardener is cycloaliphatic amine. In some embodiments, the hardener is aromatic amine. In some embodiments, the hardener is diamine hardener.

In some embodiments, the amount of hardener employed to cure the epoxy resins approximates the quantities employed with the presently used commercial resins such as MY-720, EPON HPT 1071, EPON HPT 1072, and EPON 828. In some embodiments, the amount of hardener is from about 0.05 to about 2 weight equivalents per one weight equivalents of the epoxy resin. In some embodiments, the amount of hardener is from about 0.1 to about 1.5 weight equivalents. In some embodiments, about 0.5 to about 1 weight equivalents.

In some embodiments, the amount of hardener is about 0.05 weight equivalents, about 0.1 weight equivalents, about 0.15 weight equivalents, about 0.2 weight equivalents, about 0.25 weight equivalents, about 0.3 weight equivalents, about 0.35 weight equivalents, about 0.4 weight equivalents, about 0.45 weight equivalents, about 0.5 weight equivalents, about 0.55 weight equivalents, about 0.6 weight equivalents, about 0.65 weight equivalents, about 0.7 weight equivalents, about 0.75 weight equivalents, about 0.8 weight equivalents, about 0.85 weight equivalents, about 0.9 weight equivalents, about 0.95 weight equivalents, about 1 weight equivalent, about 1.05 weight equivalents, about 1.1 weight equivalents, about 1.15 weight equivalents, about 1.2 weight equivalents, about 1.25 weight equivalents, about 1.3 weight equivalents, about 1.35 weight equivalents, about 1.4 weight equivalents, about 1.45 weight equivalents, or about 1.5 weight equivalents.

In some embodiments, the epoxy resin comprises a porogen. Examples of porogens include, but not limited to, ethylene glycol and ethylene glycol based materials such as diethylene glycol, triethylene glycol, and higher homologs. The higher homologs of ethylene glycol are often referred to as polyethylene glycol (i.e., PEG) or polyethylene oxide (i.e., PEO). In some embodiments, the porogen is selected from the group consisting of propylene glycol and propylene glycol based materials such as dipropylene glycol, tripropylene glycol, and higher homologs. The higher homologs of propylene glycol are often referred to as polypropylene glycol (i.e., PPG) or polypropylene oxide (i.e., PPO). In some embodiments, the porogen is random or block copolymers of polyethylene oxide and polypropylene oxide.

Some porogens are polyalkylene oxides having a molecular weight of at least 200 g/mole, at least 400 g/mole, at least 800 g/mole, at least 1,000 g/mole, at least 2,000 g/mole, 4,000 g/mole, at least 8,000 g/mole, or at least 10,000 g/mole. In some embodiments, the polyalkylene oxide porogens have an average molecular weight up to 20,000 g/mole, up to 16,000 g/mole, up to 12,000 g/mole, up to 10,000 g/mole, up to 8,000 g/mole, up to 6,000 g/mole up to 4,000 g/mole, up to 2,000 g/mole, up to 1,000 g/mole, up to 500 g/mole, or up to 200 g/mole. In some embodiments, the polyalkylene oxide porogen typically has an average molecular weight in the range of 200 to 20,000 g/mole, in the range of 200 to 16,000 g/mole, in the range of 200 to 8,000 g/mole, in the range of 200 to 4,000 g/mole, in the range of 200 to 2,000 g/mole, in the range of 200 to 1,000 g/mole, in the range of 200 to 800 g/mole, in the range of 200 to 600 g/mole, or in the range of 200 to 400 g/mole.

In some embodiments, a mixture of porogens is used. In some embodiments, the porogen is a mixture of a first porogen being alkylene glycol and a second porogen that is a polyalkylene oxide. In some embodiments, the porogen is a mixture of ethylene glycol with a polyethylene glycol with hydroxy end groups.

In some embodiments, the porogen comprises a hydrophilic polymer, hydrophobic polymer, or a mixture thereof. In some embodiments, the hydrophilic polymer comprises poly(ethylene glycol) (PEG), poly(ethyleneimine), polyaniline, or a mixture thereof.

In some embodiments, the porogen comprises a mixture of PEG200 and PEG400. In some embodiments, the porogen comprises a mixture of PEG200 and PEG800. In some embodiments, the porogen comprises a mixture of PEG400 and PEG800.

In some embodiments, a ratio of PEG200 to PEG400 is from about 1:10 to about 10:1. In some embodiments, a ratio of PEG200 to PEG400 is from about 1:5 to about 5:1. In some embodiments, a ratio of PEG200 to PEG400 is from about 1:10, about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, or about 9:1 to about 1:9, about 1:8, about 1:7, about 1:6, about 1:5, about 1:4, about 1:3, about 1:2, about 1:1, about 2:1, about 3:1, about 4:1, about 5:1, about 6:1, about 7:1, about 8:1, about 9:1, or about 10:1. In some embodiments, the ratio of PEG200 to PEG400 is about 1 to about 10. In some embodiments, the ratio of PEG200 to PEG400 is about 1 to about 9. In some embodiments, the ratio of PEG200 to PEG400 is about 1 to about 8. In some embodiments, the ratio of PEG200 to PEG400 is about 1 to about 7. In some embodiments, the ratio of PEG200 to PEG400 is about 1 to about 6. In some embodiments, the ratio of PEG200 to PEG400 is about 1 to about 5. In some embodiments, the ratio of PEG200 to PEG400 is about 1 to about 4. In some embodiments, the ratio of PEG200 to PEG400 is about 1 to about 3. In some embodiments, the ratio of PEG200 to PEG400 is about 1 to about 2. In some embodiments, the ratio of PEG200 to PEG400 is about 1 to about 1. In some embodiments, the ratio of PEG200 to PEG400 is about 2 to about 1. In some embodiments, the ratio of PEG200 to PEG400 is about 3 to about 1. In some embodiments, the ratio of PEG200 to PEG400 is about 4 to about 1. In some embodiments, the ratio of PEG200 to PEG400 is about 5 to about 1. In some embodiments, the ratio of PEG200 to PEG400 is about 6 to about 1. In some embodiments, the ratio of PEG200 to PEG400 is about 7 to about 1. In some embodiments, the ratio of PEG200 to PEG400 is about 8 to about 1. In some embodiments, the ratio of PEG200 to PEG400 is about 9 to about 1. In some embodiments, the ratio of PEG200 to PEG400 is about 10 to about 1.

In some embodiments, the amount of porogen is from about 0.1 to about 10 weight equivalents per one weight equivalent of the epoxy resin. In some embodiments, the amount of porogen is from about 0.2 to about 5 weight equivalents. In some embodiments, about 0.5 to about 4 weight equivalent.

In some embodiments, the amount of porogen is about 0.1 weight equivalents, about 0.2 weight equivalents, about 0.3 weight equivalents, about 0.4 weight equivalents, about 0.5 weight equivalents, about 0.6 weight equivalents, about 0.7 weight equivalents, about 0.8 weight equivalents, about 0.9 weight equivalents, about 1 weight equivalent, about 1.1 weight equivalents, about 1.2 weight equivalents, about 1.3 weight equivalents, about 1.4 weight equivalents, about 1.5 weight equivalents, about 1.6 weight equivalents, about 1.7 weight equivalents, about 1.8 weight equivalents, about 1.9 weight equivalents, about 2 weight equivalents, about 2.1 weight equivalents, about 2.2 weight equivalents, about 2.3 weight equivalents, about 2.4 weight equivalents, about 2.5 weight equivalents, about 2.6 weight equivalents, about 2.7 weight equivalents, about 2.8 weight equivalents, about 2.9 weight equivalents, about 3 weight equivalents, about 3.1 weight equivalents, about 3.2 weight equivalents, about 3.3 weight equivalents, about 3.4 weight equivalents, about 3.5 weight equivalents, about 3.6 weight equivalents, about 3.7 weight equivalents, about 3.8 weight equivalents, about 3.9 weight equivalents, about 4 weight equivalents, about 4.1 weight equivalents, about 4.2 weight equivalents, about 4.3 weight equivalents, about 4.4 weight equivalents, about 4.5 weight equivalents, about 4.6 weight equivalents, about 4.7 weight equivalents, about 4.8 weight equivalents, about 4.9 weight equivalents, about 5 weight equivalents, about 5.1 weight equivalents, about 5.2 weight equivalents, about 5.3 weight equivalents, about 5.4 weight equivalents, about 5.5 weight equivalents, about 5.6 weight equivalents, about 5.7 weight equivalents, about 5.8 weight equivalents, about 5.9 weight equivalents, about 6 weight equivalents, about 6.1 weight equivalents, about 6.2 weight equivalents, about 6.3 weight equivalents, about 6.4 weight equivalents, about 6.5 weight equivalents, about 6.6 weight equivalents, about 6.7 weight equivalents, about 6.8 weight equivalents, about 6.9 weight equivalents, about 7 weight equivalents, about 7.1 weight equivalents, about 7.2 weight equivalents, about 7.3 weight equivalents, about 7.4 weight equivalents, about 7.5 weight equivalents, about 7.6 weight equivalents, about 7.7 weight equivalents, about 7.8 weight equivalents, about 7.9 weight equivalents, about 8 weight equivalents, about 8.1 weight equivalents, about 8.2 weight equivalents, about 8.3 weight equivalents, about 8.4 weight equivalents, about 8.5 weight equivalents, about 8.6 weight equivalents, about 8.7 weight equivalents, about 8.8 weight equivalents, about 8.9 weight equivalents, about 9 weight equivalents, about 9.1 weight equivalents, about 9.2 weight equivalents, about 9.3 weight equivalents, about 9.4 weight equivalents, about 9.5 weight equivalents, about 9.6 weight equivalents, about 9.7 weight equivalents, about 9.8 weight equivalents, about 9.9 weight equivalents, or about 10 weight equivalents of the epoxy resin.

In some embodiments, the epoxy resin additionally comprises an accelerator to increase the rate of cure. In some embodiments, the accelerator is selected from Lewis acid/amine complexes such as BF₃/monoethylamine, BF₃/piperidine, BF₃/methylimidazole; amines, such as imidiazole and its derivatives such as 4-ethyl-2-methylimidazole, 1-methylimidazole, 2-methylimidazole; N,N-dimethylbenzylamine; acid salts of tertiary amines, such as the p-toluenesulfonic acid/imidazole complex, salts of tri-fluoromethane sulfonic acid, such as FC-520 (obtained from 3M Company), organophosphonium halides, dicyandiamide, 1,1-dimethyl-3-phenyl urea (Fikure (62U from Fike Chemical Co.) and chlorinated derivatives of 1,1-dimethyl-3-phenyl urea (monuron and diuron from du Pont).

In some embodiments, the amount of cure accelerator is from about 0.01 wt. % to about 20 wt. % of the epoxy resin system (i.e., epoxy plus hardener plus porogen). In some embodiments, the amount of cure accelerator is about 0.01 wt. %, about 0.05 wt. %, about 0.1 wt. %, about 0.2 wt. %, about 0.3 wt. %, about 0.4 wt. %, about 0.5 wt. %, about 0.6 wt. %, about 0.7 wt. %, about 0.8 wt. %, about 0.9 wt. %, about 1 wt. %, about 2 wt. %, about 3 wt. %, about 4 wt. %, about 5 wt. %, about 6 wt. %, about 7 wt. %, about 8 wt. %, about 9 wt. %, about 10 wt. %, about 11 wt. %, about 12 wt. %, about 13 wt. %, about 14 wt. %, about 15 wt. %, about 16 wt. %, about 17 wt. %, about 18 wt. %, about 19 wt. %, or about 20 wt. % of the epoxy resin system (i.e., epoxy plus hardener plus porogen).

In some embodiments, two or more epoxy resins are mixed prior to curing of the microporous support layer of the asymmetric thin-film composite membrane. In some embodiments, one epoxy resin is present in an amount from about 5 wt. % to about 95 wt. %.

In some embodiments, one epoxy resin is present in an amount from about 10 wt. % to about 90 wt. %. In some embodiments, one epoxy resin is present in an amount from about 20 wt. % to about 80 wt. %. In some embodiments, one epoxy resin is present in an amount from about 30 wt. % to about 70 wt. %. In some embodiments, one epoxy resin is present in an amount from about 40 wt. % to about 60 wt. %. In some embodiments, one epoxy resin is present in an amount of about 50 wt. %.

In some embodiments, the microporous support layer of the asymmetric thin-film composite membrane is exposed to a heat source. In some embodiments, the heat source comprises a stream of hot air, an oven, or an IR lamp. In some embodiments, the heat source has a temperature of at least about 50° C. to at least about 200° C. In some embodiments, the heat source has a temperature of at least about 50° C., at least about 60° C., at least about 70° C., at least about 80° C., at least about 90° C., at least about 100° C., at least about 110° C., at least about 120° C., at least about 130° C., at least about 140° C., at least about 150° C., at least about 160° C., at least about 170° C., at least about 180° C., at least about 190° C., or at least about 200° C.

In some embodiments, the microporous support layer of the asymmetric thin-film composite membrane is exposed to a heat source from about 1 to about 24 hours. In some embodiments, the microporous support layer of the asymmetric thin-film composite membrane is exposed to a heart source from about 1 to about 6 hours. In some embodiments, the active layer is exposed to the heat source for about 1 hour, about 1.5 hours, about 2 hours, about 2.5 hours, about 3 hours, about 3.5 hours, about 4 hours, about 4.5 hours, about 5 hours, about 5.5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, or about 24 hours. In some embodiments, the active layer is exposed to the heat source from about 1 hour, about 1.5 hours, about 2 hours, about 2.5 hours, about 3 hours, about 3.5 hours, about 4 hours, about 4.5 hours, about 5 hours, about 5.5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, or about 23 hours to about 1.5 hours, about 2 hours, about 2.5 hours, about 3 hours, about 3.5 hours, about 4 hours, about 4.5 hours, about 5 hours, about 5.5 hours, about 6 hours, about 7 hours, about 8 hours, about 9 hours, about 10 hours, about 11 hours, about 12 hours, about 13 hours, about 14 hours, about 15 hours, about 16 hours, about 17 hours, about 18 hours, about 19 hours, about 20 hours, about 21 hours, about 22 hours, about 23 hours, or about 24 hours.

In some embodiments, the active layer of the asymmetric thin-film composite membrane and the microporous support layer of the asymmetric thin-film composite membrane are bonding to each other when exposed to a heat source. In some embodiments, the bonding comprises a covalent modification. In some embodiments, the active layer of the asymmetric thin-film composite membrane and the microporous support layer of the asymmetric thin-film composite membrane are bonded via C—O covalent bonds. In some embodiments, the active layer of the asymmetric thin-film composite membrane and the microporous support layer of the asymmetric thin-film composite membrane bonded via C—N covalent bonds. In some embodiments, the active layer of the asymmetric thin-film composite membrane and the microporous support layer of the asymmetric thin-film composite membrane are bonded via C—O or C—N covalent bonds. In some embodiments, the active layer of the asymmetric thin-film composite membrane and the microporous support layer of the asymmetric thin-film composite membrane are bonded via C—O and C—N covalent bonds.

In a further aspect, bonding comprises exposing the microporous support layer of the asymmetric thin-film composite membrane and the active layer of the asymmetric thin-film composite membrane to a light source. In some embodiments, bonding comprises exposing the microporous support layer of the asymmetric thin-film composite membrane to a light source. In some embodiments, bonding comprises exposing the active layer of the asymmetric thin-film composite membrane to a light source. In some embodiments, bonding comprises a photochemical modification. In some embodiments, the light source comprises UV light. In some embodiments, the light source comprises UV light in the range of from between 200 nm and 370 nm.

In some embodiments, the asymmetric thin-film composite membrane is exposed to water from about 1 to about 48 hours. In some embodiments, the asymmetric thin-film composite membrane is exposed to water for about 2 hours. In some embodiments, the asymmetric thin-film composite membrane is exposed to water for about 4 hours. In some embodiments, the asymmetric thin-film composite membrane is exposed to water for about 6 hours. In some embodiments, the asymmetric thin-film composite membrane is exposed to water for about 8 hours. In some embodiments, the asymmetric thin-film composite membrane is exposed to water for about 12 hours. In some embodiments, the asymmetric thin-film composite membrane is exposed to water for about 18 hours. In some embodiments, the asymmetric thin-film composite membrane is exposed to water for about 24 hours. In some embodiments, the asymmetric thin-film composite membrane is exposed to water for about 30 hours. In some embodiments, the asymmetric thin-film composite membrane is exposed to water for about 36 hours. In some embodiments, the asymmetric thin-film composite membrane is exposed to water for about 48 hours.

In some embodiments, the asymmetric thin-film composite membrane is optionally separated from the substrate. In some embodiments, the asymmetric thin-film composite membrane is not separated from the substrate.

### Definitions

As used herein, nomenclature for compounds, including organic compounds, can be given using common names, IUPAC, IUBMB, or CAS recommendations for nomenclature. When one or more stereochemical features are present, Cahn-Ingold-Prelog rules for stereochemistry can be employed to designate stereochemical priority, E/Z specification, and the like. One of skill in the art can readily ascertain the structure of a compound if given a name, either by systemic reduction of the compound structure using naming conventions, or by commercially available software, such as CHEMDRAW™ (Cambridgesoft Corporation, U.S.A.).

As used in the specification and the appended claims, the singular forms “a,” “an” and “the” include plural referents unless the context clearly dictates otherwise. Thus, for example, reference to “a component,” “a polymer,” or “a particle” includes mixtures of two or more such components, polymers, or particles, and the like.

Ranges can be expressed herein as from “about” one particular value, and/or to “about” another particular value. When such a range is expressed, another aspect includes from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint. It is also understood that there are a number of values disclosed herein, and that each value is also herein disclosed as “about” that particular value in addition to the value itself. For example, if the value “10” is disclosed, then “about 10” is also disclosed. It is also understood that when a value is disclosed that “less than or equal to” the value, “greater than or equal to the value” and possible ranges between values are also disclosed, as appropriately understood by the skilled artisan. For example, if the value “10” is disclosed the “less than or equal to 10” as well as “greater than or equal to 10” is also disclosed. It is also understood that throughout the application, data is provided in a number of different formats and that this data represents endpoints and starting points, and ranges for any combination of the data points. For example, if a particular data point “10” and a particular data point 15 are disclosed, it is understood that greater than, greater than or equal to, less than, less than or equal to, and equal to 10 and 15 are considered disclosed as well as between 10 and 15. It is also understood that each unit between two particular units are also disclosed. For example, if 10 and 15 are disclosed, then 11, 12, 13, and 14 are also disclosed.

References in the specification and concluding claims to parts by weight of a particular element or component in a composition denotes the weight relationship between the element or component and any other elements or components in the composition or article for which a part by weight is expressed. Thus, in a compound containing 2 parts by weight of component X and 5 parts by weight component Y, X and Y are present at a weight ratio of 2:5, and are present in such ratio regardless of whether additional components are contained in the compound.

A weight percent (wt. %) of a component, unless specifically stated to the contrary, is based on the total weight of the formulation or composition in which the component is included.

As used herein, the terms “optional” or “optionally” means that the subsequently described event or circumstance may or may not occur, and that the description includes instances where said event or circumstance occurs and instances where it does not.

As used herein, the terms “effective amount” and “amount effective” refer to an amount that is sufficient to achieve the desired result or to have an effect on an undesired condition.

The term “stable”, as used herein, refers to compositions that are not substantially altered when subjected to conditions to allow for their production, detection, and, in certain aspects, their recovery, purification, and use for one or more of the purposes disclosed herein.

As used herein, the term “polymer” refers to a relatively high molecular weight organic compound, natural or synthetic, whose structure can be represented by a repeated small unit, the monomer (e.g., polyethylene, rubber, cellulose). Synthetic polymers are typically formed by addition or condensation polymerization of monomers.

As used herein, the term “homopolymer” refers to a polymer formed from a single type of repeating unit (monomer residue).

As used herein, the term “copolymer” refers to a polymer formed from two or more different repeating units (monomer residues). By way of example and without limitation, a copolymer can be an alternating copolymer, a random copolymer, a block copolymer, or a graft copolymer. It is also contemplated that, in certain aspects, various block segments of a block copolymer can themselves comprise copolymers.

As used herein, the term “oligomer” refers to a relatively low molecular weight polymer in which the number of repeating units is between two and ten, for example, from two to eight, from two to six, or form two to four. In one aspect, a collection of oligomers can have an average number of repeating units of from about two to about ten, for example, from about two to about eight, from about two to about six, or form about two to about four.

As used herein, the term “cross-linked polymer” refers to a polymer having bonds linking one polymer chain to another.

As used herein, the term “porogen composition” or “porogen(s)” refers to any structured material that can be used to create a porous material.

“Oxo” refers to the ═O substituent.

“Thioxo” refers to the ═S substituent.

“Alkyl” refers to a straight or branched hydrocarbon chain radical, having from one to twenty carbon atoms, and which is attached to the rest of the molecule by a single bond. An alkyl comprising up to 10 carbon atoms is referred to as a C1-C10 alkyl, likewise, for example, an alkyl comprising up to 6 carbon atoms is a C1-C6 alkyl. Alkyls (and other moieties defined herein) comprising other numbers of carbon atoms are represented similarly. Alkyl groups include, but are not limited to, C1-C10 alkyl, C1-C9 alkyl, C1-C8 alkyl, C1-C7 alkyl, C1-C6 alkyl, C1-C5 alkyl, C1-C4 alkyl, C1-C3 alkyl, C1-C2 alkyl, C2-C8 alkyl, C3-C8 alkyl and C4-C8 alkyl. Representative alkyl groups include, but are not limited to, methyl, ethyl, n-propyl, 1-methylethyl (i-propyl), n-butyl, i-butyl, s-butyl, n-pentyl, 1,1-dimethylethyl (t-butyl), 3-methylhexyl, 2-methylhexyl, 1-ethyl-propyl, and the like. In some embodiments, the alkyl is methyl or ethyl. In some embodiments, the alkyl is —CH(CH3)₂ or —C(CH3)3. Unless stated otherwise specifically in the specification, an alkyl group may be optionally substituted as described below. “Alkylene” or “alkylene chain” refers to a straight or branched divalent hydrocarbon chain linking the rest of the molecule to a radical group. In some embodiments, the alkylene is —CH2-, —CH2CH2-, or —CH2CH2CH2-. In some embodiments, the alkylene is —CH2-. In some embodiments, the alkylene is —CH2CH2-. In some embodiments, the alkylene is —CH2CH2CH2-.

“Alkoxy” refers to a radical of the formula —OR where R is an alkyl radical as defined. Unless stated otherwise specifically in the specification, an alkoxy group may be optionally substituted as described below. Representative alkoxy groups include, but are not limited to, methoxy, ethoxy, propoxy, butoxy, pentoxy. In some embodiments, the alkoxy is methoxy. In some embodiments, the alkoxy is ethoxy.

“Heteroalkylene” refers to an alkyl radical as described above where one or more carbon atoms of the alkyl is replaced with a O, N or S atom. “Heteroalkylene” or “heteroalkylene chain” refers to a straight or branched divalent heteroalkyl chain linking the rest of the molecule to a radical group. Unless stated otherwise specifically in the specification, the heteroalkyl or heteroalkylene group may be optionally substituted as described below. Representative heteroalkyl groups include, but are not limited to —OCH2OMe, —OCH2CH2OMe, or —OCH2CH2OCH2CH2NH2. Representative heteroalkylene groups include, but are not limited to —OCH2CH2O—, —OCH2CH2OCH2CH2O—, or —OCH2CH2OCH2CH2OCH2CH2O—.

“Alkylamino” refers to a radical of the formula —NHR or —NRR where each R is, independently, an alkyl radical as defined above. Unless stated otherwise specifically in the specification, an alkylamino group may be optionally substituted as described below.

The term “aromatic” refers to a planar ring having a delocalized it-electron system containing 4n+2 π electrons, where n is an integer. Aromatics can be optionally substituted. The term “aromatic” includes both aryl groups (e.g., phenyl, naphthalenyl) and heteroaryl groups (e.g., pyridinyl, quinolinyl).

“Aryl” refers to an aromatic ring wherein each of the atoms forming the ring is a carbon atom. Aryl groups can be optionally substituted. Examples of aryl groups include, but are not limited to phenyl, and naphthyl. In some embodiments, the aryl is phenyl. Depending on the structure, an aryl group can be a monoradical or a diradical (i.e., an arylene group). Unless stated otherwise specifically in the specification, the term “aryl” or the prefix “ar-” (such as in “aralkyl”) is meant to include aryl radicals that are optionally substituted.

“Carboxy” refers to —CO2H. In some embodiments, carboxy moieties may be replaced with a “carboxylic acid bioisostere”, which refers to a functional group or moiety that exhibits similar physical and/or chemical properties as a carboxylic acid moiety. A carboxylic acid bioisostere has similar biological properties to that of a carboxylic acid group. A compound with a carboxylic acid moiety can have the carboxylic acid moiety exchanged with a carboxylic acid bioisostere and have similar physical and/or biological properties when compared to the carboxylic acid-containing compound. For example, in one embodiment, a carboxylic acid bioisostere would ionize at physiological pH to roughly the same extent as a carboxylic acid group. Examples of bioisosteres of a carboxylic acid include, but are not limited to:

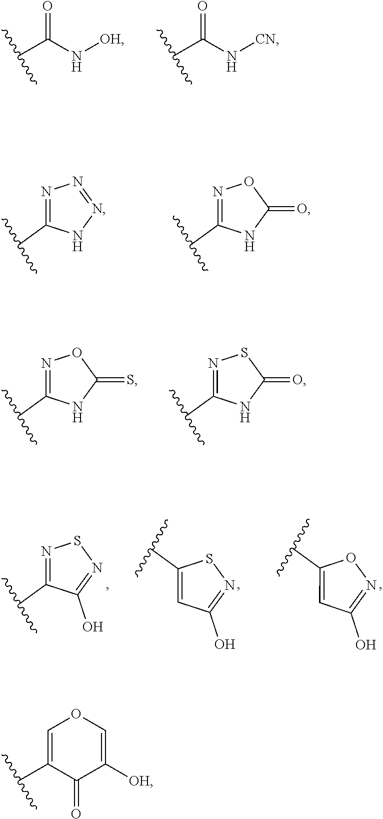

and the like.

“Cycloalkyl” refers to a monocyclic or polycyclic non-aromatic radical, wherein each of the atoms forming the ring (i.e. skeletal atoms) is a carbon atom. Cycloalkyls may be saturated, or partially unsaturated. Cycloalkyls may be fused with an aromatic ring (in which case the cycloalkyl is bonded through a non-aromatic ring carbon atom). Cycloalkyl groups include groups having from 3 to 10 ring atoms. Representative cycloalkyls include, but are not limited to, cycloalkyls having from three to ten carbon atoms, from three to eight carbon atoms, from three to six carbon atoms, or from three to five carbon atoms. Monocyclic cyclcoalkyl radicals include, for example, cyclopropyl, cyclobutyl, cyclopentyl, cyclohexyl, cycloheptyl, and cyclooctyl. In some embodiments, the monocyclic cyclcoalkyl is cyclopropyl, cyclobutyl, cyclopentyl or cyclohexyl. In some embodiments, the monocyclic cyclcoalkyl is cyclopentyl. Polycyclic radicals include, for example, adamantyl, norbornyl, decalinyl, and 3,4-dihydronaphthalen-1(2H)-one. Unless otherwise stated specifically in the specification, a cycloalkyl group may be optionally substituted.

“Fused” refers to any ring structure described herein which is fused to an existing ring structure. When the fused ring is a heterocyclyl ring or a heteroaryl ring, any carbon atom on the existing ring structure which becomes part of the fused heterocyclyl ring or the fused heteroaryl ring may be replaced with a nitrogen atom.

“Halo” or “halogen” refers to bromo, chloro, fluoro or iodo.

“Haloalkyl” refers to an alkyl radical, as defined above, that is substituted by one or more halo radicals, as defined above, e.g., trifluoromethyl, difluoromethyl, fluoromethyl, trichloromethyl, 2,2,2-trifluoroethyl, 1,2-difluoroethyl, 3-bromo-2-fluoropropyl, 1,2-dibromoethyl, and the like. Unless stated otherwise specifically in the specification, a haloalkyl group may be optionally substituted.

“Haloalkoxy” refers to an alkoxy radical, as defined above, that is substituted by one or more halo radicals, as defined above, e.g., trifluoromethoxy, difluoromethoxy, fluoromethoxy, trichloromethoxy, 2,2,2-trifluoroethoxy, 1,2-difluoroethoxy, 3-bromo-2-fluoropropoxy, 1,2-dibromoethoxy, and the like. Unless stated otherwise specifically in the specification, a haloalkoxy group may be optionally substituted.

“Heterocycloalkyl” or “heterocyclyl” or “heterocyclic ring” refers to a stable 3- to 14-membered non-aromatic ring radical comprising 2 to 10 carbon atoms and from one to 4 heteroatoms selected from the group consisting of nitrogen, oxygen, and sulfur. Unless stated otherwise specifically in the specification, the heterocycloalkyl radical may be a monocyclic, or bicyclic ring system, which may include fused (when fused with an aryl or a heteroaryl ring, the heterocycloalkyl is bonded through a non-aromatic ring atom) or bridged ring systems. The nitrogen, carbon or sulfur atoms in the heterocyclyl radical may be optionally oxidized. The nitrogen atom may be optionally quaternized. The heterocycloalkyl radical is partially or fully saturated. Examples of such heterocycloalkyl radicals include, but are not limited to, dioxolanyl, thienyl[1,3]dithianyl, decahydroisoquinolyl, imidazolinyl, imidazolidinyl, isothiazolidinyl, isoxazolidinyl, morpholinyl, octahydroindolyl, octahydroisoindolyl, 2-oxopiperazinyl, 2-oxopiperidinyl, 2-oxopyrrolidinyl, oxazolidinyl, piperidinyl, piperazinyl, 4-piperidonyl, pyrrolidinyl, pyrazolidinyl, quinuclidinyl, thiazolidinyl, tetrahydrofuryl, trithianyl, tetrahydropyranyl, thiomorpholinyl, thiamorpholinyl, 1-oxo-thiomorpholinyl, 1,1-dioxo-thiomorpholinyl. The term heterocycloalkyl also includes all ring forms of carbohydrates, including but not limited to monosaccharides, disaccharides and oligosaccharides. Unless otherwise noted, heterocycloalkyls have from 2 to 10 carbons in the ring. In some embodiments, heterocycloalkyls have from 2 to 8 carbons in the ring. In some embodiments, heterocycloalkyls have from 2 to 8 carbons in the ring and 1 or 2 N atoms. In some embodiments, heterocycloalkyls have from 2 to 10 carbons, 0-2 N atoms, 0-2 O atoms, and 0-1 S atoms in the ring. In some embodiments, heterocycloalkyls have from 2 to 10 carbons, 1-2 N atoms, 0-1 O atoms, and 0-1 S atoms in the ring. It is understood that when referring to the number of carbon atoms in a heterocycloalkyl, the number of carbon atoms in the heterocycloalkyl is not the same as the total number of atoms (including the heteroatoms) that make up the heterocycloalkyl (i.e. skeletal atoms of the heterocycloalkyl ring). Unless stated otherwise specifically in the specification, a heterocycloalkyl group may be optionally substituted.

“Heteroaryl” refers to an aryl group that includes one or more ring heteroatoms selected from nitrogen, oxygen and sulfur. The heteroaryl is monocyclic or bicyclic. Illustrative examples of monocyclic heteroaryls include pyridinyl, imidazolyl, pyrimidinyl, pyrazolyl, triazolyl, pyrazinyl, tetrazolyl, furyl, thienyl, isoxazolyl, thiazolyl, oxazolyl, isothiazolyl, pyrrolyl, pyridazinyl, triazinyl, oxadiazolyl, thiadiazolyl, furazanyl, indolizine, indole, benzofuran, benzothiophene, indazole, benzimidazole, purine, quinolizine, quinoline, isoquinoline, cinnoline, phthalazine, quinazoline, quinoxaline, 1,8-naphthyridine, and pteridine. Illustrative examples of monocyclic heteroaryls include pyridinyl, imidazolyl, pyrimidinyl, pyrazolyl, triazolyl, pyrazinyl, tetrazolyl, furyl, thienyl, isoxazolyl, thiazolyl, oxazolyl, isothiazolyl, pyrrolyl, pyridazinyl, triazinyl, oxadiazolyl, thiadiazolyl, and furazanyl. Illustrative examples of bicyclic heteroaryls include indolizine, indole, benzofuran, benzothiophene, indazole, benzimidazole, purine, quinolizine, quinoline, isoquinoline, cinnoline, phthalazine, quinazoline, quinoxaline, 1,8-naphthyridine, and pteridine. In some embodiments, heteroaryl is pyridinyl, pyrazinyl, pyrimidinyl, thiazolyl, thienyl, thiadiazolyl or furyl. In some embodiments, a heteroaryl contains 0-4 N atoms in the ring. In some embodiments, a heteroaryl contains 1-4 N atoms in the ring. In some embodiments, a heteroaryl contains 0-4 N atoms, 0-1 O atoms, and 0-1 S atoms in the ring. In some embodiments, a heteroaryl contains 1-4 N atoms, 0-1 O atoms, and 0-1 S atoms in the ring. In some embodiments, heteroaryl is a C1-C9heteroaryl. In some embodiments, monocyclic heteroaryl is a C1-C5heteroaryl. In some embodiments, monocyclic heteroaryl is a 5-membered or 6-membered heteroaryl. In some embodiments, a bicyclic heteroaryl is a C6-C9heteroaryl.

The term “optionally substituted” or “substituted” means that the referenced group may be substituted with one or more additional group(s) individually and independently selected from alkyl, haloalkyl, cycloalkyl, aryl, heteroaryl, heterocycloalkyl, —OH, alkoxy, aryloxy, alkylthio, arylthio, alkylsulfoxide, arylsulfoxide, alkylsulfone, arylsulfone, —CN, alkyne, C₁-C₆alkylalkyne, halogen, acyl, acyloxy, —CO₂H, —CO₂alkyl, nitro, and amino, including mono- and di-substituted amino groups (e.g. —NH₂, —NHR, —N(R)₂), and the protected derivatives thereof. In some embodiments, optional substituents are independently selected from alkyl, alkoxy, haloalkyl, cycloalkyl, halogen, —CN, —NH₂, —NH(CH₃), —N(CH₃)₂, —OH, —CO₂H, and —CO₂alkyl. In some embodiments, optional substituents are independently selected from fluoro, chloro, bromo, iodo, —CH₃, —CH₂CH₃, —CF₃, —OCH₃, and —OCF₃. In some embodiments, substituted groups are substituted with one or two of the preceding groups. In some embodiments, an optional substituent on an aliphatic carbon atom (acyclic or cyclic, saturated or unsaturated carbon atoms, excluding aromatic carbon atoms) includes oxo (═O). Compounds described herein can contain one or more double bonds and, thus, potentially give rise to cis/trans (E/Z) isomers, as well as other conformational isomers. Unless stated to the contrary, the invention includes all such possible isomers, as well as mixtures of such isomers.

In some embodiments, certain materials, compounds, compositions, and components disclosed herein can be obtained commercially or readily synthesized using techniques generally known to those of skill in the art. For example, the starting materials and reagents used in preparing the disclosed compounds and compositions are either available from commercial suppliers such as Aldrich Chemical Co., Milwaukee, Wis.), Acros Organics (Morris Plains, N.J.), Fisher Scientific (Pittsburgh, Pa.), or Sigma (St. Louis, Mo.) or are prepared by methods known to those skilled in the art following procedures set forth in references such as Fieser and Fieser's Reagents for Organic Synthesis, Volumes 1-17 (John Wiley and Sons, 1991); Rodd's Chemistry of Carbon Compounds, Volumes 1-5 and Supplemental volumes (Elsevier Science Publishers, 1989); Organic Reactions, Volumes 1-40 (John Wiley and Sons, 1991); March's Advanced Organic Chemistry, (John Wiley and Sons, 4th Edition); and Larock's Comprehensive Organic Transformations (VCH Publishers Inc., 1989).

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; and the number or type of embodiments described in the specification.

### EXAMPLES

The following examples are provided for illustrative purposes only, and are intended to be purely exemplary of the disclosure and are not intended to limit the scope of the claims provided herein. Efforts have been made to ensure accuracy with respect to numbers (e.g., amounts, temperature, etc.), but some errors and deviations should be accounted for.

### Example 1. Exemplary Process of Making an Asymmetric Thin-Film Membrane

The active layer film was cast independently of the microporous support. First, the active layer was cast onto a substrate using a doctor blade or spin-coater, then it was thermally cured. In the second step, thermosetting resin was then cast directly on top of the active layer and thermally cured to form a microporous support. As the support cured and hardened, it simultaneously generated covalent interactions with the active layer enabling the essentially defect-free delamination of the active layer from the underlying substrate. Physical and chemical properties of the active layer were investigated through spectroscopic techniques because the active layer was cast separately from the support. Furthermore, as long as these techniques are non-destructive, the active layer can be directly fabricated into an RO membrane with the T-FLO technique and studied during operation in a pressurized cell. Additionally, casting on an inorganic substrate enabled high performance polymers such as polyimides and polybenzimidazolones to be formed into asymmetric membranes for RO. The active layer thickness can be adjusted, in some instances, to <100 nm, resulting in high permeability.

### Example 2. Exemplary Preparation of the Polybenzimidazolone Active Layer of the Asymmetric Thin-Film Membrane

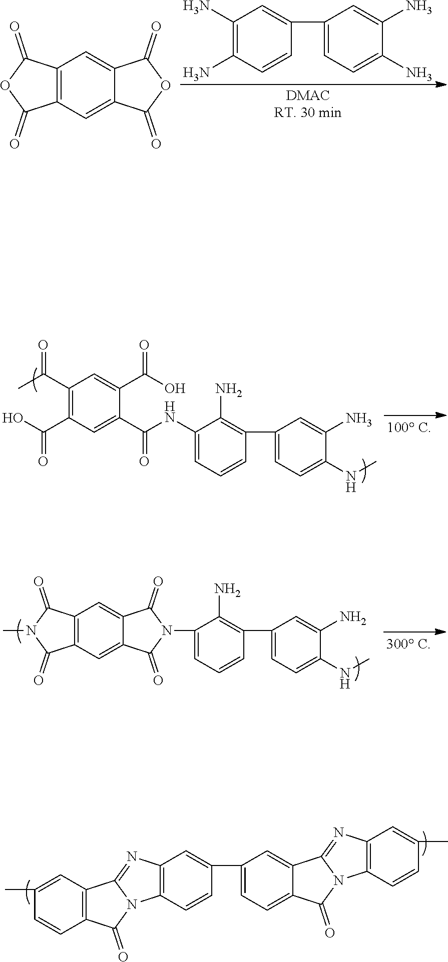

The polybenzimidazolone polymer of pyromellitic dianhydride (PMDA) and 3,3′-diaminobenzidine (DAB) was prepared by adding 95 ml of a solution of 0.04 mole of PMDA in 100 ml DMAC to a stirred solution of 0.04 mole of DAB in 100 ml DMAC at room temperature under nitrogen. After 30 minutes of stirring, the remainder of the PMDA solution, 0.44 g. in 5 ml DMAC, was added dropwise. Stirring was continued for one hour. The solution might be diluted with additional DMAC to adjust the wt. % and viscosity of the polymer solution. Before casting, the prepolymer solution was centrifuged and degassed to avoid defects in the final polymer films.

The resulted prepolymer solution was cast with an adjustable clearance film aplicator onto a surface of a material. After the film was cast, a heat of about 50° C. was applied beneath the material from a heating source. After one hour, the material was placed in a forced air oven set at 100° C. The films were cured for various times at 150° C. and 300 OC. After the curing cycle, the active layer was cooled down and used in the preparation of an asymmetric thin-film composite membrane.

### Example 3. Exemplary Preparation of Gas Separation Active Layers with Polyaniline

Polyaniline polymer solution was prepared according to the following procedure. Commercially available 20 kDa molecular weight polyaniline was dissolved in a mixture of tetrahydrofuran and N-methylpyrollidone at different wt. % solutions. Once fully dissolved, the solutions was centrifuged and degassed to avoid defects when casting.

### Example 4. Exemplary Preparation of TiO₂ Nanoparticle Self-Assembled Aromatic Polyamide Thin-Film-Composite (TFC) Membrane as Active Layers

TiO₂ nanoparticles were prepared from the controlled hydrolysis of titanium tetraisopropoxide at acidic condition. A 1.25 ml sample of Ti(OCH(CH₃)₂)₄ (Aldrich, 97%) dissolved in 25 ml of absolute ethanol by injection was dropped under vigorous stirring to 250 ml of distilled water (4° C.) adjusted to pH 1.5 with nitric acid. After this mixture was stirred overnight, a transparent colloidal suspension was resulted. Powdered sample was obtained by evaporating (35° C.) using a rotavapor and drying (50° C.) under vacuum.

Thin-film-composite (TFC) membrane was made via interfacial polymerization of m-phenylenediamine (MPD) in the aqueous phase (2 wt. %) and trimesoyl chloride (TMC) in the organic phase (0.1 wt. %) on the nonwoven fabric-reinforced polysulfone supports. The resulting TFC membrane was rinsed in a sodium carbonate solution (0.2 wt. %) and then washed with distilled water. The neat TFC membrane with an area of ca. 50.0 cm² was dipped in the transparent TiO₂ colloidal solution for 1 h to deposit TiO₂ nanoparticles on the membrane surface and then washed with water.

### Example 5. Exemplary Preparation of the Polyimide Active Layer of the Asymmetric Thin-Film Membrane

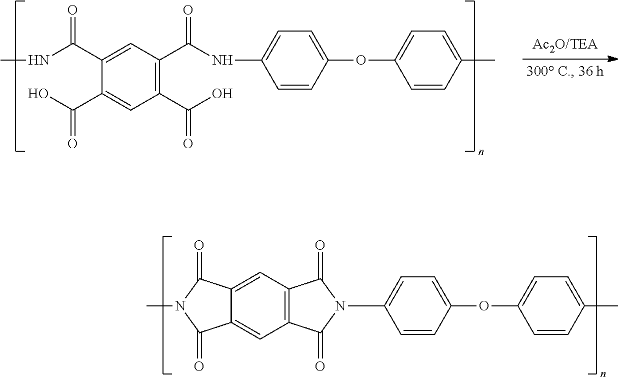

Three casting solutions are prepared by adding 0%, 6% and 24% ZnCl₂ into the 15% poly(pyromelliticdianhydride-co-4,4′-oxydianiline) amic acid solution (PAA)/NMP solution. The percentage of added ZnCl₂ is based on the polymer solution and not on the polymer itself. For example, to make a casting solution with 6% ZnCl₂, 6 g of anhydrous ZnCl₂ is added to 100 g of the 15% PAA/NMP solution. The mixture is then stirred by a mechanical stirrer until the zinc chloride is totally dissolved. After that, the solution is degassed under vacuum to remove all the bubbles. The casting solution is then cast onto a polyester fabric (Calendered PET from Crane Nonwovens) which provides mechanical support for the asymmetric membrane, and immerses immediately into a water coagulation bath at room temperature. The membrane thickness is controlled at roughly 500 nm. After 30 min, the membrane is removed from the water bath and washed thoroughly with deionized (DI) water. Then the PAA membrane is dried by an isopropanol-hexane displacement sequence: the membrane is immersed in the isopropanol for 90 min during which the isopropanol is refreshed 3 times. Subsequently, the isopropanol is replaced by hexane using the same procedure. Chemical imidization is performed by immersing the PAA membranes into a mixture of acetic anhydride (Ac₂O) and triethylamine (TEA) (4:1 by volume) at 100° C. for 36 h. The resultant polyimide membranes are then washed using isopropanol several times and used in the preparation of an asymmetric thin-film composite membrane.

### Example 6. Exemplary Procedure for Casting the Active Layers

Once pre-polymer solutions are prepared, they will be cast onto glass plates or aluminum sheets. Bird-type applicators (Gardco, Inc.) with constant wet-film heights will be used to draw down solutions to produce dry films with specific film heights. For polyimides and polybenzimidazolones, the DMAC solvent will be first removed at low temperature to produce a prepolymer gel-like film. The temperature will then be increased to drive the imidization and cyclization reactions in an oven, following common literature procedures. For polyaniline active layers, the wet-films will be baked at 120° C. overnight to produce thin, dry films.

### Example 7. Exemplary Procedure for Dry Active Layer Film Characterization

Once all films are dried, they will be directly chemically characterized with attenuated total reflectance IR (JASCO ATR-IR 6600) to monitor the degree of imidization/cyclization. Additional chemical analysis will also be conducted with a Kratos X-ray photoelectron spectrometer. Dry film thickness will be investigated with profilometry and film morphology/topography will be observed with scanning electron microscopy (JEOL JSM-6701F) and atomic force microscopy (Bruker Dimension Scanning Probe). Although the polymer film active layers are mostly amorphous, crystallinity and chain packing can be estimated with wide-angle X-ray diffraction (Bruker D8 Discover). All of these instruments are accessible on UCLA's campus within the Molecular Instrumentation Center which is run by the Department of Chemistry and Biochemistry.

### Example 8. Exemplary Optimization of the Epoxy Support Layer

Several commercial diglycidyl ethers based epoxy resins will be screened as the support layer to determine chemical and mechanical robustness, compaction resistance, and compatibility with the T-FLO system. Additionally, a variety of hardeners will be used to determine their effect on the physical properties of the thin film membranes. Fabricating support layers without active layers will be performed using the following procedure.

Into a vessel 139 parts by weight of a bisphenol-A type epoxy resin (EPICOAT 828, manufactured by Japan Epoxy Resin Co., Ltd.), 93.2 parts by weight of a bisphenol-A type epoxy resin (EPICOAT 1010, manufactured by Japan Epoxy Resin Co., Ltd.), 52 parts by weight of bis(4-amino-cyclohexyl)methane and 500 parts by weight of 1:1 mixture of polyethylene glycol 200 and polyethylene glycol 400 are charged and the mixture is stirred at 400 μm for 15 minutes using a three-one motor to obtain an epoxy resin composition.

The resulted mixture is degassed under vacuum for 30 minutes to remove bubbles that are found to cause defects. The resulting resin is poured in between two clean glass plates, one glass plate coated with a releasing agent. The glass plates are spaced by electrical tape that determines the membrane film thickness. The glass plate-resin sandwich structure is then placed on a hot plate and heated for 200 minutes at 120° C. to cure the resin. Upon completion and cooling, the glass plates are separated and the film is placed in a clean DI water bath overnight to remove the porogen. The support layers are stored in a clean water bath to keep them wet before testing.

### Example 9. Exemplary Characterization of the Epoxy Support Layer

The dry epoxy support layer films will be characterized with ATR-IR and differential scanning calorimetry (Perkin Elmer) to determine changes in chemical structure and cross-linking density. Further, SEM will be used to observe film morphology, thickness, pore size, and pore density of the ensuing membranes. Changes in hardener reactivity are anticipated to produce the most significant change in morphology and cross-linking density of the films.

### Example 10. Exemplary Preparation of the Porous Support Layer of the Asymmetric Thin-Film Membrane

A porogen is added to the uncured support layer resin to create microporous architectures during the thermal curing of the resin that acts as the support layer. A water-soluble polyethylene glycol (PEG) porogen is selected so that the final membrane can be submerged in a water bath to remove the porogen and create the final porous membrane structure. The water bath simultaneously swells the active layer, enabling defect-free delamination from the underlying substrate.

Glycidyl ether and glycidyl ester epoxy resins are mixed with 200 wt. % of PEG₂₀₀ and 200 wt. % of PEG₄₀₀. The resulted mixture is applied onto the active layer of an asymmetric thin-film composite membrane. The resulted microporous support layer is heated at 120° C. for 4 h. After cooling, the resulted asymmetric thin-film composite membrane is exposed to water at room temperature for 6 hours before isolating, washing, and storing them wet before testing.

### Example 11. Exemplary Optimization of Fabric Reinforcement

Several fabrics will be investigated to find the optimal properties for fabric-reinforcement. Low-density non-woven veil fabrics will be used to produce robust and freestanding membranes. Several non-woven veil materials (OPTIVEIL, Technical Fibre Products) will be acquired to observe fabric wetting, strength, T-FLO compatibility, and chemical stability. The fabric materials are produced from glass (20103A), carbon (20301A), polyester (20202A), polyaramid (20601A), and polyetherimide (T2570-11). Additionally, variance to membrane permeability will be observed when difference density fabrics are used.

### Example 12. Exemplary Determination of Transport Properties of New Active Layer Polymers

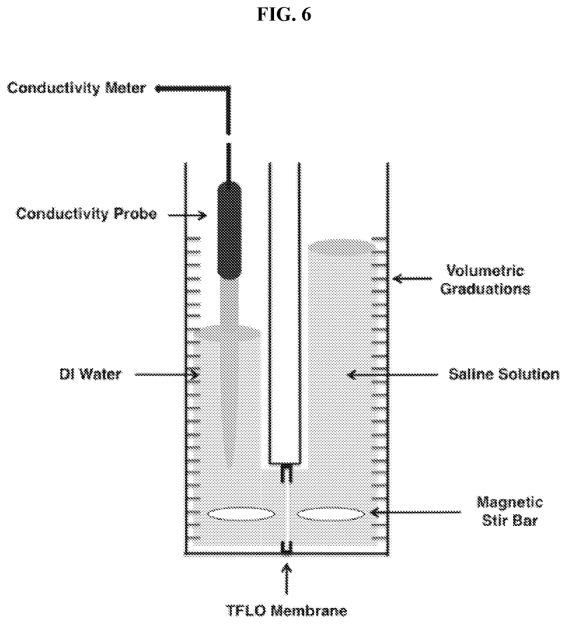

Once the active layers are formed into membranes using the T-FLO method, the Dw and Ds of the sub-micron thick active layers will be investigated. A modified U-shaped Diffusion Osmosis Apparatus (PASCO) will be used for osmosis experiments. A schematic of the apparatus is shown in FIG. 6. 13.4 cm² square membrane cutouts will be placed in between two o-ring gaskets within the cell. 150 mL of DI water will be placed in a graduated cylinder on one side of the membrane and 150 mL of a 3.5% NaCl solution will be placed in the cylinder to begin the experiment. The active layer will be facing the saline solution. The flow of water across the membrane to the saline side can be measured by observing changes in volume over time. Salt transport across the membrane will be measured using a conductivity probe, connected to a computer with logging software (Accumet), placed in the DI water solution. The apparatus will be placed on two magnetic stir plates to rotate stir bars near the membrane surface to minimize concentration polarization. The salt concentration will be back calculated from a predetermined conductivity vs. salt concentration calibration curve. From the experiment, the Dw/Ds ratio will be calculated from the equations below:

Dw=ΔMw/Am/t Ds=ΔMs/Am/t

where ΔMw is the change in final mass of the DI solution to the initial mass of the DI water solution, ΔMs is the change in the mass of salt in the final DI solution to the initial mass of salt in the initial DI water solution, Am is the effective membrane area, and t is time in seconds. The Dw/Ds ratio for several polymers will be compared as candidates for RO testing. A Dw/Ds ratio of >100 is suitable for seawater RO.

### Example 13. Exemplary Performance Testing of Membranes with Reverse Osmosis

The separation properties and permeability of the composite membranes in reverse osmosis conditions will be tested in a high-pressure stainless-steel dead end cell (Sterlitech HP4750) equipped with a stir bar. 45.6 cm² membrane samples will be cutout from the larger flat sheets and placed in the cell. The cell will be filled with DI water and the pressure will be increased from 100-800 psi until a stable flux is reached, incrementally, and the permeability will be monitored with a digital liquid flowmeter (GJC Instruments Ltd.) attached to a computer with logging software. The separation properties for RO will be observed using solutions of NaCl in the feed and the conductivity of the permeate will be measured at 800 psi with a conductivity probe (Accumet Dual Channel pH/Ion/Conductivity Meter). The salt rejection (Rs) will be calculated based on the equation:

Rs=[1−(Cp/Cf)]×100%

where Cp and Cf are the conductivity of the permeate and feed, respectively.

To accurately compare membrane permeability and rejection under identical conditions, several membrane cutouts will be tested in a multi-cell system. A lab-built six-cell cross-flow apparatus consisting of commercially available stainless steel cross-flow membrane filtration cells will be used (FIG. 7). A complete description and schematic of the apparatus is described by Hoek et al. (Hoek, E. M. V.; Kim, A. S.; Elimelech, M. Environmental Engineering Sciences 2002, 19 (6), 357-372) The channel dimensions are approximately 1 inch, 3 inch, and 1.73 mm for channel length, width, and height, respectively. Plastic mesh feed spacers will be inserted into the system to mimic operational conditions such as increased turbulence, decreased concentration polarization, and enhanced performance in spiral wound elements. Pressure controlled fluxes and feed flow rates will be consistent with industrial conditions, with a recirculation heater/chiller attached to a steel coil immersed in the feed tank to control temperature. The membranes will be continually run for multiple weeks to determine the long-term flux stability of the membranes.

### Example 14. Exemplary Reverse Osmosis Membrane Fouling Experiments and Surface Properties

Fouling testing will be performed in the six-cell cross-flow system. Several model foulants, such as bovine serum albumin, humic acid, and sodium alginate will be added to the feed solution individually and together to observe the fouling rate as a function of the flow rate over time. Inorganic scaling studies will be performed with a modified procedure outlined by Cohen and co-workers (Lin, N. H.; Kim, M.; Lewis, G. T.; Cohen, Y. J. Mater. Chem. 2010, 20, 4642) using concentrated gypsum solutions. In separate tests, half of the cells will contain commercial RO membranes and the other half will contain T-FLO membranes for a direct comparison of membrane fouling with current state-of-the-art membranes under identical conditions. To further probe membrane fouling characteristics, contact angle measurements will be performed with several probe liquids to determine the γ-values for the new active layer polymers. The electron donicity of membranes plays a large role in the repulsion of organic foulants at the polymers liquid interface. Polymers with high γ-values repel even the “stickiest” foulants such as sodium alginate and bovine serum albumin.

### Example 15. Exemplary Performance Testing of Gas Separation Membranes

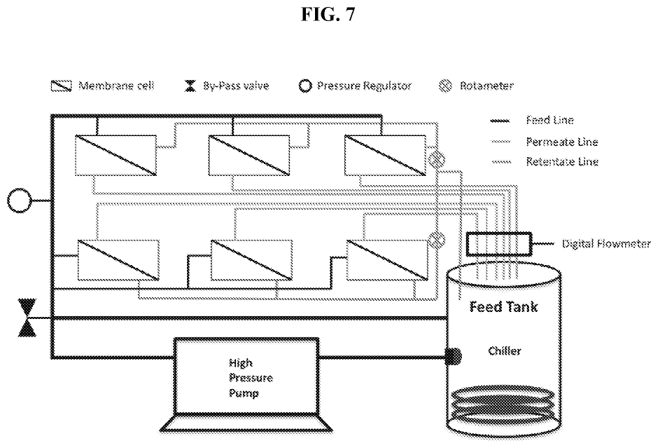

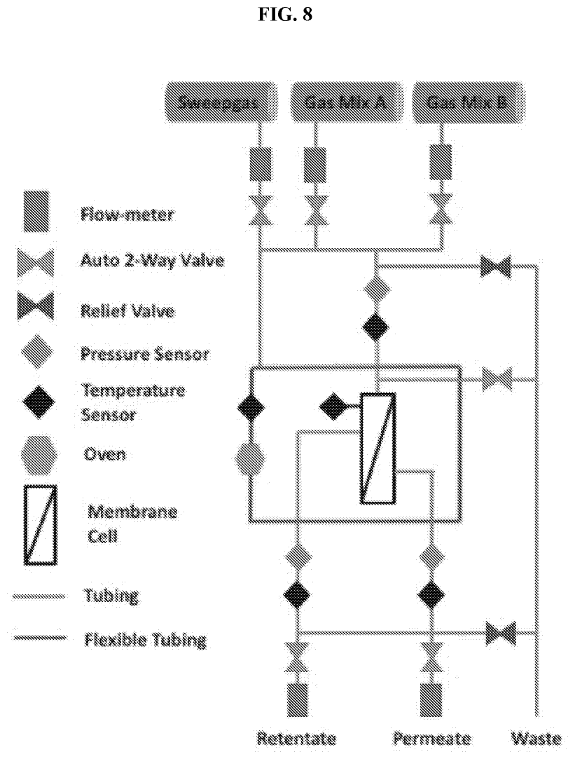

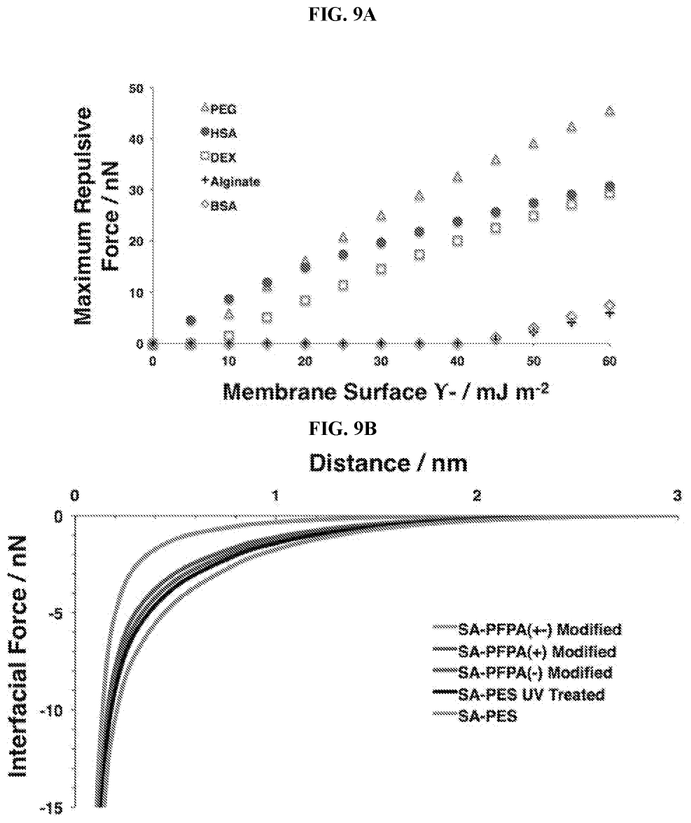

Gas separation and permeability of the polyaniline gas separation membranes will be measured with a bench-scale apparatus with an integrated GC-MS that is capable of measuring single gases or mixed gases at a variety of temperatures and pressures. Mass flowmeters will be used to independently measure the mass flow of any gas mixture. A simple diagram of the system is shown in FIG. 8. 17.35 cm² flat sheet samples will be cut out from larger flat sheets and placed into the membrane cell with the polyaniline active layer facing the feed. The membrane samples will be evacuated before use and steady-state gas permeability will be measured at a controlled temperature. Seven different gases, H₂, He, CO₂, N₂, Ar, O₂ and CH₄, will be used to measure the properties of the membrane. Membrane permeability will be correlated to active layer thickness, chain entanglement, casting wt. %, and gas kinetic diameter to determine the optimal properties for gas separation. Further, the polyaniline T-FLO membranes will be doped, dedoped, and partially re-doped with several mineral and organic acids to determine changes in permeability and selectivity for the different gases, and to find optimal permselectivity.

### Example 16. Determining the Chemical Stability of the T-FLO Composite Membranes

Membranes are constantly and thoroughly cleaned with chemicals to remove organic, inorganic, and biological foulants during operation. The T-FLO membranes will be tested against different chemicals to check the chemical stability of the new active layers and the epoxy support. Using the six-cell cross-flow system, the pH of the feed will be adjusted incrementally from 1 to 14 and the permeability and salt rejection will be monitored to determine usable pH ranges for the flat sheet membranes. To test chlorine stability, sodium hypochlorite will be added to the feed at different concentrations and the permeability and salt rejection will be monitored. Typically, chlorine tolerance is rated in ppm-hrs, that is, a specific chlorine concentration multiplied by hours of exposure.

### Example 17. Exemplary Performance of Membranes in Gas Separation Studies

The casted PANi membrane films were dried in a vacuum oven at 80° C. for 36 hours with further drying no additional mass loss was observed. Afterwards, the PANi membrane films were submerged in DI water to be separated from the substrate.

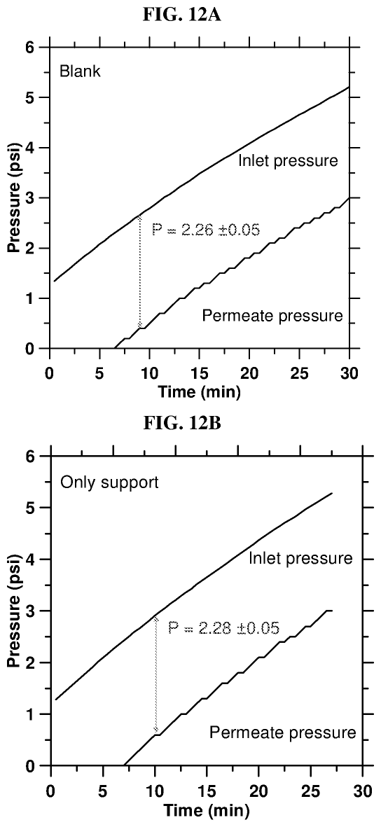

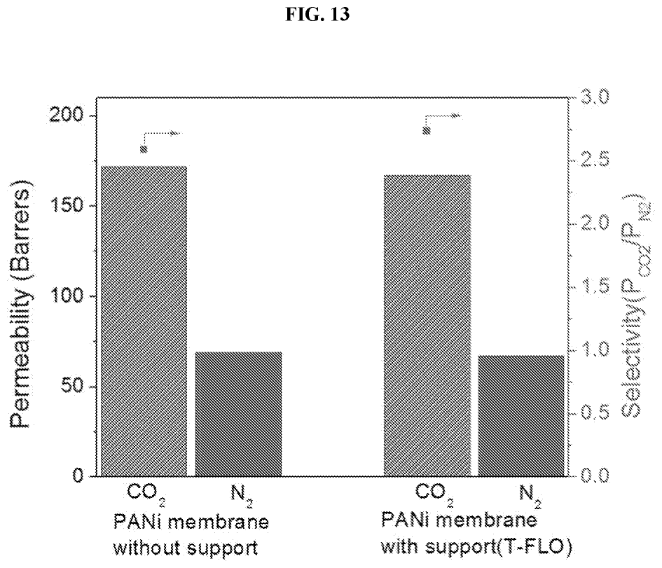

To determine if the epoxy support affects gas permeability, two different experiments were carried out without any support and membranes (Blank test), and with the support only (no active site). The pressure difference between the inlet and the permeate side was compared. As shown in FIG. 12, comparing the case with and without the epoxy support, there is almost no pressure difference depending on the presence or absence of epoxy supports. Based on the simple test, it could be deduced the provided support has a high gas permeability and negligible effect on the gas permeability measurement.

For obtaining information about gas separation performance of the PANi film and PANi support membranes, pure CO₂ and N₂ gas permeability values were determined using constant-volume/variable-pressure method. The PANi film and PANi support membrane was degassed in the membrane cell unit using a vacuum pump at room temperature. The increase in permeation pressure with time was measured using a pressure transducer. The permeability of pure CO₂ and N₂ gases was from the following:

$$P = 1 {0}^{10} \times \frac{V L}{{P}_{permeate} A R T} \times \frac{dp ( t )}{dt}$$

Wherein P is the gas permeability (Barrer) [1 Barrer=10⁻¹⁰ cm³(STP)cm/cm² s cm Hg], Pₚₑᵣₘₑₐₜₑ is the upstream pressure (cm Hg), dp/dt is the steady-state permeate-side pressure increase (cm Hg/s), V is the calibrated permeate volume (cm³), L is the membrane thickness (cm), A is the effective membrane area (cm²), T is the operating temperature (K), and R is the gas constant [0.278 cm³ cm Hg/cm³(STP) K]. The ideal selectivity (a) was determined from the ratio of permeability coefficient.

$${α}_{A / B} = \frac{{P}_{A}}{{P}_{B}} = \frac{{P}_{{CO}_{2}}}{{P}_{{N}_{2}}}$$

Wherein PA and PB refer to the permeability coefficients of pure gases CO₂ and N₂, respectively. FIG. 12 shows the comparison of the CO₂ permeance of the membranes with and without the epoxy layer. The pure CO₂ and N₂ permeance variation and ideal selectivity(CO₂/N₂) were measured at 7 psi (0.048 MPa) feed pressure. The CO₂ permeability of PANi film membrane (without epoxy layer) is slightly higher than the PANi support membrane produced. However, the difference in CO₂ and N₂ permeance was insignificant, which indicated that CO₂ and N₂ permeance were not affected by epoxy layer. This can be explained by the fact that the produced epoxy layer had a larger pore size, which could not reduce the penetration of the gases. When the pore size of support decreases enough to affect gas transport in the membrane, it follows both surface diffusion and molecular sieving mechanisms. No obvious effect of the epoxy support layer on the CO₂/N₂ selectivity was observed from this study.

### Example 18. Exemplary Performance of Membranes in Chlorinated Systems

Pressure-driven reverse osmosis has emerged as the leading technology for desalination of seawater and brackish water for its continuous operation, small footprint, and low-energy cost compared to other desalination technologies. Despite their superior performance, polymeric membrane thin films foul due to organic and biological material in the feed that adhere to the membrane surfaces. These biofilms restrict the passage of water through the membrane, increasing resistance and lowering production efficiency. Chlorination of feed water is a common way to prevent the formation and growth of biofilms. However, state-of-the-art thin-film composite membranes are highly susceptible to degradation with even trace amounts of chlorine present in the feed solution. The amide bonds that make up the backbone of the active layer polymer rapidly hydrolyze and deteriorate the initial high salt rejection of the polyamide membrane. Treatment plants must remove virtually all sodium hypochlorite from the feed water before exposure to the RO membranes, enabling fouling to occur and creating additional steps that increase the cost of desalination.

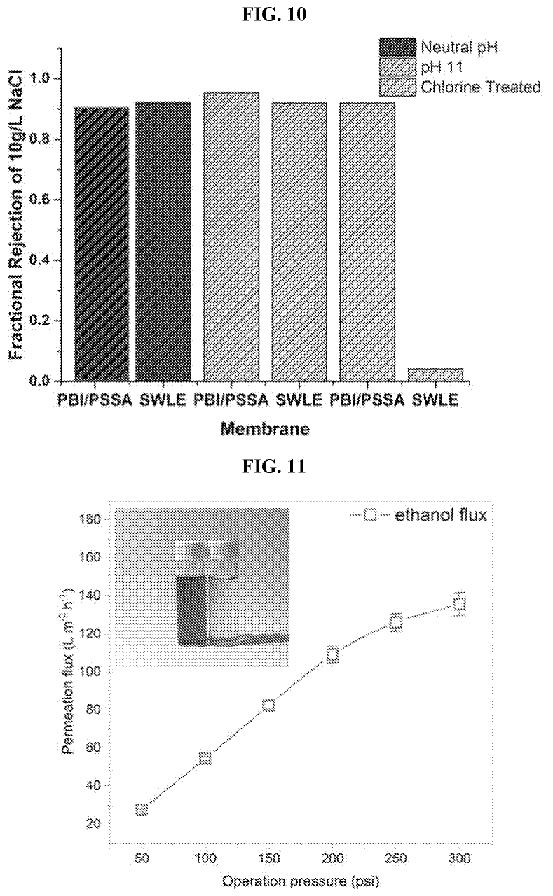

With T-FLO, we can judiciously select polymers used for the active layer that are tolerant to harsh chemical treatments such as chlorine. As demonstrated in FIG. 10, a T-FLO containing a blended polybenzimidazole/polystyrene sulfonate polymer active layer maintained its high salt rejection when exposed to sodium hypochlorite because the polymers used for the active layer have great oxidative stability. The commercial Dow SWLE membrane's salt rejection quickly degraded because the polyamide active layer is known to degrade rapidly when exposed to even trace amounts of sodium hypochlorite.

### Example 19. Exemplary Performance of Membranes for Organic Solvent Nanofiltration

Organic solvent nanofiltration (OSN) provides a complementary technique or alternative to traditional solvent purification techniques (i.e. distillation, chromatography, extraction). With OSN, desirable solutes can be readily concentrated or waste products can be rejected to purify solvents by passing them through a membrane. Current membranes for OSN are made from traditional membrane fabrication techniques that limit the selection of polymers for the membrane active layers. Additionally, harsh acids, bases, and solvents destroy or swell the membranes, shortening membrane lifespan.

Because epoxy-based polymers have good chemical stability, T-FLO membranes can be tuned for OSN applications. We demonstrate this feasibility by fabricating T-FLO membrane composites and selecting polybenzimidazole (PBI) as the active layer material. PBI is well known for its chemical stability, stiffness and toughness at elevated temperatures. Furthermore, Valtcheva et al. demonstrate that PBI membranes formed using phase-inversion exhibit great OSN capability and low degradation under extreme conditions. However, non-solvent induced phase-inversion offers little control over active layer thickness. Using T-FLO, casted PBI thin-films are readily lifted of as an active layer through the bonding between the epoxides and the repeating imidazole functionality in the backbone of the polymer. To demonstrate the membrane OSN capabilities, a solution of ethanol containing methylene blue and a solute was pressurized through the T-FLO membrane (FIG. 11). The membrane rejected ˜90% of the dyed solute in a single pass and steady permeability could be reached up to 300 psi.

### INCORPORATION BY REFERENCE

All publications and patents mentioned herein are hereby incorporated by reference in their entirety as if each individual publication or patent was specifically and individually indicated to be incorporated by reference. In case of conflict, the present application, including any definitions herein, will control.

### EQUIVALENTS

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure. It is intended that the following claims define the scope of the disclosure and that methods and structures within the scope of these claims and their equivalents be covered thereby.

### NUMBERED EMBODIMENTS

Embodiment 1 is an asymmetric thin-film composite membrane comprising an active layer and a microporous support layer, wherein
the active layer comprises at least one polymer or at least one active agent, and the active layer has a thickness from about 10 nm to about 1,000 nm;
the microporous support layer comprises an epoxy resin; and the active layer and the microporous support layer are covalently bonded to each other.

Embodiment 2 is the membrane of embodiment 1, wherein the active layer comprises at least one polyaniline, at least one polyimide, at least one polybenzimidazolone, at least one polystyrene, at least one polyamide, at least one polybenzimidazole, at least one polybenzoxazole, or a combination thereof.

Embodiment 3 is the membrane of embodiment 1 or 2, wherein the active layer comprises at least one polyaniline.

Embodiment 4 is the membrane of any one of embodiment 2 or 3, wherein the polyaniline is emeraldine base.

Embodiment 5 is the membrane of any one of embodiments 2-4, wherein the active layer comprises at least one polyimide.

Embodiment 6 is the membrane of embodiment 5, wherein the polyimide is aromatic.

Embodiment 7 is the membrane of embodiment 6, wherein the polyimide has a structure:

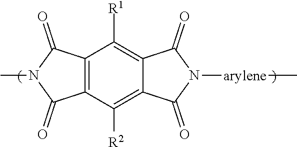

wherein,
R¹ is H, D, halogen, —CN, —OR³, —SR³, —S(═O)R³, —S(═O)₂R³, —C(═O)R³, —C(═O)OR³, —N(R³)₂ substituted or unsubstituted C₁-C₆alkyl, substituted or unsubstituted C₁-C₆fluoroalkyl, substituted or unsubstituted C₁-C₆heteroalkyl, substituted or unsubstituted C₃-C₆cycloalkyl, substituted or unsubstituted aryl, substituted or unsubstituted benzyl, or substituted or unsubstituted monocyclic heteroaryl;
R² is H, D, halogen, —CN, —OR³, —SR³, —S(═O)R³, —S(═O)₂R³, —C(═O)R³, —C(═O)OR³, —N(R³)₂ substituted or unsubstituted C₁-C₆alkyl, substituted or unsubstituted C₁-C₆fluoroalkyl, substituted or unsubstituted C₁-C₆heteroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl; and
or two R³ on the same N atom are taken together with the N atom to which they are attached to form a N-containing heterocycle.

Embodiment 8 is the membrane of embodiment 7, wherein the arylene has a structure:

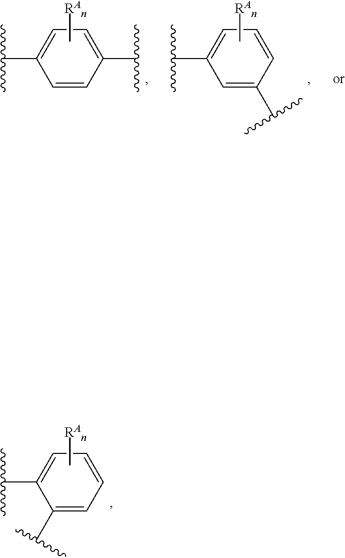

wherein each R^{A} is independently selected from H, D, halogen, —CN, —NO₂, —OR³, —SR³, —S(═O)R³, —S(═O)₂R³, —S(═O)₂N(R³)₂, —NR³S(═O)₂R³, —C(═O)R³, —OC(═O)R³, —C(═O)OR³, —OC(═O)OR³, —C(═O)N(R³)₂, and —N(R³)₂;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
n is 0, 1, 2, 3, or 4.

Embodiment 9 is the membrane of embodiment 7 or 8, wherein the arylene has a structure:

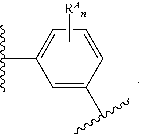

Embodiment 10 is the membrane of embodiment 9, wherein the polyimide has a structure:

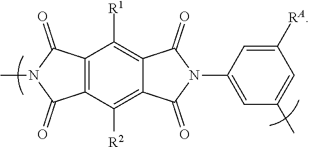

Embodiment 11 is the membrane of any one of embodiments 8-10, wherein R^{A} is H, —C(═O)OH, —C(═O)OCH₃, or —C(═O)NH₂.

Embodiment 12 is the membrane of any one of embodiments 2-11, wherein the active layer comprises at least one polybenzimidazolone.

Embodiment 13 is the membrane of embodiment 12, wherein the polybenzimidazolone has a structure selected from:

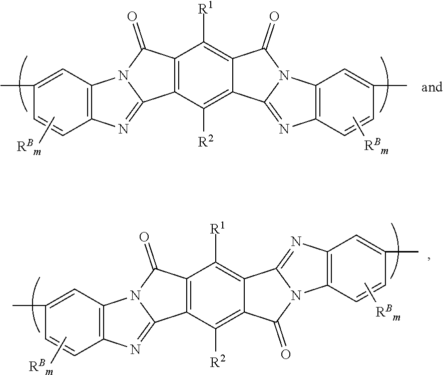

wherein each R^{B} is independently selected from H, D, halogen, —CN, —NO₂, —OR³, —SR³, —S(═O)R³, —S(═O)₂R³, —S(═O)₂N(R³)₂, —NR S(═O)₂R³, —C(═O)R³, —OC(═O)R³, —C(═O)OR³, —OC(═O)OR³, and —N(R³)₂;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
m is 0, 1, 2, or 3.

Embodiment 14 is the membrane of any one of embodiments 2-13, wherein the active layer comprises at least one polyamide.

Embodiment 15 is the membrane of embodiment 14, wherein the polyamide has a structure:

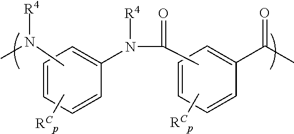

each R⁴ is independently H, D, —S(═O)R³, —S(═O)₂R³, —S(═O)₂N(R³)₂, —C(═O)R³, —C(═O)OR³, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl; or
two R^{C} are taken together to form a cross link;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

Embodiment 16 is the membrane of any one of embodiments 2-15, wherein said active layer comprises at least one polybenzimidazole.

Embodiment 17 is the membrane of embodiment 16, wherein the polybenzimidazole has a structure:

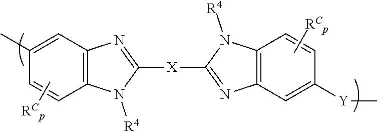

wherein,
X is absent, substituted or unsubstituted C₁-C₆alkylene, or substituted or unsubstituted arylene;
Y is absent, substituted or unsubstituted C₁-C₄alkylene, or substituted or unsubstituted arylene;
each R⁴ is independently H, D, —S(═O)R³, —S(═O)₂R³, —S(═O)₂N(R³)₂, —C(═O)R³, —C(═O)OR³, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

Embodiment 18 is the membrane of any one of embodiments 2-17, wherein the active layer comprises at least one polybenzoxazole.

Embodiment 19 is the membrane of embodiment 18, wherein the polybenzoxazole has a structure:

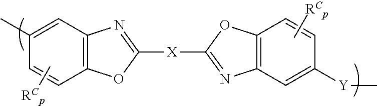

wherein,
X is absent, substituted or unsubstituted C₁-C₈alkylene, or substituted or unsubstituted arylene;
Y is absent, substituted or unsubstituted C₁-C₄alkylene, or substituted or unsubstituted arylene;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

Embodiment 20 is the membrane of any one of embodiments 2-19, wherein the active layer comprises at least one polystyrene.

Embodiment 21 is the membrane of embodiment 20, wherein the polystyrene has a structure:

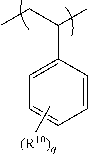

wherein
each R¹⁰ is independently alkyl, hydroxyl, nitro, halo, amino, alkoxy, or sulfonyl; and q is 1, 2, 3, 4, or 5.

Embodiment 22 is the membrane of embodiment 21, wherein R¹⁰ is sulfonyl and q is 1.

Embodiment 23 is the membrane of any one of embodiments 20-22, wherein the polystyrene has a structure:

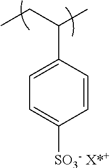

wherein X* is a positive counter ion (e.g., sodium, lithium, potassium, calcium).

Embodiment 24 is the membrane of any one of embodiments 1-23, wherein the active layer comprises one or more active agents selected from zeolites, metal-organic frameworks, nanoporous carbides, TiO₂ nanoparticles, and carbon nanotubes.

Embodiment 25 is the membrane of any one of embodiments 1-24, wherein the epoxy resin is a diglycidyl ether-based epoxy resin.

Embodiment 26 is the membrane of any one of embodiments 1-25, wherein the epoxy resin is selected from: DER 333, DER 661, EPON 828, EPON 836, EPON 1001, EPON 1007F, Epikote 826, Epikote 828, ERL-4201, ERL-4221, GT-7013, GT-7014, GT-7074, and GT-259.

Embodiment 27 is the membrane of any one of embodiments 1-26, wherein the microporous support layer further comprises a hardener.

Embodiment 28 is the membrane of embodiment 27, wherein the hardener is selected from aliphatic polyamines, polyamides, amidoamines, cycloaliphatic amines, and aromatic amines.

Embodiment 29 is the membrane of any one of embodiments 1-28, wherein the active layer and microporous support layer are covalently bonded to each other via C—O or C—N covalent bonds.

Embodiment 30 is the membrane of any one of embodiments 1-29, wherein the surface of the active layer is rough.

Embodiment 31 is the membrane of any one of embodiments 1-29, wherein the surface of the active layer is smooth.

Embodiment 32 is the membrane of any one of embodiments 1-31, wherein the membrane further comprises an agent.

Embodiment 33 is the membrane of embodiment 32, wherein the agent is an antimicrobial agent or a chemical disinfectant.

Embodiment 34 is the membrane of any one of embodiments 1-33, wherein the membrane has an improvement in at least one property selected from hydrophilicity, resistance to fouling, and reduced surface roughness as compared to an otherwise identical membrane that does not comprise a microporous support layer that comprises an epoxy resin.

Embodiment 35 is the membrane of any one of embodiments 1-34, wherein the membrane is resistant to fouling.

Embodiment 36 is the membrane of embodiment 35, wherein the fouling is biofouling.

Embodiment 37 is the membrane of embodiment 35 or 36, wherein the fouling is reduced by about 10%, about 20%, about 30%, about 40%, about 50%, about 60%, about 70%, about 80%, about 90%, about 95%, about 99% as compared to a RO membrane that does not comprise a microporous support layer that comprises an epoxy resin.

Embodiment 38 is a method of preparing the membrane of any one of embodiments 1-37, wherein the method comprises:
obtaining a substrate having a top face and a bottom face;
applying an active layer to the top face of the substrate;
exposing the active layer to a first heat source;
applying an epoxy resin to the top of the active layer; and
exposing the epoxy resin to a second heat source, thereby forming an asymmetric thin-film composite membrane.

Embodiment 39 is the method of embodiment 38, wherein the method further comprises exposing the asymmetric thin-film composite membrane to water.

Embodiment 40 is the method of embodiment 39, wherein the membrane is exposed to water for about 6 hours, about 8 hours, about 12 hours, about 18 hours, or about 24 hours.

Embodiment 41 is the method of any one of embodiments 38-40, wherein the method further comprises separating the membrane from the substrate.

Embodiment 42 is the method of any one of embodiments 38-41, wherein the top face of the substrate has a smooth surface.

Embodiment 43 is the method of any one of embodiments 38-41, wherein the top face of the substrate has a rough surface.

Embodiment 44 is the method of any one of embodiments 38-43, wherein the substrate is a non-woven fiber.

Embodiment 45 is the method of any one of embodiments 38-44, wherein the substrate comprises glass or metal (e.g., stainless steel).

Embodiment 46 is the method of any one of embodiments 38-44, wherein the substrate comprises carbon, polyester, polyaramid, polyetherimide, or a combination thereof.

Embodiment 47 is the method of any one of embodiments 38-44, wherein the fiber is a non-woven polyester fabric.

Embodiment 48 is the method of any one of embodiments 38-47, wherein the first heat source has a temperature of at least about 100° C., at least about 120° C., at least about 200° C., or at least about 300° C.

Embodiment 49 is the method of any one of embodiments 38-48, wherein the active layer is exposed to the heat source from about 1 to about 18 hours.

Embodiment 50 is the method of any one of embodiments 38-49, wherein the second heat source has a temperature of at least about 100° C., at least about 120° C., or at least about 150° C.

Embodiment 51 is the method of any one of embodiments 38-50, wherein the microporous layer is exposed to the heat source for about 1 to about 6 hours.

Embodiment 52 is the method of any one of embodiments 38-51, wherein the microporous layer is exposed to the heat source for about 3 hours.

Embodiment 53 is the method of any one of embodiments 38-52, wherein the epoxy resin further comprises one or more porogens.

Embodiment 54 is the method of embodiment 53, wherein the porogen comprises a hydrophilic polymer, a hydrophobic polymer, or a mixture thereof.

Embodiment 55 is the method of embodiment 54, wherein the hydrophilic polymer comprises at least one moiety selected from poly(ethylene glycol) (PEG), poly(ethyleneimine), polyaniline, or a mixture thereof.

Embodiment 56 is the method of embodiment 53 or 54, wherein the porogen comprises a mixture of PEG200 and PEG400.

Embodiment 57 is the method of embodiment 56, wherein a ratio of PEG200 to PEG400 is from about 1:5 to about 5:1.

Embodiment 58 is the method of embodiment 56, wherein the ratio of PEG200 to PEG400 is from about 1 to about 1.

Embodiment 59 is the method of any one of embodiments 38-58, wherein the active layer is applied to the top face of the substrate with a casting blade set to a desired height.

Embodiment 60 is a method comprising passing a liquid composition through a membrane of any one of embodiments 1-37, wherein the liquid composition comprises a solute and a solvent; and the membrane is substantially impermeable to the solute.

Embodiment 61 is the method of embodiment 60, wherein the liquid composition is salt water.

Embodiment 62 is the method of embodiment 60, wherein the liquid composition is brackish water.

Embodiment 63 is the method of embodiment 60, wherein the liquid composition is an organic solvent.

Embodiment 64 is the method of any one of embodiments 60-63, wherein the solute is a dye, a small molecule, a polymer, or an oligomer.

Embodiment 65 is the method of any one of embodiments 60-64, wherein the solute is a pathogen or a toxin.

Embodiment 66 is the method of any one of embodiments 60-65, wherein the liquid composition is passed through the membrane continuously.

Embodiment 67 is the method of any one of embodiments 60-66, wherein the liquid composition comprises at least one fouling agent.

Embodiment 68 is the method of embodiment 67, wherein the fouling agent is a bacterium, a fungus, or an organism.

Embodiment 69 is the method of embodiment 67 or 68, wherein the fouling agent is a gram negative bacterium, a gram positive bacterium, or a marine bacterium.

Embodiment 70 is the method of embodiment 68 or 69, wherein the bacterium is selected from Actinomyces, Arthrobacter, Bacillus, Clostridium, Corynebacterium, Enterococcus, Lactococcus, Listeria, Micrococcus, Mycobacterium, Staphylococcus, Streptococcus, Actinomyces spp., Arthrobacter spp., Bacillus licheniformis, Clostridium difficile, Clostridium spp., Corynebacterium spp., Enterococcus faecalis, Lactococcus spp., Listeria monocytogenes, Micrococcus spp., Mycobacterium spp., Staphylococcus aureus, Staphylococcus epidermidis, Streptococcus pneumoniae, Streptococcus pyogenes, Alteromonas, Aeromonas, Desulfovibrio, Escherichia, Fusobacterium, Geobacter, Haemophilus, Klebsiella, Legionella, Porphyromonas, Proteus, Pseudomonas, Serratia, Shigella, Salmonella, Vibrio, Alteromonas spp., Aeromonas spp., Desulfovibrio spp., Escherichia coli, Fusobacterium nucleatum, Geobacter spp., Haemophilus spp., Klebsiella spp., Legionella pneumophila, Porphyromonas spp., Pseudomonas aeruginosa, Proteus vulgaris, Proteus mirabilis, Proteus penneri, Serratia spp., Shigella dysenteriae, Shigella flexneri, Shigella boydii, Shigella sonnei, Salmonella bongori, Salmonella enterica, Vibrio Cholerae, Pseudoalteromonas spp. and Shewanella spp.

Embodiment 71 is the method of embodiment 67 or 68, wherein the fouling agent is a fungus selected from Candida albicans, Candida glabrata, Candida rugose, Candida parapsilosis, Candida tropicalis, Candida dubliniensis, and Hormoconis resinae.

Embodiment 72 is the method of embodiment 68 or 69, wherein the organism is a calcareous organism or non-calcareous organism.

Embodiment 73 is the method of embodiment 72, wherein the calcareous organism is a barnacle, bryozoan, mollusk, polychaete, tube worm, or zebra mussel.

Embodiment 74 is the method of embodiment 72, wherein the non-calcareous organism is seaweed, hydroids, or algae.

Embodiment 75 is the method of any one of embodiments 60-74, wherein the liquid composition further comprises chlorine.

Embodiment 76 is the method of embodiment 75, wherein the chlorine does not degrade the membrane.

Embodiment 77 is a method comprising passing a gas composition through a membrane of any one of embodiments 1-37, wherein the gas composition comprises at least two gasses; and the membrane is substantially impermeable to at least one of the gasses.

Embodiment 78 is the method of embodiment 7, wherein at least one gas is selected from nitrogen, carbon dioxide, oxygen, argon, neon, methane, carbon monoxide, chlorine, fluorine, nitrogen dioxide, hydrogen, helium, hydrogen sulfide, hydrogen cyanide, formaldehyde, phosgene, phosphine, and bromine.

Embodiment 79 is an asymmetric thin-film composite membrane comprising:
(a) an active layer; and
(b) a microporous support layer,
wherein said active layer has thickness from about 10 nm to about 1000 nm, and
wherein said active layer and said microporous support layer are bonded to each other covalently.

Embodiment 80 is the membrane of embodiment 79, wherein said active layer comprises at least one polyaniline.

Embodiment 81 is the membrane of embodiment 80, wherein the polyaniline is emeraldine base:

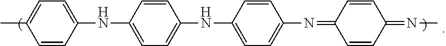

Embodiment 82 is the membrane of embodiment 79, wherein said active layer comprises at least one polyimide.

Embodiment 83 is the membrane of embodiment 82, wherein said polyimide is aromatic.

Embodiment 84 is the membrane of embodiment 83, wherein the aromatic polyimide has the structure of:

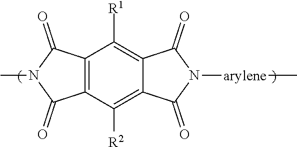

wherein,
R¹ is H, D, halogen, —CN, —OR³, —SR³, —S(═O)R³, —S(═O)₂R³, —C(═O)R³, —C(═O)OR³, —N(R³)₂ substituted or unsubstituted C₁-C₆alkyl, substituted or unsubstituted C₁-C₆fluoroalkyl, substituted or unsubstituted C₁-C₆heteroalkyl, substituted or unsubstituted C₃-C₆cycloalkyl, substituted or unsubstituted aryl, substituted or unsubstituted benzyl, or substituted or unsubstituted monocyclic heteroaryl;
R² is H, D, halogen, —CN, —OR³, —SR³, —S(═O)R³, —S(═O)₂R³, —C(═O)R³, —C(═O)OR³, —N(R³)₂ substituted or unsubstituted C₁-C₆alkyl, substituted or unsubstituted C₁-C₆fluoroalkyl, substituted or unsubstituted C₁-C₆heteroalkyl, substituted or unsubstituted C₃-C₆cycloalkyl, substituted or unsubstituted aryl, substituted or unsubstituted benzyl, or substituted or unsubstituted monocyclic heteroaryl; and
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle.

Embodiment 85 is the membrane of embodiment 84, wherein the arylene group of aromatic polyimide is:

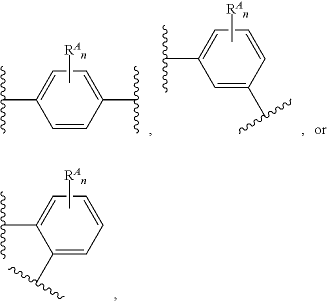

wherein each R^{A} is independently selected from H, D, halogen, —CN, —NO₂, —OR³, —SR³, —S(═O)R³, —S(═O)₂R³, —S(═O)₂N(R³)₂, —NR³S(═O)₂R³, —C(═O)R³, —OC(═O)R³, —C(═O)OR³, —OC(═O)OR³, —C(═O)N(R³)₂, and —N(R³)₂;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
n is 0, 1, 2, 3, or 4.

Embodiment 86 is the membrane of embodiment 85, wherein the arylene group of aromatic polyimide is:

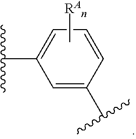

Embodiment 87 is the membrane of embodiment 83, wherein the aromatic polyimide has the structure of:

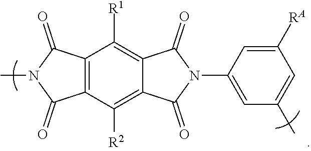

Embodiment 88 is the membrane of embodiment 87, wherein R^{A} is H, —C(═O)OH, —C(═O)OCH₃, or —C(═O)NH₂.

Embodiment 89 is the membrane of embodiment 79, wherein said active layer comprises at least one polybenzimidazolone.

Embodiment 90 is the membrane of embodiment 89, wherein said polybenzimidazolone has one or more structures selected from:

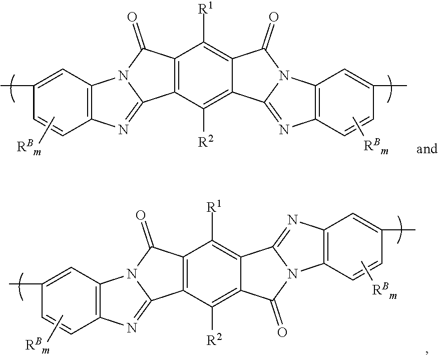

wherein each R^{B} is independently selected from H, D, halogen, —CN, —NO₂, —OR³, —SR³, —S(═O)R³, —S(═O)₂R³, —S(═O)₂N(R³)₂, —NR³S(═O)₂R³, —C(═O)R³, —OC(═O)R³, —C(═O)OR³, —OC(═O)OR³, and —N(R³)₂;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
m is 0, 1, 2, or 3.

Embodiment 91 is the membrane of embodiment 79, wherein said active layer comprises at least one polyamide.

Embodiment 92 is the membrane of embodiment 91, wherein the polyamide has the structure of:

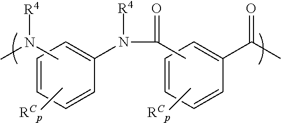

each R⁴ is independently H, D, —S(═O)R³, —S(═O)₂R³, —S(═O)₂N(R³)₂, —C(═O)R³, —C(═O)OR³, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl; or
two R^{C} are taken together to form a cross link;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

Embodiment 93 is the membrane of embodiment 79, wherein said active layer comprises at least one polybenzimidazole.

Embodiment 94 is the membrane of embodiment 93, wherein the polybenzimidazole has the structure of:

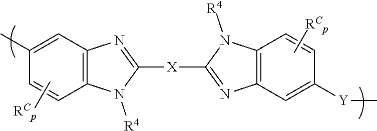

wherein,
X is absent, substituted or unsubstituted C₁-C₆alkylene, or substituted or unsubstituted arylene;
Y is absent, substituted or unsubstituted C₁-C₄alkylene, or substituted or unsubstituted arylene;
each R⁴ is independently H, D, —S(═O)R³, —S(═O)₂R³, —S(═O)₂N(R³)₂, —C(═O)R³, —C(═O)OR³, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

Embodiment 95 is the membrane of embodiment 79, wherein said active layer comprises at least one polybenzoxazole.

Embodiment 96 is the membrane of embodiment 95, wherein the polybenzoxazole has the structure of:

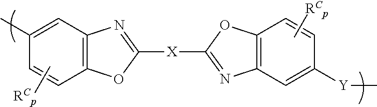

wherein,
X is absent, substituted or unsubstituted C₁-C₈alkylene, or substituted or unsubstituted arylene;
Y is absent, substituted or unsubstituted C₁-C₄alkylene, or substituted or unsubstituted arylene;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

Embodiment 97 is the membrane of any one of embodiments 79-96, wherein said active layer comprises one or more materials selected from the group consisting of zeolites, metal-organic frameworks, nanoporous carbides, TiO₂ nanoparticles, and carbon nanotubes.

Embodiment 98 is the membrane of any one of embodiments 79-97, wherein said microporous support layer comprises at least one polymer-based epoxy resin.

Embodiment 99 is the membrane of embodiment 98, wherein said polymer-based epoxy resin is diglycidyl ether-based epoxy resin.

Embodiment 100 is the membrane of embodiment 99, wherein said polymer-based epoxy resin is selected from the group consisting of: DER 333, DER 661, EPON 828, EPON 836, EPON 1001, EPON 1007F, Epikote 826, Epikote 828, ERL-4201, ERL-4221, GT-7013, GT-7014, GT-7074, and GT-259.

Embodiment 101 is the membrane of any one of embodiments 79-100, wherein said microporous support layer additionally comprises a hardener.

Embodiment 102 is the membrane of embodiment 101, wherein said hardener is selected from aliphatic polyamines, polyamides, amidoamines, cycloaliphatic amines, and aromatic amines.

Embodiment 103 is the membrane of embodiment 102, wherein said hardener is a diamine hardener.

Embodiment 104 is the membrane of any one of embodiments 79-103, wherein said active layer and said microporous support layer are bonded to each other via C—O or C—N covalent bonds.

Embodiment 105 is the membrane of any one of embodiments 79-104, wherein said membrane continuously separates gases from a mixture.

Embodiment 106 is the membrane of any one of embodiments 79-104, wherein said membrane is a reverse osmosis membrane.

Embodiment 107 is the membrane of any one of embodiments 79-106, wherein said membrane is stable when contacted by a chemical, an organic solvent, or a combination thereof.

Embodiment 108 is the membrane of embodiment 107, wherein said chemical is an oxidant or an acid.

Embodiment 109 is the membrane of embodiment 107, wherein the oxidant is sodium hypochlorite.

Embodiment 110 is the membrane of any one of embodiments 79-109, wherein the membrane demonstrates an improvement in at least one property selected from hydrophilicity, resistance to fouling, and reduced surface roughness.

Embodiment 111 is the membrane of any one of embodiments 79-1110, wherein said membrane has reduced surface roughness.

Embodiment 112 is the membrane of any one of embodiments 79-111, wherein said membrane is resistant to fouling.

Embodiment 113 is the membrane of embodiment 112, wherein said membrane prevents and/or reduces biofouling.

Embodiment 114 is the membrane of embodiment 112, wherein biofouling comprises microfouling or macrofouling.

Embodiment 115 is the membrane of embodiment 112, wherein microfouling comprises biofilm and bacterial adhesion.

Embodiment 116 is the membrane of embodiment 114 or 115, wherein microfouling is formed by a bacterium or a fungus.

Embodiment 117 is the membrane of any one of embodiments 114-116, wherein microfouling is formed by a gram-positive bacterium.

Embodiment 118 is the membrane of embodiment 117, wherein the gram-positive bacterium comprises a bacterium from the genus Actinomyces, Arthrobacter, Bacillus, Clostridium, Corynebacterium, Enterococcus, Lactococcus, Listeria, Micrococcus, Mycobacterium, Staphylococcus, or Streptococcus.

Embodiment 119 is the membrane of embodiment 117 or 118, wherein the gram-positive bacterium comprises Actinomyces spp., Arthrobacter spp., Bacillus licheniformis, Clostridium difficile, Clostridium spp., Corynebacterium spp., Enterococcus faecalis, Lactococcus spp., Listeria monocytogenes, Micrococcus spp., Mycobacterium spp., Staphylococcus aureus, Staphylococcus epidermidis, Streptococcus pneumoniae, or Streptococcus pyogenes.

Embodiment 120 is the membrane of any one of embodiments 114-116, wherein microfouling is formed by a gram-negative bacterium.

Embodiment 121 is the membrane of embodiment 120, wherein the gram-negative bacterium comprises a bacterium from the genus Alteromonas, Aeromonas, Desulfovibrio, Escherichia, Fusobacterium, Geobacter, Haemophilus, Klebsiella, Legionella, Porphyromonas, Proteus, Pseudomonas, Serratia, Shigella, Salmonella, or Vibrio.

Embodiment 122 is the membrane of embodiment 120 or 121, wherein the gram-negative bacterium comprises Alteromonas spp., Aeromonas spp., Desulfovibrio spp., Escherichia coli, Fusobacterium nucleatum, Geobacter spp., Haemophilus spp., Klebsiella spp., Legionella pneumophila, Porphyromonas spp., Pseudomonas aeruginosa, Proteus vulgaris, Proteus mirabilis, Proteus penneri, Serratia spp., Shigella dysenteriae, Shigella flexneri, Shigella boydii, Shigella sonnei, Salmonella bongori, Salmonella enterica, or Vibrio Cholerae.

Embodiment 123 is the membrane of any one of embodiments 116-122 wherein the bacterium is a marine bacterium.

Embodiment 124 is the membrane of embodiment 123, wherein the marine bacterium comprises Pseudoalteromonas spp. or Shewanella spp.

Embodiment 125 is the membrane of any one of embodiments 114-116, wherein microfouling is formed by a fungus.

Embodiment 126 is the membrane of embodiment 125, wherein the fungus comprises Candida albicans, Candida glabrata, Candida rugose, Candida parapsilosis, Candida tropicalis, Candida dubliniensis, or Hormoconis resinae.

Embodiment 127 is the membrane of embodiment 114, wherein macrofouling comprises calcareous fouling organism or non-calcareous fouling organism.

Embodiment 128 is the membrane of embodiment 127, wherein calcareous fouling organism comprises barnacle, bryozoan, mollusk, polychaete, tube worm, or zebra mussel.

Embodiment 129 is the membrane of embodiment 127, wherein non-calcareous fouling organism comprises seaweed, hydroids, or algae.

Embodiment 130 is the membrane of any one of embodiments 79-129, wherein the membrane reduces the formation of biofouling by about 10%, 20%, 30%, 40%, 50%, 60%, 70%, 80%, 90%, 95%, 99%, or more relative to a commercial RO membrane.

Embodiment 131 is the membrane of any one of embodiments 79-130, wherein the membrane is further coated with an additional agent.

Embodiment 132 is the membrane of embodiment 131, wherein the additional agent is an antimicrobial agent.

Embodiment 133 is the membrane of embodiment 131, wherein the additional agent is a chemical disinfectant.

Embodiment 134 is a process of making an asymmetric thin-film composite membrane comprising:
(a) providing a substrate having a top surface and a bottom surface;
(b) applying an active layer to the top surface of the substrate;
(c) exposing the active layer to a first heat source;
(d) applying epoxy resin microporous support layer on top of the thermally exposed active layer;
(e) exposing the microporous support layer to a second heat source to form an asymmetric thin-film composite membrane; wherein said active layer and said microporous support layer are bonding to each other covalently;
(f) exposing the asymmetric thin-film composite membrane to water; and
(g) optionally separating the membrane from the substrate.

Embodiment 135 is the process of embodiment 134, wherein said membrane is a reverse osmosis membrane.

Embodiment 136 is the process of embodiment 134, wherein said substrate has a smooth top surface.

Embodiment 137 is the process of embodiment 134, wherein said substrate is inorganic substrate.

Embodiment 138 is the process of embodiment 134, wherein said inorganic substrate is glass or metal.

Embodiment 139 is the process of embodiment 134, wherein said substrate is a non-woven fiber material.

Embodiment 140 is the process of embodiment 134, wherein said non-woven fiber material is produced from glass, carbon, polyester, polyaramid, polyetherimide, or a combination thereof.

Embodiment 141 is the process of embodiment 134, wherein said substrate is a non-woven polyester fabric.

Embodiment 142 is the process of any one of embodiments 134-141, wherein said active layer comprises at least one polyaniline.

Embodiment 143 is the process of embodiment 142, wherein the polyaniline is emeraldine base:

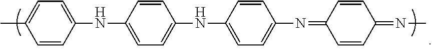

Embodiment 144 is the process of any one of embodiments 134-141, wherein said active layer comprises at least one polyimide.

Embodiment 145 is the process of embodiment 144, wherein said polyimide is aromatic.

Embodiment 146 is the process of embodiment 145, wherein the aromatic polyimide has the structure of:

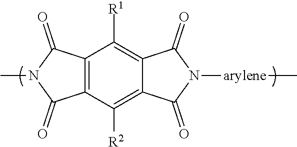

wherein,
R¹ is H, D, halogen, —CN, —OR³, —SR³, —S(═O)R³, —S(═O)₂R³, —C(═O)R³, —C(═O)OR³, —N(R³)₂ substituted or unsubstituted C₁-C₆alkyl, substituted or unsubstituted C₁-C₆fluoroalkyl, substituted or unsubstituted C₁-C₆heteroalkyl, substituted or unsubstituted C₃-C₆cycloalkyl, substituted or unsubstituted aryl, substituted or unsubstituted benzyl, or substituted or unsubstituted monocyclic heteroaryl; and
R² is H, D, halogen, —CN, —OR³, —SR³, —S(═O)R³, —S(═O)₂R³, —C(═O)R³, —C(═O)OR³, —N(R³)₂ substituted or unsubstituted C₁-C₆alkyl, substituted or unsubstituted C₁-C₆fluoroalkyl, substituted or unsubstituted C₁-C₆heteroalkyl, substituted or unsubstituted C₃-C₆cycloalkyl, substituted or unsubstituted aryl, substituted or unsubstituted benzyl, or substituted or unsubstituted monocyclic heteroaryl; and
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle.

Embodiment 147 is the process of embodiment 146, wherein the arylene group of aromatic polyimide is:

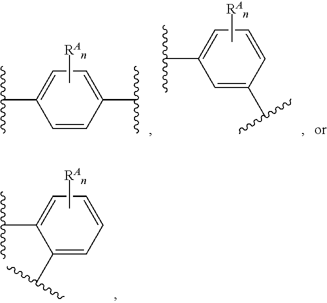

wherein each R^{A} is independently selected from H, D, halogen, —CN, —NO₂, —OR³, —SR³, —S(═O)R³, —S(═O)₂R³, —S(═O)₂N(R³)₂, —NR³S(═O)₂R³, —C(═O)R³, —OC(═O)R³, —C(═O)OR³, —OC(═O)OR³, —C(═O)N(R³)₂, and —N(R³)₂;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
n is 0, 1, 2, 3, or 4.

Embodiment 148 is the process of embodiment 147, wherein the arylene group of aromatic polyimide is:

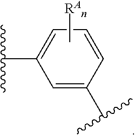

Embodiment 149 is the process of embodiment 146, wherein the aromatic polyimide has the structure of:

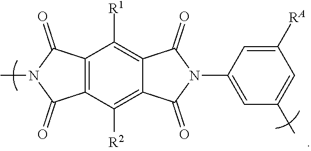

Embodiment 150 is the process of embodiment 149, wherein RA is H, —C(═O)OH, —C(═O)OCH₃, or —C(═O)NH₂.

Embodiment 151 is the process of any one of embodiments 134-141, wherein said active layer comprises at least one polybenzimidazolone.

Embodiment 152 is the process of embodiment 151, wherein said polybenzimidazolone has one or more structures selected from:

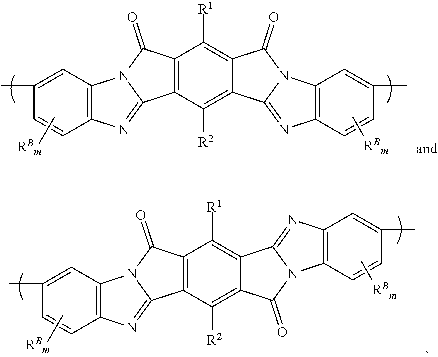

wherein each R^{B} is independently selected from H, D, halogen, —CN, —NO₂, —OR³, —SR³, —S(═O)R³, —S(═O)₂R³, —S(═O)₂N(R³)₂, —NR³S(═O)₂R³, —C(═O)R³, —OC(═O)R³, —C(═O)OR³, —OC(═O)OR³, and —N(R³)₂;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
m is 0, 1, 2, or 3.

Embodiment 153 is the process of embodiment 152, wherein said active layer comprises at least one polyamide.

Embodiment 154 is the process of embodiment 153, wherein the polyamide has the structure of:

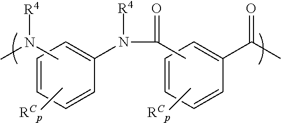

each R⁴ is independently H, D, —S(═O)R³, —S(═O)₂R³, —S(═O)₂N(R³)₂, —C(═O)R³, —C(═O)OR³, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl; or
two R^{C} are taken together to form a cross link;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

Embodiment 155 is the process of embodiment 134, wherein said active layer comprises at least one polybenzimidazole.

Embodiment 156 is the process of embodiment 155, wherein the polybenzimidazole has the structure of:

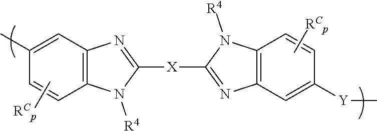

wherein,
X is absent, substituted or unsubstituted C₁-C₆alkylene, or substituted or unsubstituted arylene;
Y is absent, substituted or unsubstituted C₁-C₄alkylene, or substituted or unsubstituted arylene;
each R⁴ is independently H, D, —S(═O)R³, —S(═O)₂R³, —S(═O)₂N(R³)₂, —C(═O)R³, —C(═O)OR³, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

Embodiment 157 is the process of embodiment 134, wherein said active layer comprises at least one polybenzoxazole.

Embodiment 158 is the process of embodiment 157, wherein the polybenzoxazole has the structure of:

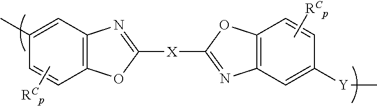

wherein,
X is absent, substituted or unsubstituted C₁-C₈alkylene, or substituted or unsubstituted arylene;
Y is absent, substituted or unsubstituted C₁-C₄alkylene, or substituted or unsubstituted arylene;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

Embodiment 159 is the process of any one of embodiments 134-141, wherein said active layer comprises one or more materials selected from the group consisting of zeolites, metal-organic frameworks, nanoporous carbides, TiO₂ nanoparticles, and carbon nanotubes.

Embodiment 160 is the process of any one of embodiments 134-159, wherein the active layer is exposed to the heat source that has a temperature of at least about 100° C.

Embodiment 161 is the process of embodiment 160, wherein the heat source has the temperature of at least about 120° C.

Embodiment 162 is the process of embodiment 160, wherein the heat source has the temperature of at least about 200° C.

Embodiment 163 is the process of embodiment 160, wherein the heat source has the temperature of at least about 300° C.

Embodiment 164 is the process of any one of embodiments 134-163, wherein the active layer is exposed to the heat source from about 1 to about 18 hours.

Embodiment 165 is the process of any one of embodiments 134-164, wherein said microporous support layer comprises at least one polymer-based epoxy resin.

Embodiment 166 is the process of any one of embodiments 165, wherein said polymer-based epoxy resin is diglycidyl ether-based epoxy resin.

Embodiment 167 is the process of any one of embodiments 166, wherein said polymer-based epoxy resin is selected from the group consisting of: DER 333, DER 661, EPON 828, EPON 836, EPON 1001, EPON 1007F, Epikote 826, Epikote 828, ERL-4201, ERL-4221, GT-7013, GT-7014, GT-7074, and GT-259.

Embodiment 168 is the process of any one of embodiments 134-167, wherein said microporous support layer additionally comprises a hardener.

Embodiment 169 is the process of embodiment 168, wherein said hardener is selected from aliphatic polyamines, polyamides, amidoamines, cycloaliphatic amines, and aromatic amines.

Embodiment 170 is the process of embodiment 168, wherein said hardener is a diamine hardener.

Embodiment 171 is the process of any one of embodiments 164-170, wherein the epoxy resin microporous support layer comprises one or more porogens.

Embodiment 172 is the process of embodiment 171, wherein said porogen comprises a hydrophilic polymer, hydrophobic polymer, or a mixture thereof.

Embodiment 173 is the process of embodiment 172, wherein said hydrophilic polymer comprises at least one moiety selected from poly(ethylene glycol) (PEG), poly(ethyleneimine) and polyaniline, or a mixture thereof.

Embodiment 174 is the process of embodiment 173, wherein the porogen comprises a mixture of PEG200 and PEG400.

Embodiment 175 is the process of embodiment 174, wherein a ratio of PEG200 to PEG400 is from about 1:5 to about 5:1.

Embodiment 176 is the process of embodiment 174, wherein the ratio of PEG200 to PEG400 is from about 1 to about 1.

Embodiment 177 is the process of any one of embodiments 134-176, wherein the microporous layer is exposed to the heat source that has a temperature of at least about 100° C.

Embodiment 178 is the process of embodiment 177, wherein the heat source that has the temperature of at least about 120° C.

Embodiment 179 is the process of embodiment 177, wherein the heat source that has the temperature of at least about 150° C.

Embodiment 180 is the process of embodiment 177, wherein the microporous layer is exposed to the heat source for about 1 to about 6 hours.

Embodiment 181 is the process of embodiment 177, wherein the microporous layer is exposed to the heat source for about 3 hours.

Embodiment 182 is the process of any one of embodiments 134-181, wherein the membrane is exposed to water for about 6 hours.

Embodiment 183 is the process of embodiment 182, wherein the membrane is exposed to water for about 8 hours.

Embodiment 184 is the process of embodiment 182, wherein the membrane is exposed to water for about 12 hours.

Embodiment 185 is the process of embodiment 182, wherein the membrane is exposed to water for about 18 hours.

Embodiment 186 is the process of embodiment 182, wherein the membrane is exposed to water for about 24 hours.

Embodiment 187 is a method of purifying a solution, the method comprising:
(a) providing an asymmetric thin-film membrane comprising an active layer and a microporous support layer,
wherein said active layer has thickness from about 10 nm to about 1000 nm, and
wherein said active layer and said microporous support layer are bonded to each other covalently;
(b) contacting an active layer face of the membrane with a first solution of a first volume having a first contaminant concentration at a first pressure; and
(c) contacting a microporous support layer face of the membrane with a second solution of a second volume optionally having a second contaminant concentration at a second pressure;
wherein the first solution is in fluid communication with the second solution through the membrane,
wherein the first contaminant concentration is higher than the second contaminant concentration, thereby creating an osmotic pressure across the membrane, and
wherein the first pressure is sufficiently higher than the second pressure to overcome the osmotic pressure to increase the second volume and decrease the first volume, and wherein the first contaminant remains on the active layer face, thereby generating a purified solution.

Embodiment 188 is the method of embodiment 187, wherein the asymmetric membrane is produced by a process, comprising:
(i) providing a substrate having a top surface and a bottom surface;
(ii) applying an active layer to the top surface of the substrate;
(iii) exposing the active layer to a heat source;
(iv) applying epoxy resin microporous support layer on top of the thermally exposed active layer;
(v) exposing the microporous support layer to a heat source to form an asymmetric thin-film composite membrane; wherein said active layer and said microporous support layer are bonding to each other covalently;
(vi) exposing the asymmetric thin-film composite membrane to water; and
(vii) optionally separating the membrane from the substrate.

Embodiment 189 is the method of embodiment 187, wherein the first solution is seawater.

Embodiment 190 is the method of embodiment 187, wherein the contaminant is salt.

Embodiment 191 is the method of embodiment 190, wherein the membrane exhibits a salt rejection of at least about 90% for at least about 4 hours.

Embodiment 192 is the method of any one of embodiments 60-76 and 191, wherein the membrane exhibits a salt rejection of at least about 92% for at least about 4 hours.

Embodiment 193 is the method of any one of embodiments 60-76 and 191, wherein the membrane exhibits a salt rejection of at least about 94% for at least about 4 hours.

Embodiment 194 is the method of any one of embodiments 60-76 or 191, wherein the membrane exhibits a salt rejection of at least about 96% for at least about 4 hours.

Embodiment 195 is the method of any one of embodiments 60-76 or 191, wherein the membrane exhibits a salt rejection of at least about 98% for at least about 4 hours.

Embodiment 196 is the method of any one of embodiments 60-76 or 191, wherein the membrane exhibits a salt rejection of at least about 99% for at least about 4 hours.

Embodiment 197 is the method of any one of embodiments 186-196, wherein a volumetric flow rate is at least about 2 ml/min.

Embodiment 198 is the method of any one of embodiments 186-196, wherein a volumetric flow rate is at least about 4 ml/min.

Embodiment 199 is the method of any one of embodiments 186-196, wherein a volumetric flow rate is at least about 6 ml/min.

Embodiment 200 is the method of any one of embodiments 186-196, wherein a volumetric flow rate is at least about 8 ml/min.

Embodiment 201 is the method of any one of embodiments 186-196, wherein a volumetric flow rate is at least about 10 ml/min.

Embodiment 202 is a method of separating a contaminant from a gas, the method comprising:
(a) providing an asymmetric thin-film membrane comprising an active layer and a microporous support layer,
wherein said active layer has thickness from about 10 nm to about 1000 nm, and
wherein said active layer and said microporous support layer are bonded to each other covalently;
(b) contacting an active layer face of the membrane with a first gas mixture of a first volume having a first contaminant concentration at a first pressure; and
(c) contacting a microporous support layer face of the membrane with a second gas mixture of a second volume optionally having a second contaminant concentration at a second pressure;
wherein the first gas mixture is in communication with the second gas mixture through the membrane,
wherein the first contaminant concentration is higher than the second contaminant concentration, thereby creating an osmotic pressure across the membrane, and
wherein the first pressure is sufficiently higher than the second pressure to increase the second volume and decrease the first volume, and wherein the first contaminant remains on the active layer face, thereby generating a purified gas.

Embodiment 203 is the method of embodiment 202, wherein the asymmetric membrane is produced by a process, comprising:
(i) providing a substrate having a top surface and a bottom surface;
(ii) applying an active layer to the top surface of the substrate;
(iii) exposing the active layer to a heat source;
(iv) applying epoxy resin microporous support layer on top of the thermally exposed active layer;
(v) exposing the microporous support layer to a heat source to form an asymmetric thin-film composite membrane; wherein said active layer and said microporous support layer are bonding to each other covalently;
(vi) exposing the asymmetric thin-film composite membrane to water; and
(vii) optionally separating the membrane from the substrate.

Embodiment 204 is the method of embodiment 202, wherein the first gas mixture comprises two or more gases selected from the group consisting of CO₂, CH₄, H₂, He, Ar, N₂, and 02.

Embodiment 205 is the method of embodiment 204, wherein the first gas mixture comprises CO₂ and CH₄.

Embodiment I is an asymmetric thin-film composite membrane comprising an active layer and a microporous support layer, wherein
the active layer comprises at least one polymer or at least one active agent, and the active layer has a thickness from about 10 nm to about 1,000 nm;
the microporous support layer comprises an epoxy resin; and the active layer and the microporous support layer are covalently bonded to each other.

Embodiment II is the membrane of embodiment I, wherein the active layer comprises at least one polyaniline, at least one polyimide, at least one polybenzimidazolone, at least one polystyrene, at least one polyamide, at least one polybenzimidazole, at least one polybenzoxazole, or a combination thereof.

Embodiment III is the membrane of embodiment II, wherein said active layer comprises at least one polybenzimidazole.

Embodiment IV is the membrane of embodiment III, wherein the polybenzimidazole has a structure:

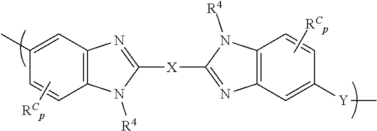

wherein,
X is absent, substituted or unsubstituted C₁-C₆alkylene, or substituted or unsubstituted arylene;
Y is absent, substituted or unsubstituted C₁-C₄alkylene, or substituted or unsubstituted arylene;
each R⁴ is independently H, D, —S(═O)R³, —S(═O)₂R³, —S(═O)₂N(R³)₂, —C(═O)R³, —C(═O)OR³, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

Embodiment V is the membrane of any one of embodiments II-IV, wherein the active layer comprises at least one polybenzoxazole.

Embodiment VI is the membrane of embodiment V, wherein the polybenzoxazole has a structure:

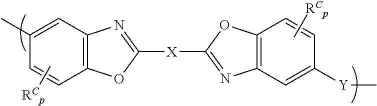

wherein,
X is absent, substituted or unsubstituted C₁-C₈alkylene, or substituted or unsubstituted arylene;
Y is absent, substituted or unsubstituted C₁-C₄alkylene, or substituted or unsubstituted arylene;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

Embodiment VII is the membrane of any one of embodiments II-VI, wherein the active layer comprises at least one polystyrene.

Embodiment VIII is the membrane of embodiment VII, wherein the polystyrene has a structure:

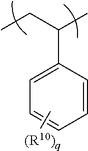

wherein
each R¹⁰ is independently alkyl, hydroxyl, nitro, halo, amino, alkoxy, or sulfonyl; and
q is 1, 2, 3, 4, or 5.

Embodiment IX is the membrane of any one of embodiments I-VIII, wherein the active layer comprises one or more active agents selected from zeolites, metal-organic frameworks, nanoporous carbides, TiO₂ nanoparticles, and carbon nanotubes.

Embodiment X is the membrane of any one of embodiments I-IX, wherein the epoxy resin is a diglycidyl ether-based epoxy resin.

Embodiment XI is the membrane of any one of embodiments I-X, wherein the epoxy resin is selected from: DER 333, DER 661, EPON 828, EPON 836, EPON 1001, EPON 1007F, Epikote 826, Epikote 828, ERL-4201, ERL-4221, GT-7013, GT-7014, GT-7074, and GT-259.

Embodiment XII is the membrane of any one of embodiments I-XI, wherein the microporous support layer further comprises a hardener.

Embodiment XIII is the membrane of embodiment XII, wherein the hardener is selected from aliphatic polyamines, polyamides, amidoamines, cycloaliphatic amines, and aromatic amines.

Embodiment XIV is the membrane of any one of embodiments I-XIII, wherein the membrane has an improvement in at least one property selected from hydrophilicity, resistance to fouling, and reduced surface roughness as compared to an otherwise identical membrane that does not comprise a microporous support layer that comprises an epoxy resin.

Embodiment XV is the membrane of any one of embodiments I-XIV, wherein the membrane is resistant to fouling.

Embodiment XVI is the membrane of embodiment XV, wherein the fouling is biofouling.

Embodiment XVII is the membrane of embodiment XV or XVI, wherein the fouling is reduced by about 10%, about 20%, about 30%, about 40%, about 50%, about 60%, about 70%, about 80%, about 90%, about 95%, about 99% as compared to a RO membrane that does not comprise a microporous support layer that comprises an epoxy resin.

Embodiment XVIII is a method of preparing the membrane of any one of embodiments I-XVII, wherein the method comprises:
obtaining a substrate having a top face and a bottom face;
applying an active layer to the top face of the substrate;
exposing the active layer to a first heat source;
applying an epoxy resin to the top of the active layer; and exposing the epoxy resin to a second heat source, thereby forming an asymmetric thin-film composite membrane.

Embodiment XIX is the method of embodiment XVIII, wherein the method further comprises exposing the asymmetric thin-film composite membrane to water.

Embodiment XX is the method of embodiment XVIII or XIX, wherein the substrate is a non-woven fiber.

Embodiment XXI is the method of any one of embodiments XVIII-XX, wherein the substrate comprises glass or metal.

Embodiment XXII is the method of any one of embodiments XVIII-XX, wherein the substrate comprises carbon, polyester, polyaramid, polyetherimide, or a combination thereof.

Embodiment XXIII is the method of any one of embodiments XVIII-XX, wherein the fiber is a non-woven polyester fabric.

Embodiment XXIV is a method comprising passing a liquid composition through a membrane of any one of embodiments I-XVII, wherein the liquid composition comprises a solute and a solvent; and the membrane is substantially impermeable to the solute.

Embodiment XXV is the method of embodiment XXIV, wherein the liquid composition is salt water.

Embodiment XXVI is the method of embodiment XXIV, wherein the liquid composition is brackish water.

Embodiment XXVII is the method of embodiment XXIV, wherein the liquid composition is an organic solvent.

Embodiment XXVIII is the method of any one of embodiments XXIV-XXVII, wherein the liquid composition comprises at least one fouling agent.

Embodiment XXIX is the method of embodiment XXVIII, wherein the fouling agent is a bacterium, a fungus, or an organism.

Embodiment XXX is the method of any one of embodiments XXIV-XXIX, wherein the liquid composition further comprises chlorine.

We claim:

1. An asymmetric thin-film composite membrane comprising an active layer and a microporous support layer, wherein
the active layer comprises at least one polymer or at least one active agent, and the active layer has a thickness from about 10 nm to about 1,000 nm;
the microporous support layer comprises an epoxy resin; and
the active layer and the microporous support layer are covalently bonded to each other.

2. The membrane of claim 1, wherein the active layer comprises at least one polyaniline, at least one polyimide, at least one polybenzimidazolone, at least one polystyrene, at least one polyamide, at least one polybenzimidazole, at least one polybenzoxazole, or a combination thereof.

3. The membrane of claim 2, wherein said active layer comprises at least one polybenzimidazole.

4. The membrane of claim 3, wherein the polybenzimidazole has a structure: 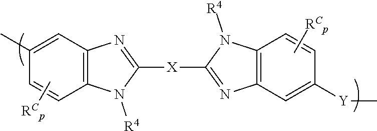
wherein,
X is absent, substituted or unsubstituted C₁-C₆alkylene, or substituted or unsubstituted arylene;
Y is absent, substituted or unsubstituted C₁-C₄alkylene, or substituted or unsubstituted arylene;
each R⁴ is independently H, D, —S(═O)R³, —S(═O)₂R³, —S(═O)₂N(R³)₂, —C(═O)R³, —C(═O)OR³, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

5. The membrane of any one of claims 2-4, wherein the active layer comprises at least one polybenzoxazole.

6. The membrane of claim 5, wherein the polybenzoxazole has a structure: 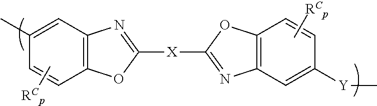
wherein,
X is absent, substituted or unsubstituted C₁-C₈alkylene, or substituted or unsubstituted arylene;
Y is absent, substituted or unsubstituted C₁-C₄alkylene, or substituted or unsubstituted arylene;
each R^{C} is independently H, D, halogen, —CN, —OR³, —SR³, —S(═O)R³, —S(═O)₂R³, —S(═O)₂N(R³)₂, —C(═O)R³, —C(═O)OR³, —N(R³)₂, substituted or unsubstituted C₁-C₆alkyl, substituted or unsubstituted C₁-C₆fluoroalkyl, substituted or unsubstituted C₃-C₆cycloalkyl, substituted or unsubstituted aryl, substituted or unsubstituted benzyl, or substituted or unsubstituted monocyclic heteroaryl;
each R³ is independently selected from H, D, substituted or unsubstituted C₁-C₆alkyl, substituted or unsubstituted C₁-C₆fluoroalkyl, substituted or unsubstituted C₃-C₆cycloalkyl, substituted or unsubstituted phenyl, and substituted or unsubstituted benzyl, and substituted or unsubstituted monocyclic heteroaryl;
or two R³ on the same N atom are taken together with the N atom to which they are attached to form a N-containing heterocycle; and
p is 0, 1, 2, or 3.

7. The membrane of any one of claims 2-6, wherein the active layer comprises at least one polystyrene.

8. The membrane of claim 7, wherein the polystyrene has a structure: 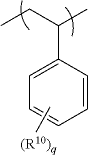
wherein
each R¹⁰ is independently alkyl, hydroxyl, nitro, halo, amino, alkyoxy, or sulfonyl; and
q is 1, 2, 3, 4, or 5.

9. The membrane of any one of claims 1-8, wherein the active layer comprises one or more active agents selected from zeolites, metal-organic frameworks, nanoporous carbides, TiO₂ nanoparticles, and carbon nanotubes.

10. The membrane of any one of claims 1-9, wherein the epoxy resin is a diglycidyl ether-based epoxy resin.

11. The membrane of any one of claims 1-10, wherein the epoxy resin is selected from: DER 333, DER 661, EPON 828, EPON 836, EPON 1001, EPON 1007F, Epikote 826, Epikote 828, ERL-4201, ERL-4221, GT-7013, GT-7014, GT-7074, and GT-259.

12. The membrane of any one of claims 1-11, wherein the microporous support layer further comprises a hardener.

13. The membrane of claim 12, wherein the hardener is selected from aliphatic polyamines, polyamides, amidoamines, cycloaliphatic amines, and aromatic amines.

14. The membrane of any one of claims 1-13, wherein the membrane has an improvement in at least one property selected from hydrophilicity, resistance to fouling, and reduced surface roughness as compared to an otherwise identical membrane that does not comprise a microporous support layer that comprises an epoxy resin.

15. The membrane of any one of claims 1-14, wherein the membrane is resistant to fouling.

16. The membrane of claim 15, wherein the fouling is biofouling.

17. The method of claim 15 or 16, wherein the fouling is reduced by about 10%, about 20%, about 30%, about 40%, about 50%, about 60%, about 70%, about 80%, about 90%, about 95%, about 99% as compared to a RO membrane that does not comprise a microporous support layer that comprises an epoxy resin.

18. A method of preparing the membrane of any one of claims 1-17, wherein the method comprises:
obtaining a substrate having a top face and a bottom face;
applying an active layer to the top face of the substrate;
exposing the active layer to a first heat source;
applying an epoxy resin to the top of the active layer; and
exposing the epoxy resin to a second heat source, thereby forming an asymmetric thin-film composite membrane.

19. The method of claim 18, wherein the method further comprises exposing the asymmetric thin-film composite membrane to water.

20. The method of claim 18 or 19, wherein the substrate is a non-woven fiber.

21. The method of any one of claims 18-20, wherein the substrate comprises glass or metal (e.g., stainless steel).

22. The method of any one of claims 18-20, wherein the substrate comprises carbon, polyester, polyaramid, polyetherimide, or a combination thereof.

23. The method of any one of claims 18-20, wherein the fiber is a non-woven polyester fabric.

24. A method comprising passing a liquid composition through a membrane of any one of claims 1-17, wherein the liquid composition comprises a solute and a solvent; and the membrane is substantially impermeable to the solute.

25. The method of claim 24, wherein the liquid composition is salt water.

26. The method of claim 24, wherein the liquid composition is brackish water.

27. The method of claim 24, wherein the liquid composition is an organic solvent.

28. The method of any one of claims 24-27, wherein the liquid composition comprises at least one fouling agent.

29. The method of claim 28, wherein the fouling agent is a bacterium, a fungus, or an organism.

30. The method of any one of claims 24-29, wherein the liquid composition further comprises chlorine.
